(19) United States
(12) Patent Application Publication
(10) Pub. No.: US 2004/0151358 A1
(43) Pub. Date: Aug. 5, 2004

(54) Medical image processing system and method for processing medical image

(76) Inventors: Akiko Yanagita, Tokyo (JP); Kenji Yamanaka, Tokyo (JP)

Correspondence Address: Cameron Kerrlgan, Squire, Sanders & Dempsey L.L.P., Suite 300, One Maritime Plaza, San Francisco, CA, 94111, US

(21) Appl. No.: 10/764,413

(22) Filed: Jan. 23, 2004

(30) Foreign Application Priority Data
Jan. 31, 2003 (JP) 2003-024028
Oct. 21, 2003 (JP) 2003-360469

(51) Int. Cl. G06K 9/00

(52) U.S. Cl. 382/132

(57) ABSTRACT

A medical image processing system has an image processing section for performing image processing including at least gradation processing on a medical image, a display formatting section for transforming the medical image processed in order to generate an image to be displayed, and an image output section for outputting the image to be displayed to an image recording device, wherein the image processing section generates, based on at least one medical image obtained by radiographing a subject, a plurality of processed images composed of at least one main image and at least one sub image generated by reducing the whole of the at least one medical image, and the display formatting section generates one image to be displayed by synthesizing the main image and the sub image.

### BACKGROUND OF THE INVENTION

1. Field of the Invention

The present invention relates to a medical image processing system and a method for processing a medical image that transform a medical image and output the processed image so as to improve efficiency on doctor's image diagnosis.

2. Related Art

Conventionally, analog images on intensifying screen, film or the like used for radiography, or images obtained from a digital image input system using photostimulable phosphor and outputted as a hardcopy such as silver halide film are used as the medical images to be used by a doctor for diagnosis. Generally, a doctor image-diagnoses such medical images with an image observation device such as Schaukasten or the like in respective clinics.

On the other hand, recently, a system for aiding doctor's diagnosis by means of an image diagnosis aid device has been proposed (see, for example, Japanese Patent Application Publication (Unexamined) No. 2000-287957). Such an image diagnosis aid device adds diagnosis aid information such as a detection result of an abnormal shadow candidate to medical images to be image-diagnosed, and outputs the medical images including the added diagnosis aid information on a CRT (Cathode Ray Tube) monitor, a liquid crystal monitor or the like. Moreover, a technique for displaying an original image on a monitor with an enlarged image of partial area corresponding to an abnormal shadow candidate or the like overlaid thereon has been proposed (see, for example, Japanese Patent Application Publication (Unexamined) No. 2000-287955).

When a medical image is outputted to a monitor or the like to be image-diagnosed, it is possible to change brightness and contrast of the monitor with an adjustment means attached to the monitor, and to change image processing conditions regarding gradation processing, frequency processing and the like in real time by means of image display software at the time of image diagnosis. Moreover, enlargement, reduction and displacement of an image can be preformed with the image display software. As described above, at the time of image diagnosis on a medical image on a monitor, it is possible to make an operation to change a display format and the like in real time, and thereby flexibility of display is large.

However, when a medical image is to be displayed on a monitor, the monitor is required to have high performance for providing an image suitable for image diagnosis, and such a high performance monitor is expensive and requires space for installation. Moreover, such a monitor consumes large amount of electric power, and exhausts large amount of heat. Consequently, it has been practically difficult to install a monitor for displaying a medical image in all the image diagnosis rooms of the department of radiology and respective clinics except for some hospitals such as a large-scaled hospital or the like.

Moreover, for installing a monitor for displaying in a hospital, a doctor is required to be used to operation of the monitor system. Furthermore, since a flow of the operation in the hospital from radiography to image diagnosis would largely change, large problems such as change of the workflow, adjustment of human resources and the like occur.

On the other hand, the method for image-diagnosing a medical image outputted on a hardcopy of silver halide film or the like has the following problems, though many hospitals conventionally have practiced the method. That is, when it is clear that gradation or frequency characteristic of a medical image to be image-diagnosed is not preferable for diagnosis, or that the display method or an image size of the diagnosis aid information is not preferable for diagnosis, it is necessary to re-output film after adjusting the display format of the medical image such as the image processing thereof, the image size thereof or the like, and then to carry the re-outputted film to an image diagnosis location such as a clinic or the like. Consequently, there are problems in the method such as film cost, hour for the operation and labor cost.

Here, as a display method of the diagnosis aid information, adding a figure indicating a detection result of an abnormal shadow candidate to a medical image to be image-diagnosed has been conventionally used. Thereby, a location of abnormal shadow candidate area in the whole image can be confirmed. However, the method has the problem that part of image information is not maintained and therefore it causes trouble in image diagnosis thereof.

Moreover, as information to be referred to, when image diagnosis is performed on a medical image obtained by radiographing a certain radiographic part of a certain body, it is not only the detection result of an abnormal shadow candidate in the medical image to be image-diagnosed. But, for example, there are some cases where it is necessary to refer to an image related the medical image such as an image of the same part radiographed from another direction, an image of the same part radiographed by another modality or the like. In such a case, when a medical image is displayed on a monitor to be observed, it is relatively easy to search for such a related image, or to switch the screen to the related image. However, when a medical image recorded on a recording medium such as film is to be observed, searching for a related image or arranging the related image on Schaukasten takes a lot of trouble. Moreover, when the related image is arranged along with a medical image to be image-diagnosed, there is the problem that it is hard for a doctor who image-diagnoses the image because the doctor is dazzled by strong light from Schaukasten through a gap between the pieces of film when the doctor moves his/her view.

### SUMMARY OF THE INVENTION

An object of the present invention is to provide a medical image processing system and a method for processing a medical image capable of enabling a doctor to refer to and to use diagnosis aid information easily and rapidly in an inexpensive system without changing conventional operation flow in a hospital, and improving diagnosis performance and working efficiency of the doctor, by automatically outputting a hardcopy of a medical image in a display format suitable for diagnosis.

In accordance with a first aspect of the present invention, A medical image processing system comprising an image processing section for performing image processing including at least gradation processing on a medical image, a display formatting section for transforming the medical image processed in order to generate an image to be displayed, and an image output section for outputting the image to be displayed to an image recording device, wherein the image processing section generates, based on at least one medical image obtained by radiographing a subject, a plurality of processed images composed of at least one main image and at least one sub image generated by reducing the whole of the at least one medical image, and the display formatting section generates one image to be displayed by synthesizing the main image and the sub image.

According to the system of the first aspect of the present invention, it is possible to generate a plurality of processed images composed of at least one main image and at least one sub image generated by reducing the whole medical image on the basis of at least one medical image generated by radiographing a subject, to generate one image to be displayed by synthesizing the main image and the sub image, and to output the synthesized image as a hardcopy from an image recording device. Consequently, an expensive monitor is not necessary, and it is possible for a doctor to easily refer to a medical image necessary for image diagnosis when the doctor is to image-diagnose a medical image as the main image without changing a conventional operation flow in a hospital. Consequently, doctor's diagnosis performance and working efficiency can be improved.

Preferably, the system of the first aspect of the present invention further comprises a diagnosis aid information generating section for generating diagnosis aid information by analyzing the medical image, wherein the display formatting section adds annotation corresponding to the diagnosis aid information generated by the diagnosis aid information generating section to the at least one sub image.

According to the above-mentioned system, an image to be displayed is generated by adding annotation concerning diagnosis aid information generated by a diagnosis aid information generating section analyzing a medical image to at least one sub image, and is outputted to the image recording device. Consequently, an expensive monitor is not necessary, and it is possible for a doctor to easily and rapidly refer to and to use diagnosis aid information without changing a conventional operation flow in a hospital. Consequently, doctor's diagnosis performance and working efficiency can be improved.

Preferably, in the system of the first aspect of the present invention, the image processing section determines an image processing condition for the main image and an image processing condition for the sub image respectively by analyzing the medical image, and generates the plurality of processed images composed of the at least one main image and the at least one sub image by using the image processing conditions determined.

According to the above-mentioned system, an image processing condition for a main image and image processing condition for a sub image are determined by analyzing a medical image. By means of the determined image processing condition, a plurality of processed images composed of at least one main image and at least one sub image are generated. Consequently, different kinds of image processing can be performed on the main image for a diagnosis purpose and on the sub image for a reference purpose.

Preferably, in the system of the first aspect of the present invention, the image processing condition includes a gradation processing condition, and the image processing section determines the gradation processing condition so as to make an average gradient of the sub image smaller than an average gradient of the main image.

According to the above-mentioned system, a main image and a sub image are generated by determining a gradation processing condition so as to make the average gradient of the sub image smaller than the average gradient of the main image. Consequently, in the main image for a diagnosis purpose, sufficient contrast can be given to the image diagnosis of lesion shadow. Moreover, in the sub image for a reference purpose, the whole image can be fitted into a density range within which the image can easily be observed. Thus, the location relation between a subject and an annotation can be easily expressed.

Preferably, in the system of the first aspect of the present invention, the image processing condition includes a gradation processing condition, and the image processing section determines the gradation processing condition so as to make an average gradient of the sub image have an opposite sign value to a value of an average gradient of the main image.

According to the above-mentioned system, a main image and a sub image are generated by determining a gradation processing condition so as to make the average gradient of the sub image have a sign value opposite to a value of the average gradient of the main image. Consequently, sufficient contrast can be given to the image diagnosis of lesion shadow. Moreover, in the sub image for reference purpose, black and white of the image is inverted. Then, the boundary between a subject and its background is shown with density to be observed easily, and the location relation between the subject and annotation can be easily expressed.

Preferably, in the system of the first aspect of the present invention, the image processing condition includes a frequency processing condition, and the image processing section determines the frequency processing condition so as to make low frequency components of the sub image have smaller amount than low frequency components of the main image.

According to the above-mentioned system, a main image and a sub image are generated by determining a frequency processing condition so as to make low frequency components of the sub image have smaller amount than low frequency components of the main image. Consequently, sufficient contrast can be given to the image diagnosis of lesion shadow. Moreover, in the sub image for a reference purpose, the whole image can be fitted into a density range to be observed easily. Then, the location relation of added annotation can be easily expressed.

Preferably, the system of the first aspect of the present invention further comprises an image recording device information storage section for storing image recording device information corresponding to the image recording device, wherein the image processing section determines an image processing condition based on an analysis result of the medical image and the image recording device information.

According to the above-mentioned system, an image processing condition is determined on the basis of the analysis result of a medical image and image recording device information. Consequently, the optimum processed image according to the image recording device can be automatically generated.

Preferably, in the system of the first aspect of the present invention, the image processing section comprises a schema image generating section for automatically generating a schema by analyzing the medical image, and for generating the at least one sub image including the schema.

According to the above-mentioned system, by analyzing a medical image, a schema is automatically generated, and at least one sub image including the schema is generated. Consequently, according to a purpose, since an image to be displayed using a schema image as a sub image can be generated, a doctor can refer to and use diagnosis aid information easily and rapidly, and thereby the diagnosis performance and the working efficiency of the doctor can be improved.

Preferably, the system of the first aspect of the present invention further comprises a sub image display assigning information input section for externally inputting information in order to assign whether the sub image is to be displayed or not, wherein the display formatting section generates the image to be displayed with the sub image displayed or an image to be displayed without the sub image displayed on the basis of the sub image display assigning information inputted externally.

According to the above-mentioned system, when the information for assigning display/non-display of a sub image is externally inputted, either an image to be displayed with the sub image displayed or an image to be displayed without the sub image displayed is generated on the basis of the externally inputted sub image display assigning information. Consequently, according to need, a medical image without diagnosis aid information added can be outputted.

Preferably, in the system of the first aspect of the present invention, the diagnosis aid information generating section detects an abnormal shadow candidate in the medical image, and generates the diagnosis aid information including location information in regard to the abnormal shadow candidate detected in the medical image.

According to the above-mentioned system, an abnormal shadow candidate in a medical image is detected. Diagnosis aid information including location information in the medical image related to the detected abnormal shadow candidate is generated. Consequently, by showing the abnormal shadow candidate in regard to a lesion, doctor's oversight on the lesion is minimized. Thereby, the load of the doctor can be reduced.

Preferably, in the system of the first aspect of the present invention, the diagnosis aid information generating section performs image measurement on the medical image, and generates the diagnosis aid information including location information in regard to a result of the image measurement in the medical image.

According to the above-mentioned system, image measurement is performed on a medical image. Diagnosis aid information including location information in the medical image in regard to the measurement result is generated. Consequently, by showing the measurement result, accuracy of image measurement by a doctor is improved and the load of image diagnosis can be reduced.

Preferably, in the system of the first aspect of the present invention, the image output section comprises: a plurality of output channels corresponding to a plurality of image recording devices; an output channel selecting section for selecting any one among the plurality of output channels to which an image is outputted; and an image recording device information storage section for storing image recording device information of the image recording device set per each of the output channels, the display formatting section generates the image to be displayed on the basis of the image recording device information which corresponds to the output channel selected by the output channel selecting section, and which is stored in the image recording device information storage section.

According to the above-mentioned system, an image output section comprises a plurality of output channels corresponding to a plurality of image recording devices. Image recording device information of an image recording device set per each output channel is stored as related thereto. On the basis of the information of the selected image recording device, an image to be displayed is generated. Consequently, when an image recording device to which an image is outputted is selected among a plurality of image recording devices, the optimum format to the selected image recording device can be automatically applied.

Preferably, the system of the first aspect of the present invention further comprises an image display section for displaying on a monitor, the image to be displayed generated by the display formatting section; an image to be displayed modifying information input section for externally inputting modifying information for modifying the image to be displayed; and a display image modifying section for modifying the image to be displayed on the basis of the image to be displayed modifying information inputted externally.

According to the above-mentioned system, a generated image to be displayed is displayed on a monitor. When modifying information for modifying the displayed image to be displayed is inputted externally, the image to be displayed is modified on the basis of the externally inputted image to be displayed modifying information. Consequently, while a user confirms an image on the monitor, he/she can modify the display format.

Preferably, the system of the first aspect of the present invention further comprises a diagnosis aid information storage section for storing the diagnosis aid information as related to image data of the medical image, wherein the display formatting section loads the diagnosis aid information stored in the diagnosis aid information storage section, and generates the image to be displayed on the basis of the diagnosis aid information.

According to the above-mentioned system, diagnosis aid information is stored as related to the image data of a medical image, and the stored diagnosis aid information is loaded. Then, an image to be displayed is generated on the basis of the loaded diagnosis aid information. Consequently, when display formatting is changed to be re-outputted, it is not necessary to re-perform the calculation for generating the diagnosis aid information.

Preferably, the system of the first aspect of the present invention further comprises an image processing condition storage section for storing an image processing condition of image processing as related to image data of the medical image, the image processing performed on the medical image by the image processing section, wherein the image processing section loads the image processing condition stored in the image processing condition storage section, and generates the plurality of processed images on the basis of the image processing condition.

According to the above-mentioned system, the condition of the image processing performed on a medical image is stored as related to the image data of the medical image, the stored image processing condition is loaded, and on the basis of the loaded image processing condition, a processed image is generated. Consequently, when the condition of the display formatting other than image processing is changed to be re-outputted, it is not necessary to re-perform the calculation of determining the image processing condition.

Preferably, the system of the first aspect of the present invention further comprises a display format storage section for storing an image to be displayed generating condition applied on the medical image by the display formatting section, or image data of the image to be displayed generated by the display formatting section, as related to image data of the medical image, wherein the display formatting section loads the image to be displayed generating condition stored in the display format storage section or data of the image to be displayed in order to generate the image to be displayed.

According to the above-mentioned system, the image to be displayed generating condition performed on a medical image or the image data of the generated image to be displayed is stored as related to the image data of the medical image, and the stored image to be displayed generating condition or the data of the image to be displayed is loaded to generate the image to be displayed. Consequently, when an outputted medical image is to be re-outputted, it is not necessary to re-perform the calculation for generating the image to be displayed. Moreover, by storing a image to be displayed generating condition as related to image data, a record indicating by which film output a doctor determined a diagnosis is left. Consequently, information management desirable in view of EBM (Evidence Based Medicine), response to a medical lawsuit or the like is possible.

Preferably, the system of the first aspect of the present invention further comprises a schema image storage section for storing image data of the schema as related to image data of the medical image, wherein the display formatting section loads the image data of the schema stored in the schema image storage section in order to generate the image to be displayed on the basis of the image data of the schema.

According to the above-mentioned system, the image data of a schema is stored as related to the image data of a medical image, and the stored schema image data is loaded. On the basis of the schema image data, an image to be displayed is generated. Consequently, when the conditions of display formatting other than the schema are changed to be re-outputted, it is not necessary to re-perform the calculation for determining the image processing conditions.

Preferably, in the system of the first aspect of the present invention, the display formatting section comprises: an image size adjusting section for performing size adjustment on each of the main image and the sub image; and an image synthesizing section for synthesizing the main image size-adjusted and the sub image size-adjusted.

According to the above-mentioned system, size adjustment is performed on each of main images and sub images. Then, the main images and the sub images are synthesized. Consequently, the size adjustment on each of the main images and the sub images can be performed.

Preferably, in the system of the first aspect of the present invention, the image size adjusting section performs the size adjustment so as to make an image size of the sub image smaller than an image size of the main image.

According to the above-mentioned system, the size adjustment is performed so as to make the image size of a sub image smaller than the image size of a main image. Consequently, for example, it is possible that the main image, which is a main body of image diagnosis, is expressed in its full-size in detail, and that the sub image as a reference of image diagnosis is located on the same image.

Preferably, in the system of the first aspect of the present invention, the image synthesizing section synthesizes the sub image size-adjusted with the main image size-adjusted so as to fit the sub image into predetermined area in the main image.

According to the above-mentioned system, the size-adjusted sub image is synthesized with the size-adjusted main image so as to make the sub image fitted into predetermined area in the main image. Consequently, for example, it is possible that the main image, which is a main body of image diagnosis, is expressed in its full-size in detail, and that the sub image as a reference of image diagnosis is located in predetermined area where the sub image does not disturb the image diagnosis.

Preferably, in the system of the first aspect of the present invention, the image synthesizing section determines a location for fitting the sub image size-adjusted on the basis of image attribute information of the medical image.

According to the above-mentioned system, on the basis of the image attribute information of a medical image, the fitting location of the size-adjusted sub image is determined. Consequently, the sub image can be located at a location where the sub image does not disturb the image diagnosis on the basis of the image attribute information of a medical image such as a radiographic part, a body position, a radiographing size and the like.

Preferably, in the system of the first aspect of the present invention, the display formatting section comprises a subject area recognizing section for recognizing subject area by analyzing the medical image, and the image synthesizing section determines a location into which the sub image size-adjusted is to be fitted on the basis of information of the subject area recognized.

According to the above-mentioned system, subject area is recognized by analyzing a medical image. On the basis of the information of the recognized subject area, the fitting location of the size-adjusted sub image is determined. Consequently, the sub image can be automatically located at a location where the subject image is not overlapped on the subject area and therefore the image diagnosis is not disturbed.

Preferably, in the system of the first aspect of the present invention, the image size adjusting section adjusts the image size of the sub image on the basis of the information of the subject area recognized.

According to the above-mentioned system, the size of a sub image is adjusted on the basis of the information of recognized subject area. Consequently, the sub image can be located so as to have a size in order not to disturb the image diagnosis and not to be overlapped on the subject area.

Preferably, in the system of the first aspect of the present invention, the diagnosis aid information generating section generates a plurality of pieces of diagnosis aid information different from one another based on the same medical image, and the image processing section generates the at least one sub image per each of the plurality of pieces of diagnosis aid information.

According to the above-mentioned system, a plurality of pieces of diagnosis aid information different from one another is generated from the same medical image. Further, per each of the generated plurality of pieces diagnosis aid information, at least one sub image is generated. Consequently, even if a plurality of different kinds of abnormal shadow candidates and measurement results exist, the sub image does not become complicated, and a sub image to be observed easily can be provided.

Preferably, the system of the first aspect of the present invention further comprises a modality for generating the medical image by radiographing the subject; and an abnormal shadow candidate detecting section for analyzing the medical image generated in order to detect an abnormal shadow candidate, wherein the image processing section comprises a reduced medical image generating section for reducing at a predetermined magnifying rate, the whole of the medical image in order to generate a reduced medical image as the sub image, and the display formatting section comprises: a reduced abnormality displayed image generating section for overlapping a result of the detection of the abnormal shadow candidate on the reduced medical image generated in order to generate a reduced abnormality displayed image as the sub image; and a synthesized image generating section for recognizing subject area of the main image generated, and for locating at least one of the reduced medical image and the reduced abnormality displayed image with information of the subject area recognized in the main image maintained in order to synthesize the main image with the reduced medical image or the reduced abnormality displayed image as the sub image into a synthesized image.

According to the above-mentioned system, a reduced medical image is generated by reducing a medical image at a predetermined magnifying rate. A detection result of an abnormal shadow candidate is overlapped on the generated reduced medical image to generate a reduced abnormality displayed image. The reduced medical image and/or the reduced abnormality displayed image are located in area with the information of the subject area in a medical image maintained, to be synthesized into a synthesized image. At least one of the synthesized image, the medical image, the reduced medical image and the reduced abnormality displayed image is outputted to an image recording device. Consequently, the reduced medical image and/or the reduced abnormality displayed image to be referred to at the time of diagnosis is located with the information of the subject area in a medical image maintained, and the reduced medical image and/or the reduced abnormality displayed image is outputted as a hardcopy. Thereby, doctor's diagnosis performance and working efficiency can be improved.

Preferably, the system of the first aspect of the present invention further comprises an obtaining section for obtaining at least one of an other modality image of the same radiographic part of the same subject, generated by a modality other than the modality that has generated the medical image, and a past medical image generated by the same modality; and an obtained image storage section for storing at least one of the other modality image obtained and the past medical image obtained, wherein the image processing section comprises an obtained image processing section for loading at least one of the other modality image and the past medical image from the obtained image storage section, and for reducing at the predetermined magnifying rate, the image loaded in order to generate the reduced medical image as the sub image, and at least one of the reduced medical image and the reduced abnormality displayed image to be synthesized with the main image by the synthesized image generating section is any one of the images indicated by the following items (1) to (5),

(1) a reduced medical image of the same medical image as the main image;

(2) a reduced abnormality displayed image of the same medical image as the main image;

(3) a reduced medical image of another medical image related to the medical image of the main image;

(4) a reduced abnormality displayed image of another medical image related to the medical image of the main image; and

(5) a reduced medical image obtained from the obtained image processing section.

According to the above-mentioned system, the following images are displayed on a medical image for reference: a reduced medical image of the medical image, a reduced abnormality displayed image of the medical image, a reduced medical image of another medical image related to the medical image, a reduced abnormality displayed image of another medical image related to the medical image, a reduced medical image of an other modality image and/or a reduced medical image of a past medical image. Thereby, doctor's diagnosis performance and working efficiency can be improved.

Preferably, in the system of the first aspect of the present invention, the obtained image processing section performs at least one among gradation processing, frequency processing and processing for adding information indicating a modality type in an image, on the reduced other modality image.

According to the above-mentioned system, at least one among the gradation processing, frequency processing, the processing of adding the information indicating a type of modality in an image is performed on a reduced other modality image. Consequently, the other modality image can be made to be an image suitable for reference.

Preferably, in the system of the first aspect of the present invention, the reduced abnormality displayed image generating section overlaps at least annotation information as the result of the detection of the abnormal shadow candidate in order to generate the reduced abnormality displayed image on the reduced medical image generated by the reduced medical image generating section, the annotation information indicating a location of the abnormal shadow candidate.

According to the above-mentioned system, as a detection result of an abnormal shadow candidate, at least annotation information indicating location of the abnormal shadow candidate is overlapped on a reduced medical image to generate a reduced abnormality displayed image. Consequently, a detection result of the abnormal shadow candidate can be easily displayed.

Preferably, in the system of the first aspect of the present invention, the reduced medical image generating section further recognizes the subject area by analyzing the reduced medical image, and performs density correction so as to make area other than the subject area recognized have more than predetermined density.

According to the above-mentioned system, by analyzing a reduced medical image, subject area is recognized. Then, density correction is performed so as to make area other than the recognized subject area have more than predetermined density. Consequently, when the reduced medical image or a medical image generated by synthesizing the reduced medical image is observed with Schaukasten, it does not happen that light quantity of the area other than the subject area is too strong to image-diagnose or to refer to the subject area.

Preferably, in the system of the first aspect of the present invention, the obtained image processing section further analyzes at least one of the other modality image reduced and the past medical image reduced in order to recognize each subject area, and performs density correction so as to make area other than the each subject area recognized have more than predetermined density.

According to the above-mentioned system, by analyzing a reduced other modality image and/or a reduced past medical image, subject area is recognized. Then, density correction is performed so as to make area other than the recognized subject area have more than predetermined density. Consequently, when the density-corrected other modality image and/or past medical image, or medical image generated by synthesizing these images are observed with Schaukasten, it does not happen that light quantity of the area other than the subject area is too strong to image-diagnose or to refer to the subject area.

Preferably, the system of the first aspect of the present invention further comprises a size information adding section for adding at least one of scale calibration and information indicating a reduction ratio on at least one of the reduced medical image and the reduced abnormality displayed image generated by the reduced medical image generating section.

According to the above-mentioned system, it is possible to add the information indicating sizes such as scale calibration, a reduction ratio and the like to a reduced medical image and/or a reduced abnormality displayed image generated by a reduced medical image generating section.

Preferably, the system of the first aspect of the present invention further comprises a size information adding section for adding at least one of scale calibration and information indicating a reduction ratio on at least one of the reduced medical image and the reduced abnormality displayed image generated by the obtained image processing section.

According to the above-mentioned system, it is possible to add the information indicating sizes such as scale calibration, a reduction ratio and the like to a reduced medical image and/or a reduced abnormality displayed image generated by an obtained image processing section.

Preferably, the system of the first aspect of the present invention further comprises a findings information input section for inputting findings information corresponding to the image to be displayed; and a findings information adding section for adding the findings information inputted to the image to be displayed to be outputted by the image output section.

According to the above-mentioned system, when findings information according to an image to be displayed is inputted, the inputted findings information is added to an image to be outputted. Consequently, it is possible to record the findings information on a recording medium along with an image.

Preferably, the system of the first aspect of the present invention further comprises a findings information storage section for storing information inputted from the findings information input section as related to the medical image to be set as the main image.

According to the above-mentioned system, it is possible to store inputted findings information as related to a medical image.

Preferably, in the system of the first aspect of the present invention, when the main image is mammography, the synthesized image generating section locates at least one of the reduced medical image as the sub image and the reduced abnormality displayed image as the sub image in the main image in order to synthesize the images in any one of the following forms indicated by items (1) to (8):

(1) main images (MLO(oblique direction)-R(right breast), L(left breast)) and reduced medical images (CC(vertical direction)-R, L);

(2) main images (CC-R, L) and reduced medical images (MLO-R, L);

(3) main images (MLO-R, CC-R) and reduced medical images (MLO-L, CC-L);

(4) main images (MLO-L, CC-L) and reduced medical images (MLO-R, CC-R);

(5) main images (MLO-R, L) and reduced abnormality displayed images (CC-R, L);

(6) main images (CC-R, L) and reduced abnormality displayed images (MLO-R, L);

(7) main images (MLO-R, CC-R) and reduced abnormality displayed images (MLO-L, CC-L); and

(8) main images (MLO-L, CC-L) and reduced abnormality displayed images (MLO-R, CC-R).

According to the above-mentioned system, at the time of a doctor's image diagnosis, other images related to mammography for diagnosis are synthesized with the mammography to be outputted. Consequently, at the time of the doctor's image diagnosis, the related images can be easily and efficiently referred to.

Preferably, in the system of the first aspect of the present invention, when the main image is mammography, the synthesized image generating section locates at least one of the reduced medical image and the reduced abnormality displayed image in the main image in order to synthesize the images in any one of following forms (1) to (8):

(1) a main image (MLO-R) and reduced medical images (MLO-R, CC-R);

(2) a main image (MLO-L) and reduced medical images (MLO-L, CC-L);

(3) a main image (CC-R) and reduced medical images (MLO-R, CC-R);

(4) a main image (CC-L) and reduced medical images (MLO-L, CC-L);

(5) a main image (MLO-R) and reduced abnormality displayed images (MLO-R, CC-R);

(6) a main image (MLO-L) and reduced abnormality displayed images (MLO-L, CC-L);

(7) a main image (CC-R) and reduced abnormality displayed images (MLO-R, CC-R); and

(8) a main image (CC-L) and reduced abnormality displayed images (MLO-L, CC-L).

According to the above-mentioned system, outputted is an image generated by synthesizing either a reduced medical image or a reduced abnormality displayed image radiographed from two directions with one medical image. Consequently, at the time of the image diagnosis by a doctor, it is possible to perform the image diagnosis efficiently.

Preferably, in the system of the first aspect of the present invention, the synthesized image generating section recognizes the subject area of the main image, and performs size adjustment on at least one of the reduced medical image and the reduced abnormality displayed image to be synthesized with the main image, according to a ratio between the subject area and area other than the subject area in the main image.

According to the above-mentioned system, size alteration on a reduced medical image and a reduced abnormality displayed image to be synthesized with a medical image are performed according to a ratio between subject area and area other than the subject area in the medical image. Consequently, the sizes of the reduced medical image and the reduced abnormality displayed image can be set in accordance with the vacant area in the medical image.

Preferably, in the system of the first aspect of the present invention, when at least one of a plurality of the reduced medical images and a plurality of the reduced abnormality displayed images are synthesized with the main image, the synthesized image generating section performs size adjustment on each of the images to be synthesized with the main image so as to make the image to be synthesized have the same size.

According to the above-mentioned system, when a plurality of reduced medical images and/or a plurality of reduced abnormality displayed images are synthesized with a medical image, the size of each image to be synthesized with the medical image is adjusted to be the same. Consequently, it is possible to provide an image to be easily observed.

Preferably, in the system of the first aspect of the present invention, when the main image is composed of two images at a left side and a right side, the synthesized image generating section recognizes subject area of each of the two images, and performs synthesis so as to make relative location relation between each subject area recognized and at least one of the reduced medical image and the reduced abnormality displayed image in the main image have the same appearance or symmetric appearance at the left side and the right side.

According to the above-mentioned system, when a medical image is composed of two images at a left side and a right side, after subject area of each medical image is recognized, synthesis can be performed so as to make relative location relation between recognized each subject area and a reduced medical image and/or a reduced abnormality displayed image in the main image have the same appearance or symmetric appearance at the left side and the right side.

Preferably, the system of the first aspect of the present invention further comprises a selecting section for selecting a medical image to be set as the main image and a medical image to be set as the sub image among a plurality of medical images generated in the same examination by the modality under different radiographing conditions.

According to the above-mentioned system, it is possible to select a medical image to be set as a main image and a medical image to be set as a sub image among a plurality of medical images generated in the same examination by a modality under different radiographing conditions. Consequently, an image to be displayed in accordance with a diagnosis purpose or the like can be generated. Then, doctor's diagnosis performance and working efficiency can be improved more.

Preferably, the system of the first aspect of the present invention further comprises an assigning section for assigning whether the reduced medical image is set as the sub image or the reduced abnormality displayed image is set as the sub image.

According to the above-mentioned system, it is possible to assign whether a reduced medical image is set as a sub image or a reduced abnormality displayed image is set as a sub image. Consequently, an image to be displayed according to a diagnosis purpose or the like can be generated. Thereby, it is possible to improve doctor's diagnosis performance and working efficiency more.

Preferably, the system of the first aspect of the present invention further comprises at least one modality, and a managing device for storing and managing medical images generated by the at least one modality as related to accompanying information thereof, wherein the image processing device comprises a selecting section for selecting a medical image to be set as the main image and a medical image to be set as the sub image among at least one of the medical images generated by the at least one modality and the medical images stored in the managing device.

According to the above-mentioned system, it is possible to select a medical image to be set as a main image and a medical image to be set as a sub image among medical images generated by the at least one modality and/or medical images stored in a managing device storing and managing medical images generated by a plurality of types of modality as related to their accompanying information. Consequently, an image to be displayed according to a diagnosis purpose or the like can be generated. Thereby doctor's diagnosis performance and working efficiency can be improved more.

Preferably, in the system of the first aspect of the present invention, after the selecting section selects the medical image to be set as the main image, the selecting section extracts medical images related to the main image from at least one of the medical images generated by the at least one modality and the medical images stored in the managing device on the basis of the accompanying information, displays a list of the medical images extracted on a display screen as sub image candidates, and selects a medical image to be set as the sub image among the sub image candidates displayed.

According to the above-mentioned system, after a medical image to be set as a main image is selected, medical images related to the main image is extracted among medical images generated on the basis of accompanying information by a modality and/or medical images stored in a managing device. Then, a list of the extracted medical images is displayed on a display screen as sub image candidates. Therefore, a medical image to be set as a sub image can be selected among the sub image candidates. Consequently, a medical image related to a main image can be easily selected as a sub image.

Preferably, in the system of the first aspect of the present invention, selecting section is capable of selecting a plurality of sub images corresponding to the main image.

According to the above-mentioned system, it is possible to select a plurality of sub images corresponding to a main image. Consequently, it is possible to synthesize a plurality of sub images to be used as a reference for diagnosis corresponding to the main image.

In accordance with a second aspect of the present invention, A method for processing a medical image, comprises: generating a plurality of processed images composed of at least one main image and at least one sub image generated by reducing the whole of a medical image on the basis of at least one medical image generated by radiographing a subject; generating one image to be displayed by synthesizing the main image and the sub image; and outputting the image to be displayed to an image recording device.

According to the method of the second aspect of the present invention, it is possible to generate a plurality of processed images composed of at least one main image and at least one sub image reduced from the whole of the medical image, to generate one image to be displayed by synthesizing the main image and the sub image, and to output the synthesized image as a hardcopy from the image recording device. Consequently, an expensive monitor is not necessary, and it is possible for a doctor to easily refer to a medical image necessary for image diagnosis when the doctor is to image-diagnose a medical image as the main image without changing a conventional operation flow in a hospital. Consequently, doctor's diagnosis performance and working efficiency can be improved.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a block diagram showing a functional structure of a medical image processing system 10 according to a first embodiment in the present invention;

FIG. 2A is a view showing an example of a microcalcification clusters, and FIG. 2B is a view showing an example of mass shadow;

FIG. 3A is a table showing an data storing example of an abnormal shadow candidate file 141 stored in a diagnosis aid information storage section 14 of FIG. 1, and FIG. 3B is a table showing an data storing example of a measurement information file 142 stored in the diagnosis aid information storage section 14;

FIG. 4A is a view showing an example of histogram analysis, FIG. 4B is a view showing an example of a method for determining a gradation conversion curve, FIG. 4C is a view showing a method for determining a normalized line;

FIG. 5 is a view showing an example of a medical image monitoring screen 181 displayed by an image display section 18 of FIG. 1;

FIG. 6 is a view showing an example of a displayed image modifying screen 182 displayed by the image display section 18 of FIG. 1;

FIG. 7 is a table showing a data storing example of a modification history file 191;

FIG. 8 is a table showing an example of information set per each output channel of an image output section 20 of FIG. 1;

FIG. 9 is a view showing an example of a hardcopy 200 to be outputted from an image recording device;

FIG. 10 is a view showing an example of a hardcopy 201 to be outputted from the image recording device;

FIG. 11 is a block diagram showing a functional structure of the medical image processing system 10 according to a second embodiment in the present invention;

FIG. 12 is a view showing an example of a hardcopy 202 to be outputted from the image recording device;

FIG. 13 is a diagram showing a whole structure of a medical image processing system 100 according to a third and a fifth embodiments in the present invention;

FIG. 14 is a block diagram showing a functional structure of an image processing device 4 according to a third embodiment in the present invention;

FIG. 15 is a view showing a structure example of a storage section 44 of FIG. 14;

FIG. 16A and FIG. 16B are views showing an example of a synthesized image 491 and an example of a synthesized image 492 generated by a synthesized image generating section 49 of FIG. 14, respectively;

FIG. 17A and FIG. 17B are views showing an example of a synthesized image 493 and an example of a synthesized image 494 generated by the synthesized image generating section 49 of FIG. 14, respectively;

FIG. 18A is a view showing a location example of images when right and left mammography images radiographed from the same radiographing direction are outputted on one sheet of recording medium in two-side output on the right side and the left side, and FIG. 18B is a view showing a location example of images when the mammography images of a right breast and a left breast radiographed from different radiographing directions are outputted in two-side output on one sheet of recording medium;

FIG. 19 is a flowchart illustrating image output control processing A to be executed by a controller 41 of FIG. 14;

FIG. 20 is a view showing an example of an output image 495 to be outputted from the image processing device 4;

FIG. 21 is a diagram showing a whole structure of a medical image processing system 200 according to a fourth and a sixth embodiments in the present invention;

FIG. 22 is a block diagram showing a functional structure of the image processing device 4 in the fourth embodiment in the present invention;

FIG. 23 is a view showing a structure example of the storage section 44 of FIG. 22;

FIG. 24 is a flowchart illustrating image output control processing B to be executed by a controller 41 of FIG. 22;

FIG. 25 is a block diagram showing a functional structure of the image processing device 4 according to the fifth embodiment in the present invention;

FIG. 26 is a view showing an example of a selecting screen 422 to be displayed on an operation display section 42 of FIG. 25;

FIG. 27 is a flowchart illustrating image output control processing C to be executed by the controller 41 of FIG. 25;

FIG. 28 is a block diagram showing a functional structure of the image processing device 4 according to the sixth embodiment in the present invention;

FIG. 29A is a view showing an example of a main image selecting screen 424 to be displayed on a display screen of the operation display section 42 of FIG. 28, and FIG. 29B is a view showing an example of a sub image selecting screen 425 to be displayed on the display screen of the operation display section 42 of FIG. 28;

FIG. 30 is a view showing a structure example of the storage section 44 of FIG. 28; and

FIG. 31 is a flowchart illustrating image output control processing D to be executed by the controller 41 of FIG. 28.

### EMBODIMENTS OF THE INVENTION

In the following, the present invention will be described in detail.

[First Embodiment]

In the following, with reference to figures, a first embodiment of the present invention will be described in detail.

First, its structure will be described.

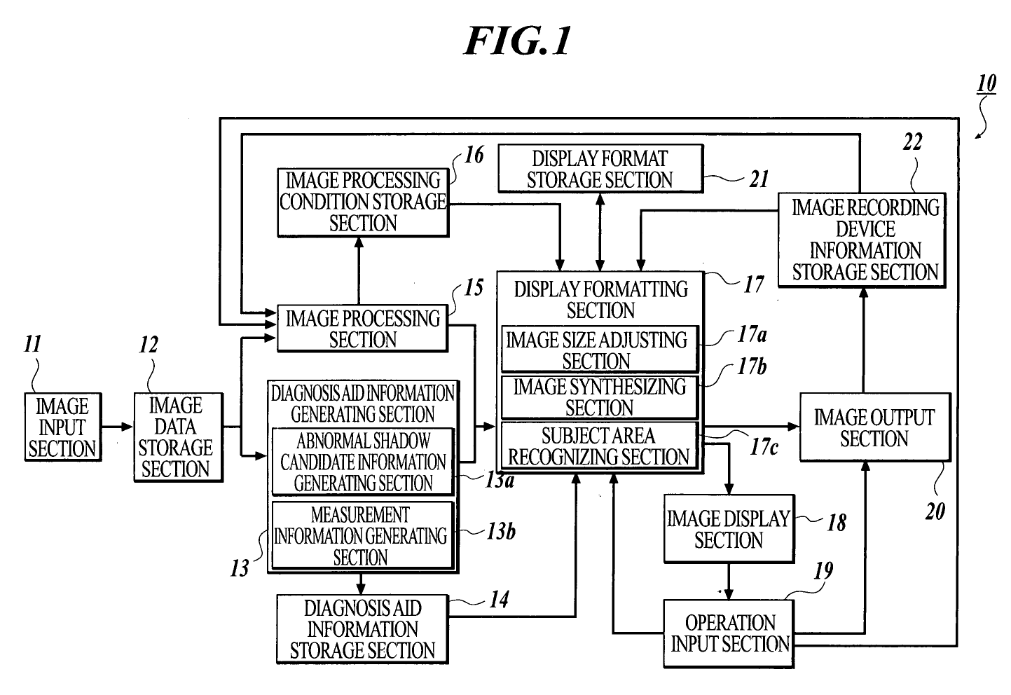

FIG. 1 is a view showing an inner structure of a medical image processing system 10 in the present embodiment. In FIG. 1, the medical image processing system 10 comprises an image input section 11, an image data storage section 12, a diagnosis aid information generating section 13, a diagnosis aid information storage section 14, an image processing section 15, an image processing condition storage section 16, a display formatting section 17, an image display section 18, an operation input section 19, an image output section 20, a display format storage section 21 and an image recording device information storage section 22.

The image input section 11 is to scan film on which a medical image obtained by radiographing a patient is recorded with laser beam, to measure amount of transmitted light and to analogue-digital-convert the value of the amount for inputting the converted value as image data by use of, for example, a laser digitizer.

Moreover, an input of an image by the image input section 11 is not limited to the inputted by the laser digitizer. For example, an optical sensor such as a CCD (Charge Coupled Device) or the like may be used. In this case, image data is obtained by scanning film with light, and performing photoelectric conversion on the reflected light thereof with the CCD. Moreover, in place of reading an image recorded on film, a medical image may be obtained by performing radiography using accumulative phosphor as disclosed in Japanese Patent Application Publication (unexamined) No. Tokukai-Sho 55-12429. The medical image radiographed in this method is converted into digital data by a radiography device connected to the image data storage section 12 to output the converted image data. In this case, advantages peculiar to a digital system such as digital image processing, image management by means of digital image storage, and image sharing and image communication through a network can be obtained.

Moreover, image data obtained from a flat panel detector (FPD), which takes a radiation image by the use of a plurality of detecting element arranged two-dimensionally to be outputted as electric signals, may be inputted. For example, Japanese Patent Application Publication (Unexamined) Publication No. Tokukai-Hei 6-342098 discloses a technique for generating charge according to intensity of irradiated radiation in a photoconductive layer to store the generated charge in a plurality of capacitors arranged two-dimensionally.

Moreover, as disclosed in Japanese Patent Application Publication (Unexamined) No. Tokukai-Hei 9-90048, a medical image may be inputted by making a phosphor layer such as an intensifying screen absorb radiation to generate fluorescence, and then by detecting intensity of the fluorescence with a photodetector such as a photodiode provided at each pixel. There are other methods using CCD or C-MOS sensor as a means to detect intensity of the fluorescence. Moreover, a structure of combining a radiographic scintillator for emitting visible light by irradiating radiation, a lens array and an area sensor corresponding to each lens may be also used.

Incidentally, when a digital medical image is to be obtained by the use of the above-mentioned various structures, though it depends on a radiographic part or a diagnosis purpose, for example, in a mammogram (a radiation image of a breast), an effective pixel size of an image is preferably not more than 200 μm, and more preferably the effective pixel size is not more than 100 μm. In order to bring out performance of the image processing device in the present invention to the utmost extent, for example, a structure where image data having an effective pixel size of approximately 50 μm is inputted is preferable.

Moreover, an image is not limited to a simple X-ray image, but the medical image processing system 10 can have a structure for inputting image data obtained from a radiography device such as CT (Computed Tomography), MRI (Magnetic Resonance Imaging), ultrasonic diagnostic equipment or the like.

Moreover, the image input section 11 inputs image data along with image attribute information related to the image data. The image attribute information includes, for example, patient information in regard to a patient such as a patient name of a radiographed patient, patient identification data (ID), age, sex and the like; radiographing information such as a radiographing date, radiographic ID, a radiographic part, radiographing conditions (a body position, a radiographing direction and the like), a radiographing device and the like; and image data information such as the pixel number of image data, a sampling pitch, the bit number and the like. When the image input section 11 outputs image data to the image data storage section 12, the image input section 11 is designed to output the image attribute information as related to the image data.

Incidentally, the image input section 11 is not necessary to be equipped with the medical image processing system 10. For example, the medical image processing system 10 may load image data from various storage media storing the image data such as CD-ROM, floppy (registered trade mark) or the like, or may obtain image data by being transmitted from an outer device connected to the medical image processing system 10 or PACS through network.

The image data storage section 12 stores image data inputted from the image input section 11 after performing data compression on the image data according to need. Hereupon, as the data compression method, lossless compression or lossy compression using a well-known technique such as JPEG, DPCM (Differential Pulse Code Modulation), wavelet compression or the like is performed. Preferably, lossless compression, in which diagnosis information along with the data compression is not deteriorated, is used.

Since data amount inputted from the image input section 11 is not too large in a small-scaled diagnosis, the image data can be stored in a magnetic disc without being compressed. In this case, the storing and the loading of the image data can be performed at very high speed in comparison with the case of a magneto-optical disk. Since high-speed cycle time is required at the time of image-diagnosing an image, there are cases where necessary image data is stored in a semiconductor memory.

The diagnosis aid information generating section 13 comprises an abnormal shadow candidate information generating section 13a and a measurement information generating section 13b.

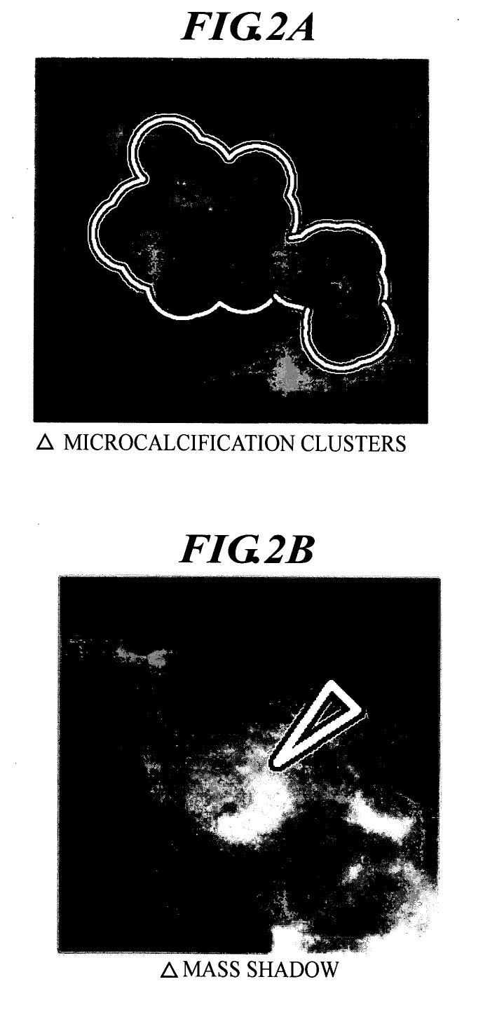

The abnormal shadow candidate information generating section 13a loads image data from the image data storage section 12 to perform image analysis. Thereby, the abnormal shadow candidate information generating section 13a detects a candidate which seems to be abnormal shadow such as microcalcification clusters, mass shadow or the like in a mammogram, and nodular shadow in a thoracic image, and generates diagnosis aid information including location information of the abnormal shadow candidate in the image. FIG. 2A shows an example of microcalcification clusters. When there is gathered microcalcification (in a clustered state), there is high possibility of the corresponding part being initial cancer. Consequently, the microcalcification is a one of important findings to find breast cancer at an early stage. The microcalcification can be found as whitish round shadow having almost a conic structure in a mammogram. Moreover, mass shadow shown in FIG. 2B can be seen as mass having a certain size, or whitish round shadow having almost a Gaussian distribution in a mammogram.

As a method to detect mass shadow, it is possible to use well-known detection methods written in the following theses:

(1) Mass Shadow

a detection method by comparing left and right mammas (Med. Phys.,Vol.21.No.3,pp445-452)

a detection method by using Iris filter (IEICE transactions (D-II), Vol.J75-D-II,no.3,pp.663-670,1992)

a detection method by using Quoit filter (IEICE transactions (D-II), Vol.J76-D-II,no.3,pp.279-287,1993)

a detection method with binarization based on histogram of pixel values of divided mamma areas (Jamit Frontier lecture collected papers,pp.84-85,1995)

a minimum direction differential filter picking up minimum output from a large number of Laplacian filters having polarity (IEICE transactions (D-II), Vol.J76-D-II,no.2,pp.241-249,1993)

a method for distinguishing benignity or malignity of mass shadow by use of fractal dimensionality (Medical Imaging technology 17 (5),pp.577-584,1999)

Further, as a method to detect an abnormal shadow candidate of microcalcification clusters, it is possible to use well-known detection methods written in the following theses:

(2) Microcalcification Clusters

a method of deleting a false positive candidate in accordance with an optical density difference of shadow figure, standard deviation of a boundary density difference or the like, by localizing an area where there is a suspicion of calcification in a mamma area (IEEE Trans Biomed Eng BME-26(4):213-219,1979)

a detection method by using an image on which Laplacian filter processing is applied (IEICE transactions (D-II), Vol.J71-D-II,no.10,pp.1994-2001,1988)

a detection method using a morphologically analyzed image in order to inhibit a background pattern such as mammary gland or the like (IEICE transactions (D-II), Vol.J71-D-II,no.7,pp.1170-1176,1992)

Moreover, as a method to detect other abnormal shadow candidates, for example, it is possible to use well-known detection methods in the following:

(3) Detection of Nodular Shadow in a Thoracic Image

Japanese Patent Application Publication (Unexamined) No. Tokukai-Hei 6-121792

(4) Detection of Shadow of Interstitial Diseases in a Thoracic Image

Japanese Patent Application Publication (Unexamined) No. Tokukai-Hei 2-185240

The measurement information generating section 13b loads image data from the image data storage section 12 for the image measurement, and then generates diagnosis aid information including location information in the image related to the measurement result. As the image measurement, for example, measurement of a cardiothoracic ratio to be used for a diagnosis of cardiac hypertrophy in a thoracic image, measurement of bone length of lower limb to be used for the planning of an operation or the like in a lower limb image, measurement of the Cobb angle to be used for a diagnosis of a spinal curvature in a spinal image, and the like. A structure in which the measurement is automatically performed may be used (for example, Medical Physics,Vol.17,No.3,pp. 342-350,1990, Japanese Patent Application Publication (Unexamined) No. Tokukai-Hei 7-381), or a structure in which the measurement is performed by executing calculation based on information inputted by an operator with a pointing device such as a mouse or the like while an image displayed on a image displaying section is observed (for example, Japanese Patent Application Publication (Unexamined) No. Tokukai-Hei 8-256993) may be used.

The diagnosis aid information storage section 14 comprises an abnormal shadow candidate file 141 for storing the diagnosis aid information generated by the abnormal shadow candidate information generating section 13a as related to the image data, and a measurement information file 142 for storing the diagnosis aid information generated by the measurement information generating section 13b as related to image data.

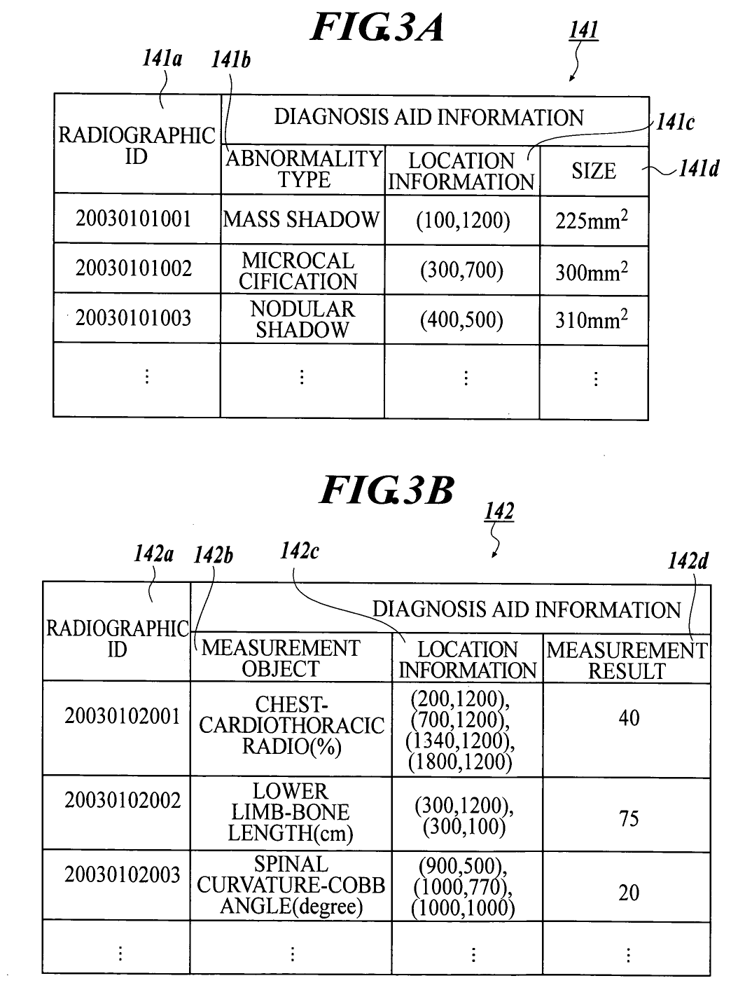

As shown in FIG. 3A, the abnormal shadow candidate file 141 comprises a radiographic ID area 141a, an abnormality type area 141b, a location information area 141c, a size area 141d and the like. The abnormal shadow candidate file 141 stores the diagnosis aid information, which is an abnormality type, location information and a size, generated by the abnormal shadow candidate information generating section 13a with regard to the image data specified by a radiographic ID, as related to one another. The image data stored in the image data storage section 12 and the diagnosis aid information in the abnormal shadow candidate file 141 are made to correspond to each other by means of a radiographic ID.

The abnormality type area 141b stores data indicating a type of a detected abnormal shadow candidate (for example, mass shadow, microcalcification, nodular shadow, . . . ) as “abnormality type”. The location information area 141c stores data indicating a coordinate value of the location of the center of gravity of abnormal shadow candidate (for example, (x, y)=(100, 1200), (300, 700), (400, 500), . . . ) as “location information”. The location information is not limited such data, but the location information may be, for example, a coordinate value indicating image area of a abnormal shadow candidate. Moreover, the location information may be a distance to distinctive normal tissue. For example, when a radiographic part is chest, a location may be indicated by a distance between the center of gravity of an abnormal shadow candidate and the center of gravity of a pulmonary area, which is the distinctive normal tissue. The distinctive normal tissue is biological tissue that seldom changes its location and is an organ or bone such as a heart, a lung, a vertebra and the like. It is preferable that the distinctive normal tissue be one that can be an indication of change with time in the location of abnormal shadow candidate. The size information area 141d stores data indicating area occupied by image area of an abnormal shadow candidate (for example, 225 mm², 300 mm², 310 mm², . . . ) as “size”. The size information may be indicated by an average distance from the center of gravity to the edge of an abnormal shadow candidate, or the longest distance thereof (for example, 15 mm or the like).

The measurement information file 142, as shown in FIG. 3B, comprises a radiographic ID area 142a, a measurement object area 142b, a location information area 142c, a measurement result area 142d and the like. The measurement information file 142 stores a measurement object, location information, a measurement result and the like as related to one another, all of which are the diagnosis aid information generated by the measurement information generating section 13b with regard to the image data specified by a radiographic ID. The image data stored in the image data storage section 12 and the diagnosis aid information in the measurement information file 142 are made to correspond to each other by means of a radiographic ID.

The measurement object area 142b stores data indicating a measurement object (for example, chest—cardiothoracic ratio (%), lower limb—bone length (cm), spinal curvature—Cobb angle (degree), . . . ) as “measurement object”. The location information area 142c stores data indicating coordinate values of locations used for the measurement in an image (for example, {(200, 1200), (700, 1200), (1340, 1200), (1800, 1200)}, {(300, 1200), (300, 100)} {(900, 500), (1000, 770), (1000, 1000)}, . . . ) as “location information”. The measurement result area 142d stores numerical value data indicating a measurement result (for example, 40, 75, 20, . . . ) as “measurement result”. The unit of the measurement result is set per each measurement object in advance.

Incidentally, a way of storing each diagnosis aid information is not limited to the description above. Each diagnosis aid information may be stored, for example, within header information of the image data in the image data storage section 12.

The image processing section 15 analyses the image data (original image) inputted from the image data storage section 12, and then determines two different kinds of image processing conditions, i.e. an image processing condition for a main image and an image processing condition for a sub image. The image processing section 15 applies the image processing conditions on the original image in order to generate the main image data and the sub image data to which annotation indicating diagnosis aid information is added. Then, the image processing section 15 outputs the generated main image data and the sub image data to the display formatting section 17. The image processing includes gradation processing for adjusting contrast of the image, frequency emphasizing processing for adjusting sharpness, dynamic range compression processing for fitting an image having a wide dynamic range into a density range within which the image is easy to observe without contrast of the details of a subject deteriorated, and the like. Moreover, the image processing further includes rotation processing, inverting processing, trimming processing and the like for modifying an image so as to make a direction and a size suitable for a diagnosis on the basis of image attribute information such as a radiographic part, radiographing conditions and the like.

In the gradation processing, the gradation processing condition for a main image is determined at first. Two examples will be described as determining methods of the gradation processing condition for a main image.

Method 1

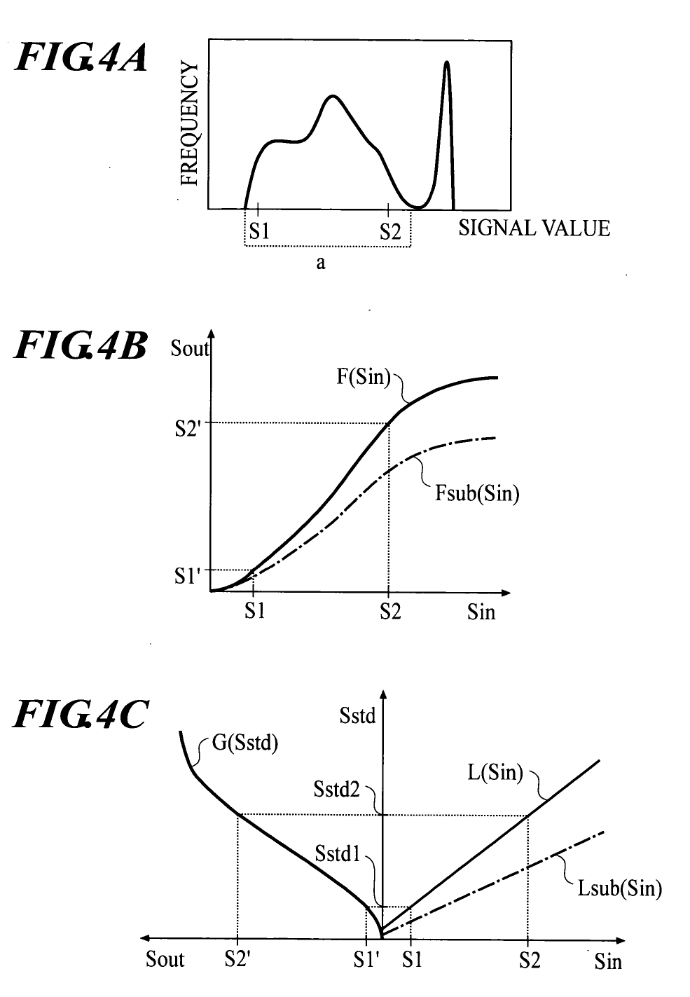

First, image data is analyzed, and image area corresponding to a desired part of a subject is set by the use of an extraction technique of pulmonary area in a thoracic image disclosed in Japanese Patent Application Publication (Unexamined) No. Tokukai-Hei 3-218578, an extraction technique of thick mammary gland area in mammography disclosed in Journal of Japan Association of Breast Cancer Screening, Vol.17, No.1, pp87-102,1998 or the like. Next, as shown in FIG. 4A, histogram analysis within the area is performed by means of a technique disclosed in Japanese Patent Application Publication (Unexamined) No. Tokukai-Sho 63-262141 or Japanese Patent Application Publication (Unexamined) No. Tokukai-Hei 8-62751, and thereby area “a” corresponding to important signal area in view of diagnosis is determined. After the determination of the area “a”, the cumulative histogram in the area “a” is calculated in order to obtain signal values S1 and S2 corresponding to predetermined cumulative histogram values (for example, 5%, 95%). The signal values S1 and S2 are determined as reference signal values.

Next, as disclosed in Japanese Patent Application Publication (Unexamined) No. Tokukai-Sho 59-83149, by deforming a reference gradation curve selected from several kinds of reference gradation curves which are generated in advance, determined is a gradation conversion curve corresponding to a function F(Sin) by which the previously obtained reference signal values S1 and S2 in input signal values Sin shown in FIG. 4B are respectively converted into output signal values S1′ and S2′ in output signal values Sout.

<Formula 1>Sout=F(Sin)

where S1′ and S2′ are values corresponding to predetermined reference output densities D1 and D2, respectively. Relation between the output signal value Sout and the density D is determined by the characteristic of the image recording device, which is an output destination of the output of images. The characteristic of the image recording device is image recording device information (a type, an output image size (a film size, number of pixels lengthwise and crosswise), maximum density and minimum density, density resolution, gradation characteristic, frequency characteristic and the like), which is stored in an image recording device information storage section, which will be described later.

Method 2

First, reference signal values S1 and S2 are obtained by the similar techniques to those of the above-mentioned method 1. Next, as shown in FIG. 4C, a reference gradation curve G (Sstd) selected among the reference gradation curves, which are generated in advance, is prepared. Then, a normalized line expressed by a linear function L(Sin) by which the reference signal values S1 and S2 are converted into predetermined normalized signal values Sstd1 and Sstd2, respectively, is determined corresponding to an input signal value Sin.

<Formula 2>Sstd=L(Sin)

where the normalized signal values Sstd1 and Sstd2 are determined as signal values to which output signal values S1′ and S2′ respectively corresponding to determined reference output densities D1 and D2 are outputted when the normalized signal values Sstd1 and Sstd2 are converted by a reference gradation curve Gstd.

When relation between inputs and outputs in gradation processing is expressed by a curve chart having an abscissa axis indicating logarithm of the quantity of arrived X-rays and a vertical axis indicating output density, an average inclination of a curved line connecting predetermined two points of output density (for example, 0.25 and 2.0) is called as an average gradient.

The gradation processing condition for a main image is required to have a high average gradient in order to observe lesion shadow and the like in detail. To put it concretely, the average gradient is preferably not less than 2.0 in mammography, and not less than 1.5 in a radiographic part other than mammography. More preferably, the average gradient is not less than 2.5 in mammography, and not less than 2.0 in a radiographic part other than mammography.

After the determination of the gradation processing condition for a main image, the gradation processing condition for a sub image is determined.

When the gradation processing condition for a main image is determined by means of the above-mentioned method 1, a gradation conversion curve F(Sin) for a main image is determined. After the determination of the gradation conversion curve F(Sin), a gradation conversion curve for a sub image is determined. As the determination method of the gradation conversion curve for a sub image, a gradation conversion curve Fsub(Sin) for a sub image is generated by multiplying the gradation conversion curve F(Sin) by a predetermined coefficient α (α<1.0) (see FIG. 4B).

When the gradation processing condition for a main image is determined by means of the above-mentioned method 2, the normalized line L(Sin) for a main image is determined. After the determination of the normalized line L(Sin) for a main image, the normalized line Lsub(Sin) is generated by multiplying the normalized line L(Sin) for a main image by a predetermined coefficient α (α<1.0) (see FIG. 4C).

Or, the following method for determining the gradation processing condition for a sub image may be used. That is, as the reference output densities Dsub1 and Dsub2 for a sub image, values smaller than the reference output densities D1 and D2 for a main image are set in advance. Then, by carrying out the same procedures as either the determination method 1 or 2 of the gradation processing condition for a main image by the use of the reference output densities Dsub1 and Dsub2, the gradation processing condition for a sub image is determined. Hereupon, the reference output densities Dsub1 and Dsub2 are set so as to make the value of (Dsub2−Dsub1) smaller than the value of (D2−D1).

For a sub image, in order to express the whole subject and its background part within a density range in which they can be easily observed, a gradation processing condition including a relatively low average gradient is set. To put it concretely, the average gradient is preferably not more than 3.5 in mammography, and not more than 3.0 in a radiographic part other than mammography. More preferably, the average gradient is not more than 3.0 in mammography, and not more than 2.5 in a radiographic part other than mammography. Moreover, the average gradient for a sub image is preferably not more than 80% of the average gradient for a main image.

As mentioned, by determining the gradation conversion curves F(Sin) and Fsub(Sin) or the normalized lines L(Sin) and Lsub(Sin) so as to make the average gradient of sub image data relatively smaller than the average gradient (inclination) of main image data, sufficient contrast is given for image diagnosis of lesion shadow in a main image for a diagnosis purpose. At the same time, the whole image of a sub image to be observed as reference is fitted into a density range in which the whole sub image can be easily seen, and thereby the location relation of annotation can be expressed to be easily seen.

Moreover, the gradation processing condition for a sub image may be determined as follows.

The gradation conversion curve F(Sin) for a main image, or the normalized line L(Sin) for a main image is inverted in a vertical axis direction.

The gradation conversion curve Fsub(Sin) or the normalized line Lsub(Sin), both of which are generated so as to make the average gradient lower than the main image by means of the above-mentioned methods, is inverted in a vertical axis direction.

As mentioned, either the gradation conversion curve or the normalized line is determined so as to make the average gradient of sub image data have a value of an opposite sign to, either the average gradient of either the gradation conversion curve of main image data or the normalized line of the main image data, or the average gradient of either gradation conversion curve or the normalized line both of which are generated so as to make the average gradient thereof lower than the main image. Thereby, sufficient contrast for image diagnosis of lesion shadow is given to a main image to be diagnosed. At the same time, in a sub image to be observed as reference, black and white of an image is inverted to show the boundary between a subject and a background at density at which the boundary is easily seen, and the location relation between the subject and an annotation can be easily expressed. This processing is especially effective in mammography.

A user can select and instruct the determination of the gradation processing conditions of the sub image data through the operation input section 19.

Incidentally, prior to the gradation processing, when irradiation field recognition processing for detecting irradiation field area of radiation is performed, the image processing on an image part necessary for a diagnosis can be suitably performed by setting various image processing conditions on the basis of image data within the recognized irradiation field area. Consequently, the irradiation field recognition processing is preferable. As the method of the irradiation field recognition processing, for example, a means disclosed in Japanese Patent Application Publication (Unexamined) No. Tokukai-Sho 63-259538, Japanese Patent Application Publication (Unexamined) No. Tokukai-Hei 5-7579 or Japanese Patent Application Publication (Unexamined) No. Tokukai-Hei 7-181609 can be used.

In the frequency processing, sharpness of an image is controlled by, for example, unsharpness mask processing disclosed in Japanese Patent Publication (Examined) No. Tokuko-Sho 62-62373 and Japanese Patent Publication (Examined) No. Tokuko-Sho 62-62376, or a multiple resolution method disclosed in Japanese Patent Application Publication (Unexamined) No. Tokukai-Hei 9-44645. In this case, a frequency processing condition is determined so as to make low-frequency component of sub image data relatively attenuated in comparison with low frequency component of main image data. Thereby, sufficient contrast for image diagnosis of lesion shadow is given in a main image to be diagnosed. At the same time, regarding a sub image to be observed as reference, the whole image can be fitted into a density range within which it is easy to see the image, and thereby the location relation of annotation can be easily expressed. Moreover, as another way of reducing the low frequency component of sub image data relatively, dynamic range compression processing conditions may be determined so to have large degree of the compression of the low frequency component of sub image data in comparison with the degree of the compression of main image data in the dynamic range compression processing.

Hereupon, the image processing conditions in the frequency processing or in the dynamic range compression processing are determined on the basis of characteristic of an image recording device, which is an output destination of an image as well as the analysis result of image data. The characteristic of an image recording device is image recording device information similar to the description in the paragraph of the gradation processing.

Moreover, the image processing section 15 performs the rotating or the inverting processing on an image on the basis of a radiographic part or an instruction from the operation input section 19. Moreover, the image processing section 15 has a function as a display image modifying means and when an instruction to modify contrast, density or the like of a main image or a sub image is inputted from the operation input section 19, the image processing section 15 re-performs the gradation processing on the instructed image in accordance with the input instruction.

The image processing conditions of the main image data and the sub image data determined by the image processing section 15 are stored by means of the image processing condition storage section 16 as related to the image data stored in the image data storage section 12. To put it concretely, image data and each image processing condition are made to correspond to each other by a radiographic ID for identifying image data. Or, each image processing condition may be stored within the header information of image data in the image data storage section 12. As mentioned, by storing the image data and the image processing conditions thereof so as to correspond to each other, it is unnecessary to re-perform the calculation for determining the image processing conditions when the conditions other than the image processing conditions are changed in order to re-output the image data. Consequently, it is possible to reduce processing load in the system.

The display formatting section 17 comprises an image size adjusting section 17a, an image synthesizing section 17b and a subject area recognizing section 17c. The image size adjusting section 17a adjusts the size of an image so that the image size of a sub image is smaller than that of a main image. In the size-adjustment, it is preferable to adjust the size of the sub image into a size so as to arrange the sub image on the outside of the subject area recognized by the subject area recognizing section 17c.

The image synthesizing section 17b refers to image attribute information in regard to image data, for example, the above-mentioned patient information, the radiographing information, the image data information and the image processing condition, and judges in which area within the image area to get interest for a diagnosis (area of interest) is located in accordance with a rule set in advance from a location of patient information displaying area which is set in advance as area to display a radiographic part, a body position, a radiographing size, patient information. Then, the image synthesizing section 17b determines the arrangement location of the sub image in the outside of the area of interest. For example, in the case of a chest front image, since lung field area is the area of interest, the image synthesizing section 17b determines a location which does not overlap a patient information displaying area in the upper right area or the upper left area of the image where displaying area does not overlap the lung field area as the arrangement location of the sub image. Or, in the case of mammography, since breast is the area of interest, the image synthesizing section 17b determines area which does not overlap the breast, i.e. a location which does not overlap patient information displaying area in an image end at a side opposite to a chest wall as the arrangement location of the sub image. To put it concretely, the image synthesizing section 17b determines rectangular area, which does not overlap the area of interest recognized by the subject area recognizing section 17c and the patient information displaying area, as the sub image arrangement location. Then, the image synthesizing section 17c loads the diagnosis aid information corresponding to the image data from the abnormal shadow candidate file 141 or the measurement information file 142, and generates annotation (illustration of diagnosis aid information by means of a sign, a letter, a marker or the like) corresponding to the loaded diagnosis aid information. The image synthesizing section 17c adds the generated annotation to the sub image data, the size of which has been adjusted, and synthesizes one image with the sub image inserted within the sub image arrangement location in the main image area. Moreover, in the present embodiment, each sub image is inserted into the main images of breasts of both sides in the same radiographing direction, and two images are synthesized where the two images are arranged on one sheet of film in the state of being opposed to each other to be outputted. Hereupon, alignment processing for aligning breasts in both sides may be performed on the basis of analysis of the image data (see Japanese Patent Application Publication (Unexamined) No. Tokukai 2000-287957).

The subject area recognizing section 17c recognizes subject area by extracting a borderline of a subject within image data, or the like. For example, the subject area recognizing section 17c binarizes density data of the image by using an appropriate threshold value, and traces a boundary between “0” and “1” to obtain the borderline. Then, the subject area recognizing section 17c determines area of interest according to the borderline, a radiographic part, a body position and a radiographing direction. Otherwise, the subject area recognizing section 17c determines the area of interest by means of a borderline extraction method of a human body area or an area corresponding to a predetermined anatomic structure in a human body (see Journal of Japan Association of Breast Cancer Screening, Vol.17,No.1, pp87-102,1998 and Japanese Patent Application Publication (Unexamined) No. Tokukai-Sho 63-240832).

The display formatting section 17 adjusts the output of synthesized image data to generate an image to be displayed on the basis of information of the image recording device assigned as an output destination among the image recording device information (a type of the device, an output image size (a film size, number of pixels lengthwise and crosswise), maximum density, minimum density, density resolution, gradation characteristic, frequency characteristic and the like), which is set per each output channel stored in the image recording device information storage section 22, and the display formatting section 17 outputs the generated image to be displayed to the image display section 18.

Moreover, the display formatting section 17 has a function as a display image modifying means and when an instruction for modifying a main image size, a sub image size, a layout or annotation is inputted from the operation input section 19, the image synthesizing section 17b re-synthesizes the image to be displayed in accordance with the input instruction, and outputs the re-synthesized image to the image display section 18.

The image data of the image to be displayed, which has been generated by the display formatting section 17, or the conditions applied on the medical image for generating the image to be displayed, is stored in the display format storage section 21 as related to the image data stored in the image data storage section 12. To put it concretely, the image data of the image data storage section 12, and either the image data of each image to be displayed or formatting conditions for display, are made to correspond to each other by a radiographic ID for identifying the image data. Otherwise, each image to be displayed and the generating conditions of the image to be displayed may be stored within the header information of the image data in the image data storage section 12. Thereby, it is unnecessary to re-perform the calculation for generating the image to be displayed at the time of re-outputting. Moreover, by storing image data as related to the generating conditions of an image to be displayed, it is possible to leave a record indicating based on what kind of film output a doctor has concluded a diagnosis.

The image display section 18 is a CRT (Cathode Ray Tube), a liquid crystal display, a plasma display or the like. The image display section 18 displays an image to be displayed that is inputted from the display formatting section 17, on a monitor thereof.

Hereupon, the image display section 18 preferably has a function of the conversion processing of gradation for display for achieving consistency of the appearance of the monitor display and a hardcopy (Japanese Patent Application Publication (Unexamined) No. 2002-366952).

The operation input section 19 includes a keyboard equipped with function keys corresponding to various functions such as cursor keys, numeral inputting keys, a decision key and the like, and a pointing device such as a mouse or the like. The operation input section 19 outputs a push signal on the keyboard and an operation signal from the mouse. Moreover, the operation input section 19 may be integrated with the image display section 18 into a touch panel. The operation input section 19 outputs designation of an image recording device or output instruction to the image output section 20 on the basis of input operation. Moreover, as a sub image display assigning information input means, the operation input section 19 outputs the existence of displaying a sub image to the display formatting section 17 on the basis of input operation. Moreover, as a display image modifying means, the operation input section 19 outputs modification instruction of the size, the layout and the annotation pattern of a main image and a sub image which are displayed on the image display section 18, or addition instruction of a comment or the like to the display formatting section 17. The operation input section 19 further outputs instruction of modifying gradation to the image processing section 15.

FIG. 5 shows an example of a medical image monitoring screen 181 displayed by the image display section 18. The diagnosis aid information of the image data inputted by the image input section 11 is generated by the diagnosis aid information generating section 13. The image processing on the image data, including the gradation processing and the like, is performed by the image processing section 15. The size adjustment, the image synthesis and the like on the image data are preformed by the display formatting section 17. Thereby, an image to be displayed for being outputted from the image output section 20 is generated. Then, the image to be displayed is displayed on a monitor in the image display section 18 as the medical image monitoring screen 181.

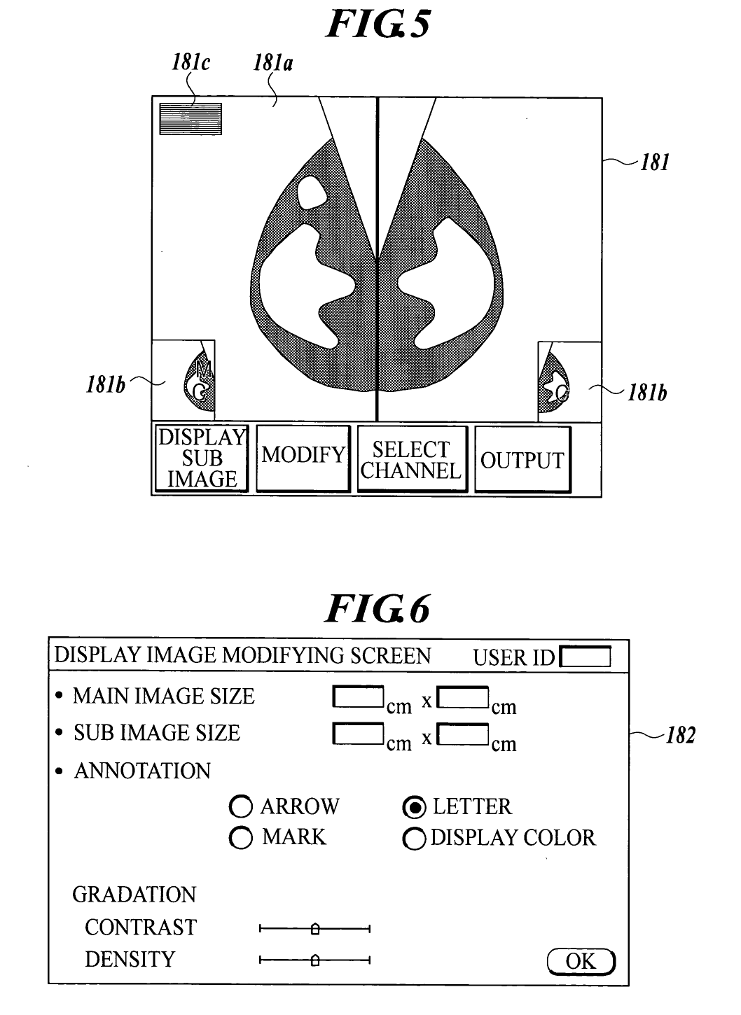

In the medical image monitoring screen 181, as shown in FIG. 5, main image 181a, sub image 181b and patient information 181c are displayed. At the lower part of the medical image monitoring screen 181, various function buttons are displayed. Among them, when a “DISPLAY SUB IMAGE” button is clicked with a mouse, an image to be displayed including only the main image is generated by the display formatting section 17. Thereby, the image to be displayed including the main image and the sub image and the image to be displayed including only the main images are switched to be displayed. When a “MODIFY” button is pushed, a displayed image modifying screen 182 shown in FIG. 6 is displayed. Hereupon, when a user ID is inputted, modifying items are set and an “OK” button is pushed, a modified and changed image is displayed on the medical image monitoring screen 181. Incidentally, the size of the main image and the sub image can be adjusted by dragging the side part of the image with a mouse. Moreover, the layout of the medical image monitoring screen 181 can be modified by dragging the sub image. When a “SELECT CHANNEL” button is pushed, a screen for selecting an output destination is displayed, and an image recording device to be an output destination can be assigned. When an “OUTPUT” button is pushed, the displayed image is outputted from an assigned output channel to the image recording device.

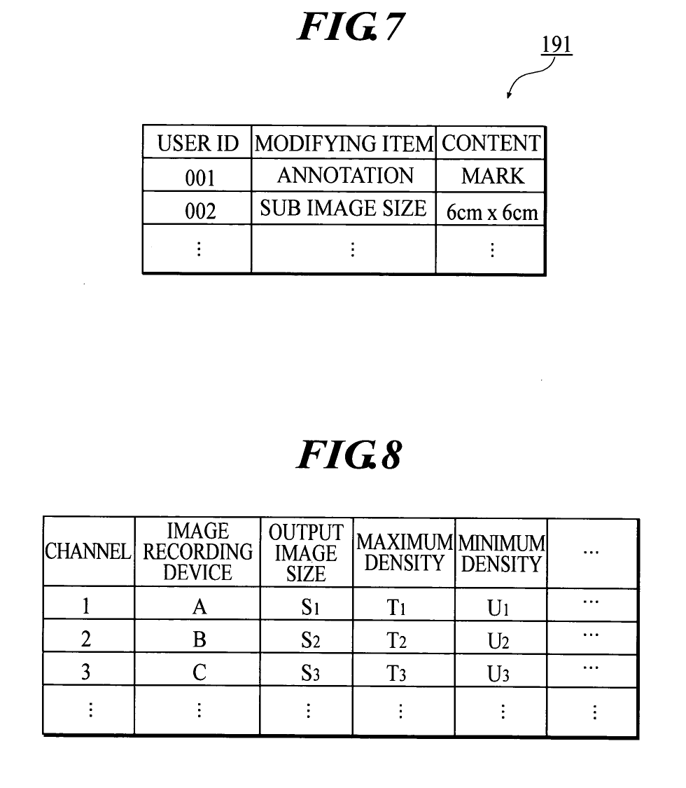

Incidentally, the system preferably comprises a modification history storage section for storing the modifying items of the image to be displayed, which has been inputted from the operation input section 19, as a modification history file 191. FIG. 7 shows an example of the modification history file 191. As shown in FIG. 7, the modification history file 191 comprises a user ID area for storing codes (for example, 001, 002, . . . ) uniquely assigned to doctors or technicians (users) who have instructed modification, a modifying item area for storing data indicating instructed modifying items (for example, annotation, sub image size, . . . ), and a content area for storing data indicating the instructed modification contents (for example, mark, 6 cm×6 cm, . . . ).

When the user ID of a doctor who image-diagnoses is inputted, the image processing section 15 and the display formatting section 17 refer to the modification history file 191 to perform the image processing or the generation of an image to be displayed on the basis of the modification history concerning modification which the user performed in the past. Thereby, an image to be displayed according to the user can be generated, and it is unnecessary to input modification at each time.

The image output section 20 comprises a plurality of output channels. Per each output channel, information of an image recording device (type of the image recording device, an output image size (film size, and number of pixels lengthwise and crosswise), maximum density and minimum density, density resolution, gradation characteristic, frequency characteristic and the like) to be an output destination to which an image to be displayed is outputted through the output channel is respectively set. The set content is stored in the image recording device information storage section 22 (see FIG. 8). From which output channel an image is outputted can be assigned by the operation input section 19 as an output channel selecting means. Moreover, a structure in which image attribute information of a radiographic part or a consultation division is in advance made to correspond to output channels, and an output channel is automatically selected on the basis of the image attribute information of the image to be outputted may be used. When the output of an image is instructed, the image output section 20 outputs the data of the image to be displayed, which is inputted from the display formatting section 17, from the assigned output channel to the image recording device. The image recording device is a device, such as a laser film printer, an ink-jet printer, a thermal printer and the like, for recording an image on a medium as a hardcopy.

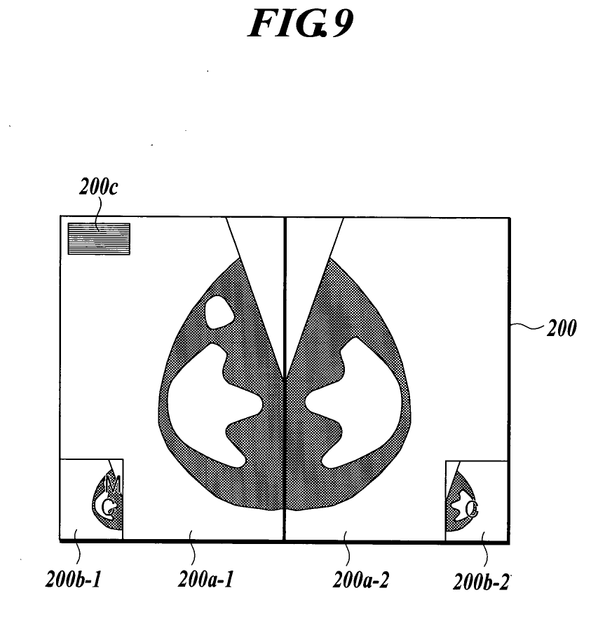

FIG. 9 shows an example of a hardcopy 200 of a medical image outputted from the image recording device. As shown in FIG. 9, on the hardcopy 200, two images to be displayed (combination of a main image and a sub image) including a mammogram of a right breast and a mammogram of a left breast are printed on one sheet of film. In FIG. 9, a reference numeral 200a-1 designates a main image of the mammogram of the right breast, and a reference numeral 200b-1 designates a sub image thereof. A reference numeral 200a-2 designates a main image of the mammogram of the left breast, and reference numeral 200b-2 designates a sub image thereof. An abnormal shadow candidate is displayed as annotation in each sub image. A letter “M” in the sub image designates a mass shadow candidate, and a letter “C” designates microcalcification clusters. At the upper left of the hardcopy, patient information 200c such as patient ID is displayed.

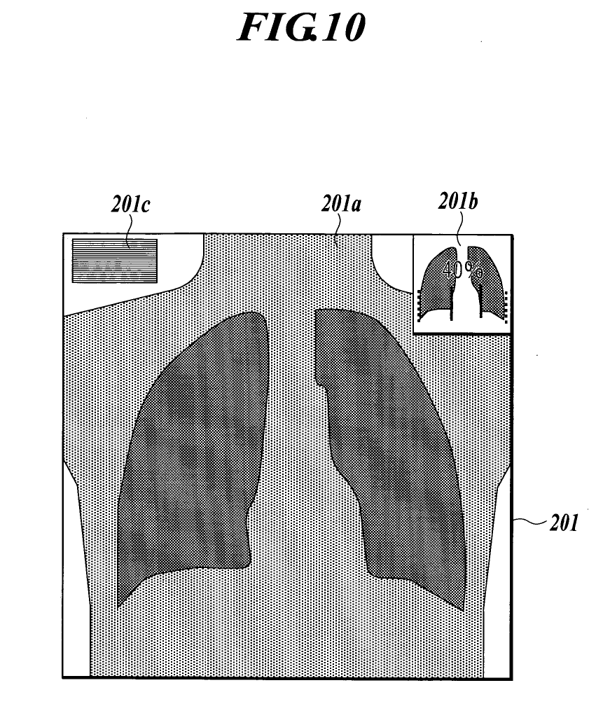

FIG. 10 shows an example of a hardcopy 201 of a medical image outputted from the image recording device. As shown in FIG. 10, in the hardcopy 201, a chest front image of a main image 201a and a sub image 201b showing a cardiothoracic ratio obtained by measuring the chest front image 201a are printed as one hardcopy. In the sub image, a measured location and a measurement result “40%” are displayed. At the upper left of the hardcopy, patient information 201c such as patient ID is displayed.

In such a way, in the above-mentioned medical image processing system 10, the diagnosis aid information in regard to the image data inputted from the image input section 11 is generated. The image processing suitable for a diagnosis is performed on the input image data to generate a main image. Moreover, by performing image processing suitable as reference, a sub image is generated. Then, the size adjustment of each image and the determination of the insertion location of the sub image are performed without the sub image disturbing a diagnosis on the main image. By adding the diagnosis aid information to the sub image, the main image and the sub image are synthesized to be outputted as one hardcopy.

Consequently, it is possible to perform the image processing, the size adjustment and the arrangement all of which are suitable for diagnosis, on the input image data, automatically. Then, one image to be displayed, which is composed of a main image and a sub image displaying diagnosis aid information therein can be generated to be outputted. As a result, even when a hardcopy such as silver halide film is image-diagnosed with an image observation device such as Schaukasten in a conventional way, the diagnosis aid information can be easily and rapidly referred to and used, and thereby diagnosis performance and working efficiency of a doctor can be improved without changing operation flow in a hospital. Moreover, since a main image to be image-diagnosed and a sub image as reference are displayed on one sheet of film, film cost can be decreased. Moreover, since image processing, size adjustment and locating all of which are suitable for diagnosis are performed on an output image, the following problematic work decreases. That is, if it is clear at the time of image diagnosis that gradation or frequency characteristic is not preferable for the diagnosis, or that the size or the location of a sub image is not preferable for the diagnosis, image processing or the size is manually adjusted for re-outputting film to be carried to a location where the image diagnosis is performed. Consequently, film cost of re-outputting, and hours and labor costs necessary for the work can be reduced.

Incidentally, the image processing section 15, the diagnosis aid information generating section 13, and the display formatting section 17 may be realized by software processing performed in cooperation with a CPU (Central Processing Unit) and a program stored in a ROM (Read Only Memory), or may be configured by means of dedicated hardware. Moreover, the present invention can also adopt a way in which the image data storage section 12, the diagnosis aid information storage section 14, the image processing condition storage section 16, the display format storage section 21, and the image recording device information storage section 22 are stored in the same recording device or the same recording medium.

Moreover, in the present embodiment, the structure in which the image processing section 15 performs the image processing on an original image to generate a processed image and then the display formatting section 17 performs the size adjustment and the location on the processed image is shown. However, a structure in which the image processing, and the size adjustment and the location on the original image are simultaneously executed can be adopted.

Moreover, when a plurality of different types of abnormal shadow candidates and measurement results exist per one piece of image data, a sub image may be generated per each piece of diagnosis aid information. In this case, the sub image is not complicated, and the diagnosis aid information can be suitably notified to a doctor. Moreover, when there is no detection despite the detection of an abnormal shadow candidate being performed, no sub image may be displayed.

[Second Embodiment]

Next, a second embodiment of the present invention will be described.

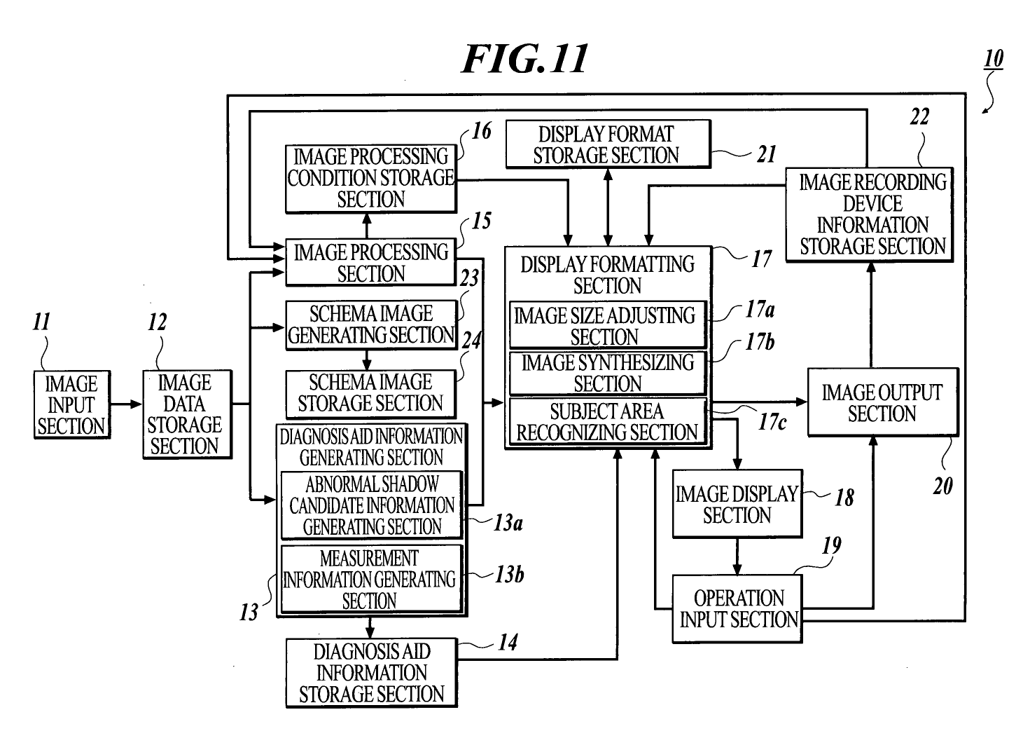

As shown in FIG. 11, in the second embodiment, the medical image processing system 10 has a structure having a schema image generating section 23 and a schema image storage section 23 in addition to the structure of the first embodiment.

The schema image generating section 23 performs contour extraction by analyzing image data inputted from the image data storage section 12 to generate a schema. As an extraction method of contours, as shown in, for example, Japanese Patent Application Publication (Unexamined) No. Tokukai-Sho 63-240832, focusing on a row or a column in image data, in its one-dimensional density data sequence, a specific pattern in which relation of values of data located before and after is in advance determined (for example, a point of local minimum, a point where an inclination is maximum, a point where an inclination is minimum, or the like) is set as a contour point in the row or the column, then contour points in the row or the column in a necessary range are obtained, and a line connecting the obtained contour points is set as a borderline. Otherwise, another known borderline extraction method (for example, in a mammography, Japanese journal of medical electronics and biological engineering, Vol.39, No.4, pp297-304,2001) may be used. The schema image generated in such a way is stored in the schema image storage section 24.

The schema image storage section 24 stores the schema image generated by the schema image generating section 23 as related to image data. To put it concretely, the image data and the schema image are made to correspond to each other by means of a radiographic ID for identifying the image data. Or, the schema image may be stored within the header information of the image data in the image data storage section 12. Since the image data and the schema image thereof are stored as related to each other in such a way, thereby, when formatting conditions for display other than the schema are to be modified to be re-outputted, the display formatting section 17 loads the stored schema image to generate an image to be displayed, and it is not necessary to re-generate schema image. Thereby, processing loads can be reduced.

The image processing section 15 performs the image processing such as gradation processing, frequency processing, dynamic range compression processing and the like on image data and outputs the processed image data to the display formatting section 17.

Hereupon, in the second embodiment, the image processing section 15 performs the image processing such as the gradation processing, the frequency processing, the dynamic range compression processing and the like on the image data inputted from the image data storage section 12, and generates a main image. The schema image generating section 23 generates a schema from the image data inputted from the image data storage section 12 as a sub image. That is, the image processing section 15 and the schema image generating section 23 in the present embodiment constitute an image processing section in the present invention.

When image data is outputted from the image processing section 15, the display formatting section 17 loads a corresponding schema image from the schema image storage section 23, and sets the image data as a main image and the schema image as a sub image. Then, the display formatting section 17 performs the size adjustment, the image synthesis, the image adjustment similar to those described in the first embodiment, and outputs the processed images to the image display section 18.

Since the other structures of the medical image processing system 10 are similar to those of the above-mentioned first embodiment, their description is omitted.

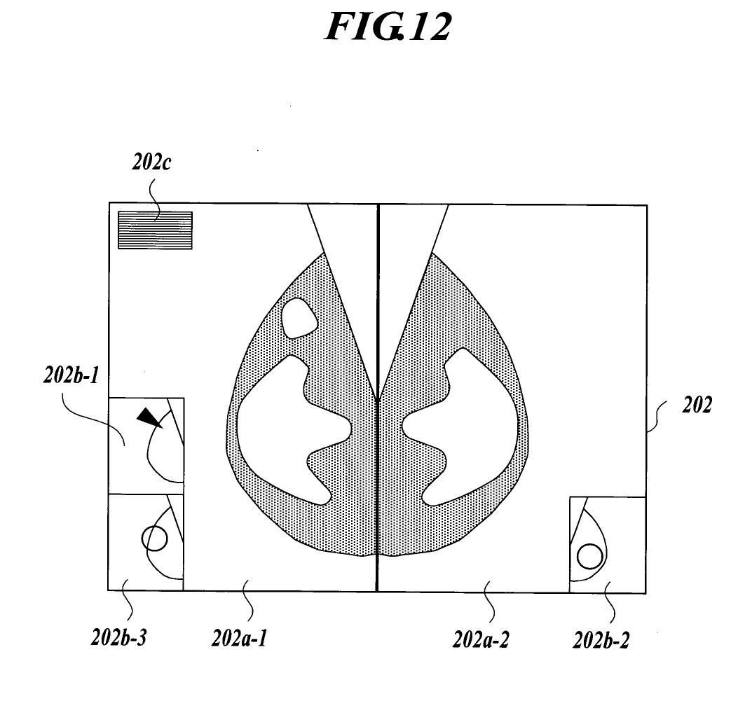

FIG. 12 shows an example of a hardcopy 202 of a medical image outputted from the image recording device. As shown in FIG. 12, in the hardcopy 202, two images, which are a mammogram of the right breast and a mammogram of the left breast, to be displayed are printed on one sheet of film. In FIG. 12, a reference numeral 202a-1 designates a main image of the mammogram of the right breast, and reference numeral 202b-1 and 202b-3 designates its sub images. A reference numeral 202a-2 designates a main image of the mammogram of the left breast, and a reference numeral 202b-2 designates its sub image. In each sub image, an abnormal shadow candidate is shown with annotation. All the sub images are schema images. Apart in a sub image referred to by a triangle indicates a mass candidate, and a part surrounded by ◯ indicates microcalcification. As for the right breast, two abnormal shadow candidates of a mass candidate and microcalcification are detected, and one sub image is displayed per each candidate. At an upper left of the hardcopy, patient information 202c such as patient ID or the like is displayed.

As described above, since only one diagnosis result is displayed in one sub image, each image is not complicated, and diagnosis aid information can be suitably notified to a doctor. When the detection of abnormal shadow candidates results in no candidate detected, no sub image may be displayed.

As described above, in the above-mentioned medical image processing system 10, the diagnosis aid information in regard to the image data inputted from the image input section 11 is generated, and the image processing suitable for diagnosis is applied on the input data to generate a main image and schema sub images. Then, the size adjustment of each image and the determination of the insertion location of the sub images are performed so that the sub images do not disturb the diagnosis on the main image, and the main image and the sub images are synthesized by adding the diagnosis aid information to the sub images into one hardcopy to be outputted.

Consequently, the image processing, the size adjustment and the location of input image data suitable for diagnosis can be automatically realized, and one image to be displayed composed of a main image and schema sub images displaying diagnosis aid information can be generated and outputted. As a result, even when image diagnosis is to be performed on a hardcopy such as silver halide film with an image observation device such as Schaukasten or the like in a conventional way, diagnosis aid information can be easily and rapidly referred to and used, and thereby the diagnosis performance and the working efficiency of a doctor can be improved without changing the operation flow in a hospital. Moreover, since a main image for image diagnosis and a sub image for reference are displayed on one sheet of film, film cost can be decreased. Moreover, since image processing, size adjustment and locating, which are suitable for diagnosis, are performed on an output image, if it is clear at the time of image diagnosis that gradation or frequency characteristic is not preferable for diagnosis, or that the size or the location of a sub image is not preferable for diagnosis, the image processing or the size does not have to be manually adjusted for re-outputting film to be carried to a location where the image diagnosis on the film is performed. Consequently, the film cost of re-outputting, and the hours and the labor cost necessary for the work can be reduced.

Incidentally, contents described in the first and the second embodiments are only suitable examples of the medical image processing system 10 according to the present invention, and the present invention is not limited to the contents. For example, the image processing section 15 in the second embodiment may include a function of generating a sub image similarly to the first embodiment to enable a user to select whether an image obtained by applying the image processing on an output form of a sub image or a schema image.

In addition, the detailed structure and the detailed operation of the medical image processing system 10 may be suitably modified without departing from the essence of the present invention.

[Third Embodiment]

First, a structure of a third embodiment will be described.

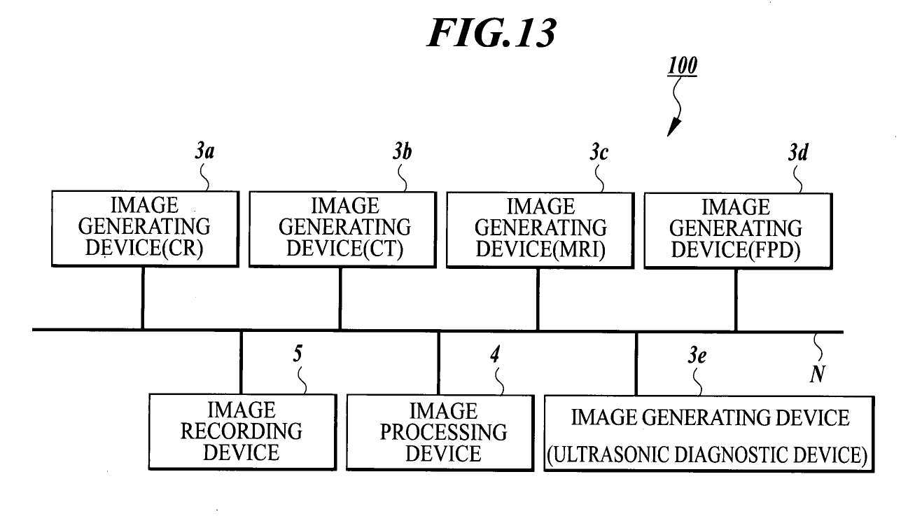

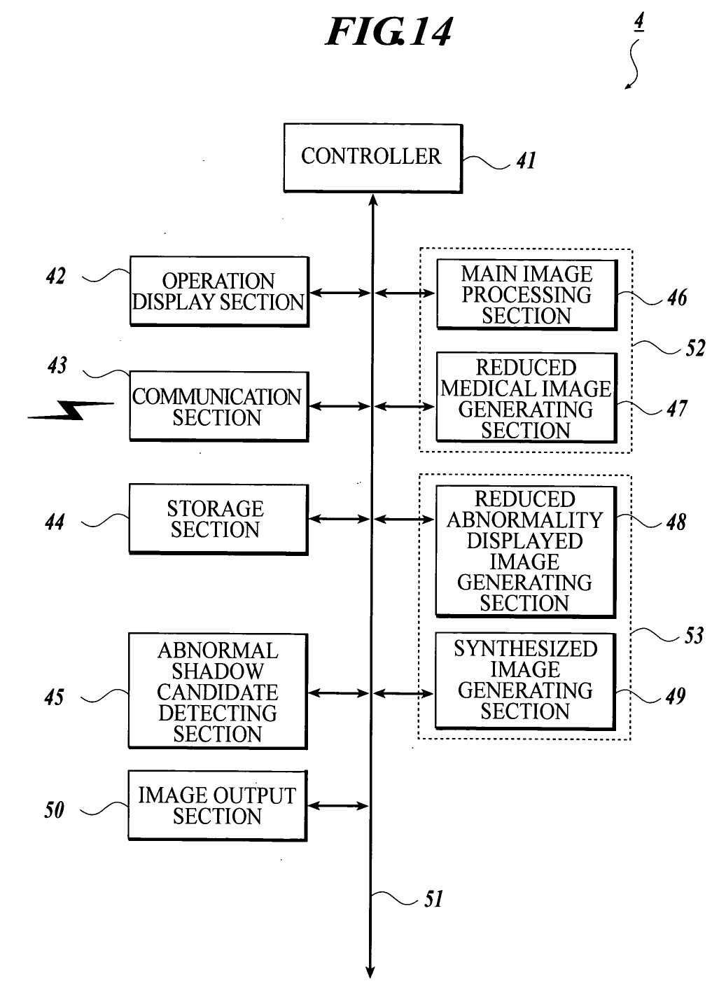

FIG. 13 is a conceptual diagram showing a whole structure of a medical image processing system 100 in the present embodiment. As shown in FIG. 13, in the medical image processing system 100, image generating devices 3a to 3e, an image processing device 4, an image recording device 5 and the like are connected to one another through a network N in the state capable of data transmitting and receiving thereamong.

Incidentally, in the present embodiment, an example of the structure in which the image generating devices 3a to 3e, the image processing device 4 and the image recording device 5 are connected to one another through the network N will be described. However, the structure of the system is not limited to such one, and the system structure in which each device is directly connected to one another with wires may be used. Moreover, the number of respective devices and the installation location of respective devices are not limited in particular.

As the network N, various circuit forms such as a local area network (LAN), a wide area network (WAN), the Internet or the like can be applied. Incidentally, if permitted in a medical institution such as a hospital, radio communication or infrared-ray communication may be applied. However, since important patient information is included, preferably, the information to be transmitted and received is encoded. Moreover, as a communication system in a hospital, DICOM (Digital Image and Communications in Medicine) standard is generally used. In the communication among each device in the network N, DICOM MWM (Modality Worklist Management) or DICOM MPPS (Modality Performed Procedure Step) is used.

The image generating devices 3a to 3e are composed of modalities such as CR (Computed Radiography), FPD (Flat Panel Detector), CT (Computed Tomography), MRI (Magnetic Resonance Imaging), ultrasonic diagnostic equipment and the like. The image generating devices 3a to 3e are devices for radiographing a human body and performing digital conversion on a radiographed image to generate a medical image. In the present embodiment, a case where the image generating device 3a is CR, the image generating device 3b is CT, the image generating device 3c is MRI, the image generating device 3d is a FPD, and the image generating device 3e is ultrasonic diagnostic equipment will be explained as an example.

Hereupon, though the effective pixel size changes depending on a radiographic part and a diagnosis purpose, in regard to, for example, a mammogram (a radiation image of a breast), the image data generated by the image generating devices 3a to 3e to be outputted to the image processing device 4 preferably has an effective pixel size of an image not more than 200 μm, more preferably not more than 100 μm. In order to bring out performance of the image processing device 4 in the present invention to the utmost extent, a structure using the image data generated to have an effective pixel size of, for example, approximately 50 μm is preferable.

Incidentally, the image generating devices 3a to 3e are devices based on the above-mentioned DICOM standard. Therefore, the image generating devices 3a to 3e can input information accompanying an image (hereinafter referred to as “accompanying information”) to a medical image in accordance with DICOM, or can automatically generate the accompanying information. The image generating devices 3a to 3e are set to output image data of generated medical image to the image processing device 4 through the network N along with the accompanying information of the medical image as the header information of the image data. In case of not being based on the DICOM standard, the accompanying information can be inputted by means of a not shown DICOM conversion device.

As the accompanying information of a medical image, for example, patient information related to a patient such as patient name of a radiographed patient, patient ID, age, sex and the like; and radiographing information such as a radiographing date, examination ID, a radiographic part, radiographing conditions (a body position, a radiographing direction and the like), image generating device (a modality type) information and the like are included therein.

The image processing device 4 reduces the medical image supplied from the image generating devices 3a to 3e to generate a reduced medical image, and detects an abnormal shadow candidate in the image data of the medical image to generate a reduced abnormality displayed image by overlapping the detected abnormal shadow candidate on the reduced medical image. Then, the image processing device 4 locates the reduced medical image of the medical image, the reduced medical images of other medical images in regard to the medical image, and a reduced abnormality displayed image of the medical image or reduced abnormality displayed images of the other medical images in regard to the medical image so as to maintain the information in the subject area of the medical image, and synthesizes the images to be outputted to the image recording device 5.

Hereupon, as the other medical images in regard to the medical image, for example, a medical image generated by radiographing the same radiographic part of the same patient from different radiographing directions can be cited.

The image recording device 5 outputs a hardcopy which is regenerated as a visual image from the image data inputted from the image processing device 4.

Next, an inner structure of the image processing device 4 will be described.

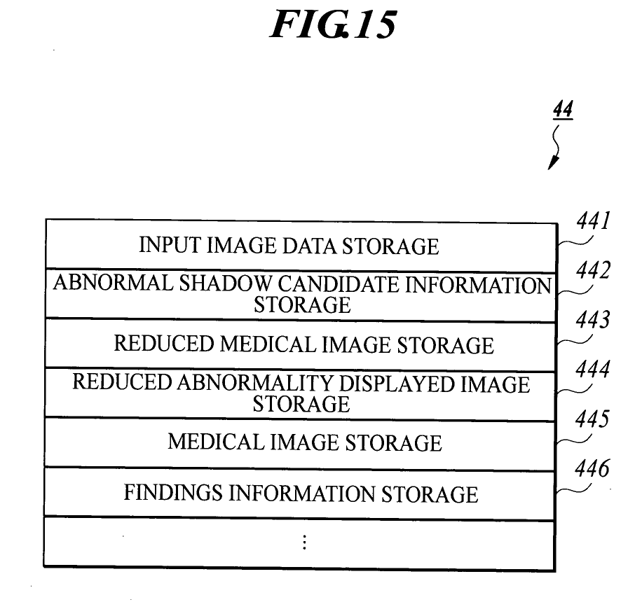

FIG. 14 is a diagram showing a structure of principal parts of the image processing device 4 in the present embodiment. In FIG. 14, the image processing device 4 comprises a controller 41, an operation display section 42, a communication section 43, a storage section 44, an abnormal shadow candidate detecting section 45, a main image processing section 46, a reduced medical image generating section 47, a reduced abnormality displayed image generating section 48, a synthesized image generating section 49, an image output section 50 and the like. Each part of the image processing device 4 is connected to one another through a bus 51. The main image processing section 46 and the reduced medical image generating section 47 constitute an image processing section 52. The reduced abnormality displayed image generating section 48 and the synthesized image generating section 49 constitute a display formatting section 53.

The controller 41 comprises a CPU, a ROM, a RAM and the like. The CPU loads a system program and a processing program, both stored in the ROM, and develops them in the RAM. The CPU controls each part of the image processing device 4 in accordance with the developed program, and executes various kinds of processing including image output control processing A, which will be described later, and the like.

The operation display section 42 is composed of an LCD, and displays various operation buttons, a state of the devices, preview display of a synthesized image generated by the image processing device 4, and the like on a display screen. The display screen of the LCD is covered by a pressure-sensitive-type (resister film pressure type) touch panel composed of transparent electrodes arranged in a grid-like state. The display screen detects an X-Y coordinate of a force point pushed by a finger, a touch pen or the like as a voltage value, and outputs the detected location signal as an operation signal. Incidentally, a display device and an input device may be configured to be separated bodies. As the display device, a CRT, a liquid crystal display, a plasma display and the like can be used. As the input device, a keyboard equipped with function keys corresponding to various functions such as cursor keys, numeral inputting keys, a decision key and the like, and a pointing device such as a mouse or the like can be used. The operation display section 42 functions as a findings information input means for inputting findings information, and an output form selection means for selecting the output form of an image.

The communication section 43 is composed of a communication interface such as a network interface card, a modem, a terminal adapter or the like, and transmits and receives various kinds of information with external equipment on the network N.

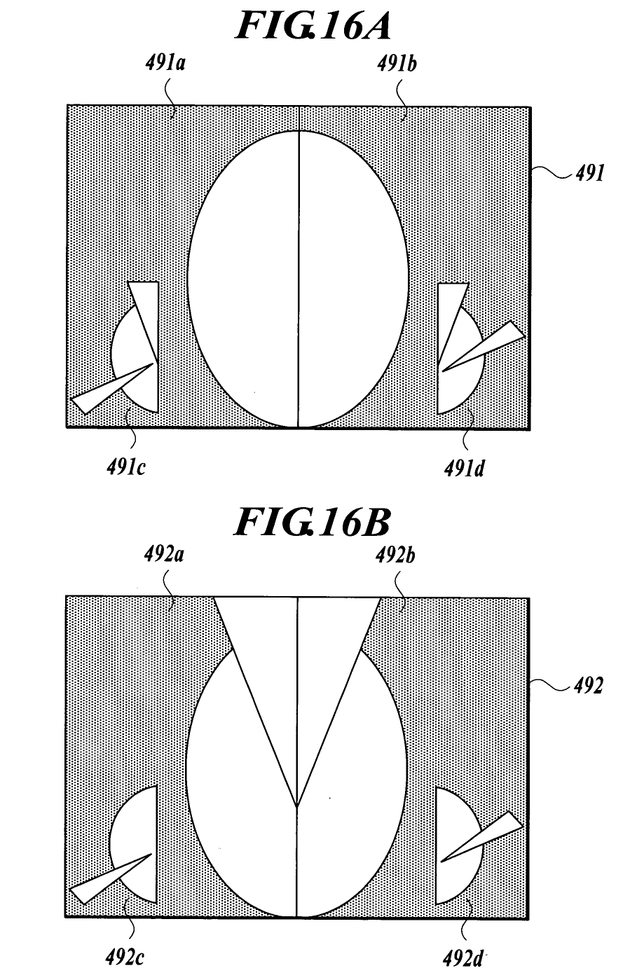

The storage section 44 is composed of HDD (Hard Disc), a semiconductor nonvolatile memory or the like. FIG. 15 shows a structure of the storage section 44. As shown in FIG. 15, the storage section 44 comprises an input image data storage 441, an abnormal shadow candidate information storage 442, a reduced medical image storage 443, a reduced abnormality displayed image storage 444, a medical image storage 445, and a findings information storage 446.

The input image data storage 441 stores the image data (hereinafter referred to as “image data D”) of the medical image inputted from the image generating devices 3a to 3e through the communication section 43 as related to the accompanying information including the examination ID and the like. The abnormal shadow candidate information storage 442 stores the abnormal shadow candidate information inputted from the abnormal shadow candidate detecting section 45 according to the image data D, as related to the image data D by means of an examination ID or the like. The reduced medical image storage 443 stores the reduced medical image data inputted from the reduced medical image generating section 47 according to the image data D, as related to the image data D by means of an examination ID or the like. The reduced abnormality displayed image storage 444 stores the reduced abnormality displayed image data inputted from the reduced abnormality displayed image generating section 48 according to the image data D, as related to the image data Dby means of an examination ID or the like. The medical image storage 445 stores the medical image data, which already has been processed as a main image, inputted from the main image processing section 46, as related to the image data D by means of an examination ID or the like.

The abnormal shadow candidate detecting section 45 loads image data from the input image data storage 441 to perform the image analysis thereof, and then detects candidate area which appears to be abnormal shadow to output the detection result thereof to the abnormal shadow candidate information storage 442. The abnormal shadow candidate detecting section 45 has a plurality of abnormal shadow candidate detecting algorithms according to each lesion type. At the time of detection, the abnormal shadow candidate detecting section 45 applies an algorithm according to the radiographic part on the image data D to perform the detection processing of an abnormal shadow candidate.

In mammography, shadow which appears to be mass or microcalcification clusters, which are the features of breast cancer, is detected. Mass shadow is a lump having a certain degree of size, and appears as whitish round shadow having a distribution close to a Gaussian distribution in mammography. Microcalcification clusters are a gathered (clustered) micro-calcified part. The existence of the microcalcification clusters indicates a high possibility of cancer at an earlier stage. The microcalcification clusters appear as whitish round shadow having an almost conic structure.

In the following, an algorithm for detecting the above-mentioned mass shadow and microcalcification clusters shadow will be described.

The abnormal shadow candidate detecting section 45 can apply the well-known detection methods disclosed in the following theses as the algorithm suitable for the detection of mass shadow

a detection method by comparing left and right mammas (Med.Phys.,Vol.21.No.3,pp445-452)

a detection method by using Iris filter (IEICE transactions (D-II), Vol.J75-D-II,no.3,pp.663-670,1992)

a detection method by using Quoit filter (IEICE transactions (D-II), Vol.J76-D-II,no.3,pp.279-287,1993)

a detection method with binarization based on histogram of pixel values of divided mamma areas (Jamit Frontier lecture collected papers,pp.84-85,1995)

a minimum direction differential filter picking up minimum output from a large number of Laplacian filters having polarity (IEICE transactions (D-II), Vol.J76-D-II,no.2,pp.241-249,1993)

a method for distinguishing benignity or malignity of mass shadow by use of fractal dimensionality (Medical Imaging technology 17 (5),pp.577-584,1999)

Further, as an algorithm suitable for detecting microcalcification clusters shadow, it is possible to use well-known detection methods written in the following theses:

a method of deleting a false positive candidate in accordance with an optical density difference of shadow figure, standard deviation of a boundary density difference or the like, by localizing an area where there is a suspicion of calcification in a mamma area (IEEE Trans Biomed Eng BME-26(4):213-219,1979)

a detection method by using an image on which Laplacian filter processing is applied (IEICE transactions (D-II), Vol.J71-D-II,no.10,pp.1994-2001,1988)

a detection method using a morphologically analyzed image in order to inhibit a background pattern such as mammary gland or the like (IEICE transactions (D-II), Vol.J71-D-II,no.7,pp.1170-1176,1992)

Moreover, as an algorithm for detecting other abnormal shadow candidates, for example, it is possible to use well-known detection methods in the following:

detection of nodular shadow in a thoracic image

Japanese Patent Application Publication (Unexamined) No. Tokukai-Hei 6-121792

detection of shadow of interstitial diseases in a thoracic image

Japanese Patent Application Publication (Unexamined) No. Tokukai-Hei 2-185240

The abnormal shadow candidate detecting section 45 detects an abnormal shadow candidate by means of the above-mentioned algorithms. At the time of detection, the abnormal shadow candidate detecting section 45 calculates various feature quantity concerning candidate area such as location information, size (area), slenderness ratio, degree of a circular form, contrast therewithin, standard deviation, intensity component of density gradient from a peripheral part to a center part, direction component and the like. Moreover, the abnormal shadow candidate detecting section 45 generates annotation information for illustrating the candidate area by means of a letter, a marker or the like on the basis of the location information of the candidate area. Then, the abnormal shadow candidate detecting section 45 outputs the above-mentioned calculated various feature quantity and annotation information as abnormal shadow candidate information to the abnormal shadow candidate information storage 442 as related to an examination ID, the algorithm information used in the detection, the threshold value (detection parameter) used in the detection algorithm, a detected lesion type, an appointed number of the lesion, and the like.

The main image processing section 46 and the reduced medical image generating section 47 constitute the image processing section 52. The image processing section 52 performs the image processing including gradation processing on the image data D by the main image processing section 46 to generate medical image data as a main image for diagnosis, and performs the image processing including reduction processing and the like on the image data D by the reduced medical image generating section 47 to generate reduced medical image data as a sub image.

The main image processing section 46 loads the image data D from the input image data storage 441 on the basis of an instruction from the controller 41, and performs various kinds of image processing to modify the loaded image data D to be a medical image suitable for diagnosis. Then, the main image processing section 46 outputs the processed medical image data to the medical image storage 445 as a main image. The image processing includes gradation processing for adjusting contrast of an image, frequency processing for adjusting sharpness, dynamic range compression processing for fitting an image having a wide dynamic range into a density range within which an image is easy to observe without decreasing contrast of the details of a subject, and the like. Moreover, the main image processing section 46 analyses the image data D to recognize the subject area, and performs the density correction on area other than the subject area so as to make the area have more than a predetermined density value, for example, a density value higher than the minimum density value in the subject area.

The recognition of the subject area is performed by, for example, analyzing the image data D to extract the borderline of the subject or the like. For example, the density data of the image data D is binarized by the use of an appropriate threshold value, and the boundary between “0” and “1” is traced to be a borderline. Then, the subject area is determined according to the borderline, the radiographic part, the body position and the radiographing direction. Otherwise, the subject area may be determined by means of the borderline extraction method of human body area or area corresponding to a predetermined anatomical structure within a human body (see Journal of Japan Association of Breast Cancer Screening, Vol.17,No.1,pp87-102,1998 and Japanese Patent Application Publication (Unexamined) No. Tokukai-Sho 63-240832).

The reduced medical image generating section 47 loads the image data D from the input image data storage 441 on the basis of an instruction from the controller 41 to reduce the loaded image data D at a predetermined magnifying rate. The image reduced medical image generating section 47 performs the image processing such as gradation processing, frequency processing or the like on the reduced image data to generate reduced medical image data. Moreover, by the above-mentioned subject recognizing methods, the reduced medical image generating section 47 recognizes the subject area of the image data set as the reduced sub image, and performs the density correction on area other than the subject area so as to make the area have more than a predetermined density, for example, a density value higher than the minimum density value in the subject area. Thereby, the image reduced medical image generating section 47 generates reduced medical image data to output the generated reduced medical image data to the reduced medical image storage 443.

The reduced abnormality displayed image generating section 48 and the synthesized image generating section 49 constitute the display formatting section 53. The display formatting section 53 generates synthesized image data as one piece of image data for display on the basis of the processed medical image data generated by the image processing section 52 as a main image and the reduced medical image data as a sub image.

The reduced abnormality displayed image generating section 48 loads reduced medical image data from the reduced medical image storage 443 on the basis of an instruction from the controller 41. Moreover, the reduced abnormality displayed image generating section 48 loads the location information and the annotation information of abnormal shadow candidate area among the abnormal shadow candidate information corresponding to the reduced medical image data from the abnormal shadow candidate information storage 442 by means of an examination ID or the like. Then the reduced abnormality displayed image generating section 48 overlaps the annotation information on the location of the abnormal shadow candidate area of the reduced medical image data to generate reduced abnormality displayed image data, and outputs the generated reduced abnormality displayed image data to the reduced abnormality displayed image storage 444. Incidentally, the location information and the annotation information of the abnormal shadow candidate area are preferably reduced according to the reduction magnifying rate of the reduced medical image to be overlapped on the reduced medical image.

The synthesized image generating section 49 loads medical image data which has already been image-processed from the medical image storage 445 on the basis of an instruction from the controller 41, and loads the reduced medical image data or the reduced abnormality displayed image data which are to be synthesized with the medical image data from the corresponding storage of the storage section 44. Then, the synthesized image generating section 49 synthesizes the medical image and the reduced medical image or the reduced abnormality displayed image into one image. In this case, the synthesized image generating section 49 recognizes the subject area in the medical image by means of the above-mentioned subject area recognizing methods, and performs the size alteration of the reduced medical image or the reduced abnormality displayed image, which are to be synthesized, according to the ratio between the subject area and area other than the subject area in the medical image so as to locate the reduced medical image or the reduced abnormality displayed image with the information of the subject area in the medical image maintained. At this time, when a plurality of reduced medical images or reduced abnormality displayed images, each of which is to be synthesized with the medical image, exist, the size alteration is performed so that the reduction rate of each of the plurality of reduced medical images or reduced abnormality displayed images is the same. Otherwise, the size may be adjusted so that the size of each image is not dispersed or each image has the same size on the basis of the setting by the operation display section 42. Then, the synthesized image generating section 49 adds the information indicating scale calibration and/or a reduction ratio to the located reduced medical image or the reduced abnormality displayed image to generate a synthesized image.

Incidentally, in the present embodiment, the synthesized image generating section 49 has a function of a size information adding means to perform the addition of the scale calibration or the addition of the reduction ratio. However, the addition of the size information may be performed by the reduced medical image generating section 47, the reduced abnormality displayed image generating section 48 or the like. Moreover, the information indicating the reduction ratio and the scale calibration can be in advance set to be added or not to be added by an input from the operation display section 42 severally.

Hereupon, when the medical image to be synthesized on the basis of an instruction from the controller 41 is mammography, the synthesized image generating section 49 performs the synthesis processing of synthesizing two sheets of mammography as main images among four sheets of mammography generated by radiographing both the left and right breasts severally from two directions (right breast oblique direction; MLO-R, left breast oblique direction; MLO-L, right breast vertical direction; CC-R, left breast vertical direction; CC-L) in one examination on the same patient (namely, having the same examination ID) so as to output one sheet of recording medium having the two sheets of mammography as one image. After that, the synthesized image generating section 49 performs the synthesis of each synthesized medical image (main image) with a sub image, which is reduced medical image data of either each medical image or another medical image (for example, mammography radiographed from another radiographing direction) associated with each medical image, or reduced abnormality displayed image data of either each medical image or each medical image associated with each medical image. As a synthesizing form of mammography, the synthesis is performed, for example, in the following synthesizing forms on the basis of an instruction from the controller 41.

(1) medical images (MLO-R, L) and reduced medical images (CC-R, L)

(2) medical images (CC-R, L) and reduced medical images (MLO-R, L)

(3) medical images (MLO-R, CC-R) and reduced medical images (MLO-L, CC-L)

(4) medical images (MLO-L, CC-L) and reduced medical images (MLO-R, CC-R)

(5) medical images (MLO-R, L) and reduced abnormality displayed images (CC-R, L)

(6) medical images (CC-R, L) and reduced abnormality displayed images (MLO-R, L)

(7) medical images (MLO-R, CC-R) and reduced abnormality displayed images (MLO-L, CC-L)

(8) medical images (MLO-L, CC-L) and reduced abnormality displayed images (MLO-R, CC-R)

That is, the synthesized image generating section 49 synthesizes the reduced medical image or the reduced abnormality displayed image of other mammography for reference over each of two sides of mammography. Thereby, at the time of image diagnosis by a doctor, an image related to the mammography for diagnosis can be easily referred to efficiently.

FIG. 16A shows an example of a synthesized image 491 when images are synthesized in the form of the output form (6). In FIG. 16A, a reference numeral 491a designates CC-R. A reference numeral 491b designates CC-L. A reference numeral 491c designates a reduced abnormality displayed image of MLO-R. A reference numeral 491d designates a reduced abnormality displayed image of MLO-L.

Moreover, FIG. 16B shows an example of a synthesized image 492 when images are synthesized in the form of the output form (5). In FIG. 16B, a reference numeral 492a designates MLO-R. A reference numeral 492b designates MLO-L. A reference numeral 492c designates a reduced abnormality displayed image of CC-R. A reference numeral 492d designates a reduced abnormality displayed image of CC-L. Incidentally, display of a reduction ratio and scale calibration on the reduced medical images and the reduced abnormality displayed images is omitted.

Otherwise, when a medical image is mammography, on the basis of an instruction from the controller 41, the synthesized image generating section 49 locates a reduced medical image of a main image or a reduced abnormality displayed image of the main image, and a reduced medical image or a reduced abnormality displayed image radiographed from other directions as sub images on mammography as a main image for diagnosis, and synthesizes the images. Thereby, since reduced medical images or reduced abnormality displayed images radiographed from two directions are synthesized over one medical image, reference can be easily performed, and it is possible to perform image diagnosis effectively. To put it concretely, the synthesized image generating section 49 performs synthesis, for example, in any one of the following forms (9) to (16) on the basis of an instruction from the controller 41.

(9) a medical image (MLO-R) and reduced medical images (MLO-R, CC-R)

(10) amedical image (MLO-L) and reduced medical images (MLO-L, CC-L)

(11) a medical image (CC-R) and reduced medical images (MLO-R, CC-R)

(12) a medical image (CC-L) and reduced medical images (MLO-L, CC-L)

(13) a medical image (MLO-R) and reduced abnormality displayed images (MLO-R, CC-R)

(14) a medical image (MLO-L) and reduced abnormality displayed images (MLO-L, CC-L)

(15) a medical image (CC-R) and reduced abnormality displayed images (MLO-R, CC-R)

(16) a medical image (CC-L) and reduced abnormality displayed images (MLO-L, CC-L)

The synthesizing forms (9) to (16) may be performed by synthesizing in two-side output on one sheet of recording medium.

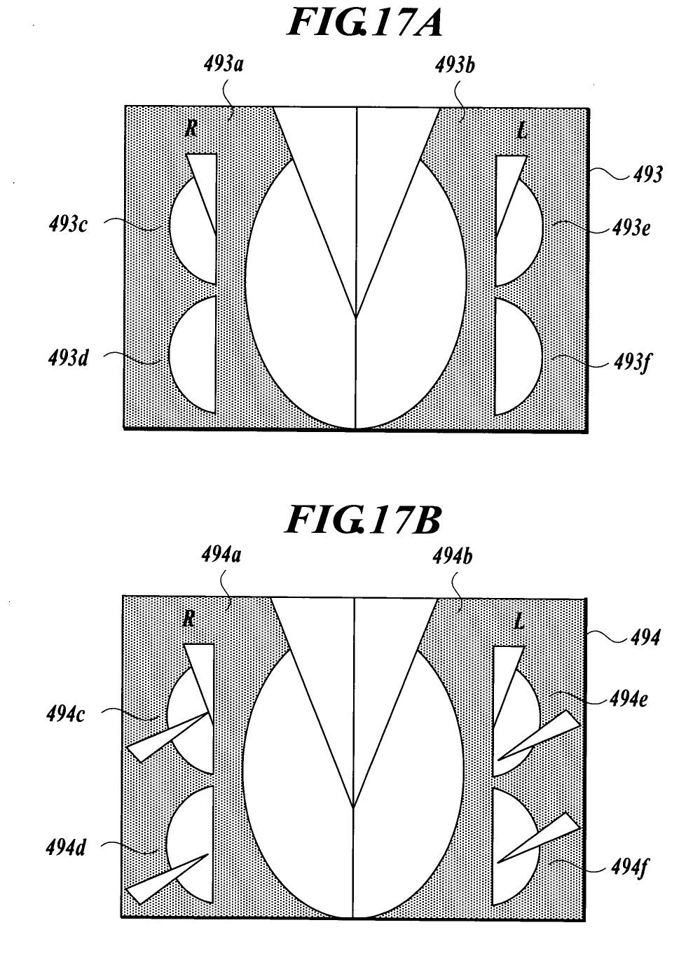

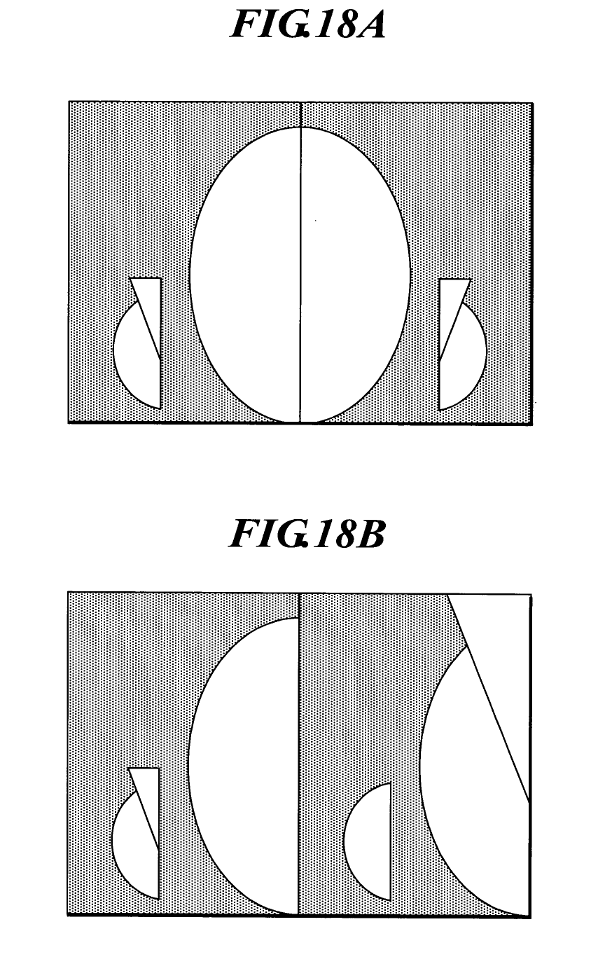

FIG. 17A shows an example of a synthesized image 493 when the output forms (9) and (10) are performed in two-side output on one sheet of recording medium. In FIG. 17A, a reference numeral 493a designates MLO-R. A reference numeral 493b designates MLO-L. A reference numeral 493c designates a reduced medical image of MLO-R. A reference numeral 493d designates a reduced medical image of CC-R. A reference numeral 493e designates a reduced medical image of MLO-L. A reference numeral 493f designates a reduced medical image of CC-L.

Moreover, FIG. 17B shows an example of a synthesized image 494 when the output forms (13) and (14) are performed in two-side output on one sheet of recording medium. In FIG. 17B, a reference numeral 494a designates MLO-R. A reference numeral 494b designates MLO-L. A reference numeral 494c designates a reduced abnormality displayed image of MLO-R. A reference numeral 494d designates a reduced abnormality displayed image of CC-R. A reference numeral 494e designates a reduced abnormality displayed image of MLO-L. A reference numeral 494f designates a reduced abnormality displayed image of CC-L. Incidentally, display of a reduction ratio and scale calibration on the reduced medical images and the reduced abnormality displayed images is omitted.

In addition, for example, outputs may be performed in the following output forms.

(17) medical images (MLO-R, CC-R), reduced medical images (CC-R, MLO-R)

(18) medical images (MLO-L, CC-L), reduced medical images (CC-L, MLO-L)

(19) medical images (MLO-R, CC-R), reduced abnormality displayed images (CC-R, MLO-R)

(20) medical images (MLO-L, CC-L), reduced abnormality displayed images (CC-L, MLO-L)

(21) medical images (MLO-R, L), reduced abnormality displayed images (MLO-R, L)

(22) medical images (CC-R, L), reduced abnormality displayed images (CC-R, L)

(23) medical images (MLO-R, CC-R), reduced abnormality displayed images (MLO-R, CC-R)

(24) medical images (MLO-L, CC-L), reduced abnormality displayed images (MLO-L, CC-L)

Hereupon, when mammography images of both sides of breast radiographed from the same radiographing direction are outputted in two-side output on the left side and the right side on one sheet of recording medium as main images (for example, CC-R and CC-L), synthesis is performed so that the relative location relation between the mammography for diagnosis as the main images and a reduced medical image or a reduced abnormality displayed image on each mammography as a sub image is set symmetrical at the left side and the right side (see FIG. 18A). Moreover, when the mammography images of a left breast or a right breast radiographed from different radiographing directions are outputted in two-side output on one sheet of recording medium (for example, CC-R and MLO-R), synthesis is performed so that the relative location relation between the mammography for diagnosis and a reduced medical image or a reduced abnormality displayed image on each mammography has the same relation on the left side and the right side (see FIG. 18B).

The image output section 50 outputs synthesized image data, i.e. image data to be displayed, generated by the synthesized image generating section 49 to the image recording device 5 through the communication section 43.

In the above, the structure of the image processing device 4 has been described. However, the abnormal shadow candidate detecting section 45, the main image processing section 46, the reduced medical image generating section 47, the reduced abnormality displayed image generating section 48, the synthesized image generating section 49 and the image output section 50 may be realized by software processing in cooperation with the CPU of the controller 41 and the programs stored in the ROM, or they may be configured by dedicated hardware.

Next, operation of the third embodiment will be described.

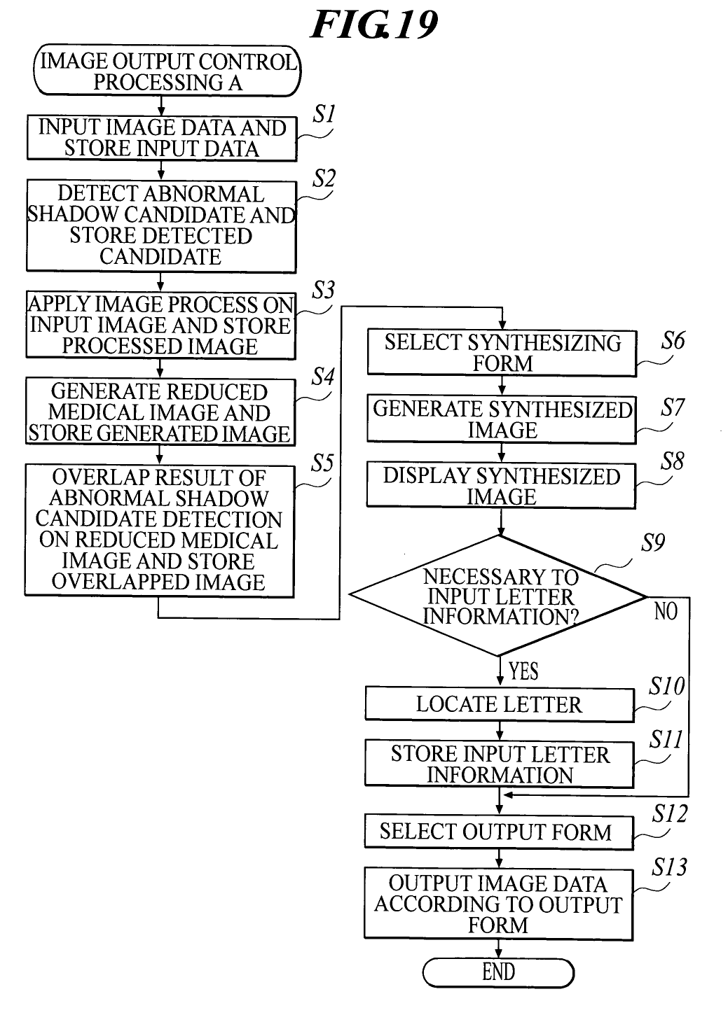

FIG. 19 shows image output control processing A to be executed by the controller 41. In the following, with reference to FIG. 19, the image output control processing A will be described.

When image data D and its accompanying information are inputted from any one of the image generating devices 3a to 3e through the communication section 43, the input image data D and its accompanying information are stored in the input image data storage 441 (Step S1). Successively, the abnormal shadow candidate detecting section 45 loads the image data D and its accompanying information, and the detection of an abnormal shadow candidate is performed on the image data D. Then, a detection result is stored in the abnormal shadow candidate information storage 442 (Step S2). Moreover, the main image processing section 46 loads the image data D and its accompanying information, and image processing such as gradation processing, frequency processing, dynamic range compression processing, and the density correction processing of the outside area of the subject area is performed on the image data D. Then, the processed image data D and its accompanying information are stored in the medical image storage 445 (Step S3).

Next, the reduced medical image generating section 47 loads the image data D from the input image data storage 441. Reduction processing at a predetermined magnifying rate, density correction processing for correcting density of area other than the subject area to have more than predetermined density, and the like are performed, and thereby reduced medical image data is generated to be stored in the reduced medical image storage 443 (Step S4). In addition, the reduced abnormality displayed image generating section 48 loads the location information and the annotation information in abnormal shadow candidate area from the abnormal shadow candidate information according to the image data D stored in the abnormal shadow candidate information storage 442. Then, the annotation information is overlapped on the location of the abnormal shadow candidate area of the reduced medical image data, and thereby the reduced abnormality displayed image data is generated to be stored in the reduced abnormality displayed image storage 444 (Step S5).

Incidentally, when the image data D is mammography and four sheets of the image data D of the both sides of breast radiographed from two radiographing directions severally exist at the same examination ID, the processing in Steps S1 to S5 is executed on each of the image data D. These images are images associated with one another.

Next, when the operation display section 42 displays an instruction of the selection input of a synthesizing form and a synthesizing form is inputted according to selection (Step S6), the synthesized image generating section 49 loads the medical image data corresponding to the selected synthesizing form and the reduced medical image data or the reduced abnormality displayed image data, and the synthesized image generating section 49 synthesizes the loaded data in the synthesizing form selected in Step S6 (Step S7). Hereupon, the synthesized image generating section 49 recognizes the subject area in the medical image, and performs the size alteration on the reduced medical image or the reduced abnormality displayed image to be synthesized according to a ratio between the subject area and area other than the subject area in the medical image. Thereby, the reduced medical image or the reduced abnormality displayed image is located with the information of the subject area maintained. Scale calibration and/or the reduction ratio are added to the located reduced medical image or the reduced abnormality displayed image, and then a synthesized image is generated. As the synthesizing form, it is possible to select any one of the forms (1) to (24), for example, in the case of mammography, with the operation display section 42.

When the synthesized image is generated, the synthesized image is displayed on the display screen of the operation display section 42 (Step S8). When an input instruction of findings information such as a doctor's diagnosis result of “normal/abnormal” to an abnormal shadow candidate and/or comments is performed on this screen and character information is inputted (Step S9; YES), markers indicating inputted distinctions of “normal/abnormal” are added to each abnormal shadow candidate of the synthesized image, and the inputted comments are added to vacant area in area other than the subject area of the medical image. Thereby, the inputted letters are located (Step S10). The inputted information is stored in the findings information storage 446 of the storage section 44 as related to the image data D by means of an examination ID (Step S11). Successively, when an output form (whether the data of the synthesized image is outputted to the image recording device 5, or the medical image data and the reduced medical image data or the reduced abnormality displayed image data are severally outputted to the image recording device 5) is selected on the display screen, and when an output is instructed (Step S12), the image output section 50 outputs the image data corresponding to the selected output form to the image recording device 5 through the communication section 43 (Step S13).

Here, when an output of the data of the synthesized image is instructed in Step S12, the image recording device 5 can easily output an image on which various kinds of information are located for diagnosis. However, since the synthesized image data has a large information amount, there is a problem of amount of communication data being large. Accordingly, when the synthesized image data is not required to be outputted in a case where each image is observed separately or the like, the medical image data, and the reduced medical image data or the reduced abnormality displayed image data are separately transmitted. Thereby, amount of communication data on the network N can be suppressed.

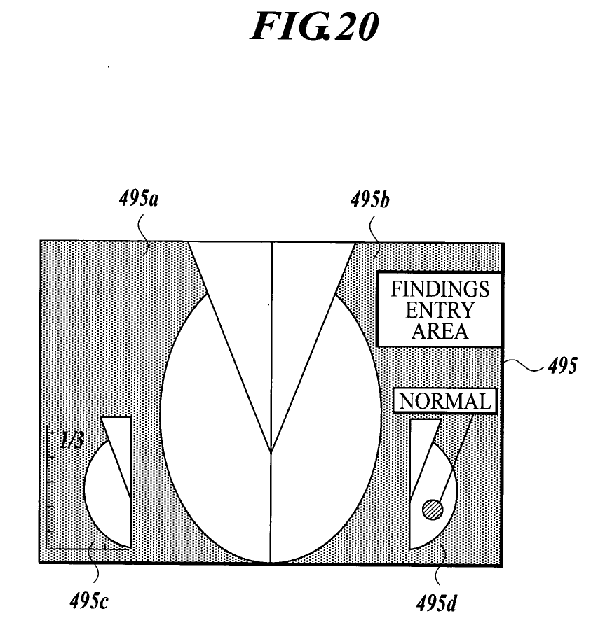

FIG. 20 shows an example of an output image 495 output by the image processing device 4. As shown in FIG. 20, in the output image 495, an image 495a of MLO-R and an image 495b of MLO-L are outputted in two-side output as main images. In the image 495a of MLO-R, a reduced abnormality displayed image 495c of MLO-R is displayed as a sub image with scale calibration and a reduction ratio added. The reduced abnormality displayed image 495c indicates that no detected abnormal shadow candidate exists. Moreover, in the image 495b of MLO-L, a reduced abnormality displayed image of MLO-L, to which a comment and an inputted marker indicating “NORMAL” are added, is displayed as a sub image.

As described above, in the image processing device 4, the abnormal shadow candidate detecting section 45 detects abnormal shadow candidate area in the image data D inputted from the image generating devices 3a to 3e through the communication section 43, and the main image processing section 46 performs the image processing on the image data D. Furthermore, the reduced medical image generating section 47 reduces the medical image data on which the image processing has been performed, at a predetermined magnifying rate to generate a reduced medical image. Moreover, the reduced abnormality displayed image generating section 48 overlaps the annotation of the detection result of the abnormal shadow candidate on the reduced medical image to generate a reduced abnormality displayed image. Then, the synthesized image generating section 49 locates the reduced medical image or the reduced abnormality displayed image on the medical image on the basis of a synthesizing form inputted from the operation display section 42 so as to maintain the information of the subject area of the medical image data to generate a synthesized image. The synthesized image generating section 49 outputs the output image data selected by the operation display section 42 to the image recording device 5 through the communication section 43.

Consequently, the medical image processing system 100 outputs a hardcopy where images which can be reference for a diagnosis on a medical image are displayed, the images such as a reduced abnormality displayed image overlapping a detection result of an abnormal shadow candidate on the medical image with the information of the medical image maintained, a reduced medical image or a reduced abnormality displayed image of another medical image associated with the medical image obtained by radiographing the same part from other directions, and the like. Therefore, the medical image processing system 100 can perform the diagnosis of a medical image more efficiently, and thereby can improve the diagnosis performance and the working efficiency of a doctor.

Incidentally, the synthesized image data may be stored in the storage section 44 so as to be outputted in response to an input from the operation display section 42 without performing the synthesizing processing on images.

[Fourth Embodiment]

Next, a fourth embodiment of the present invention will be described.

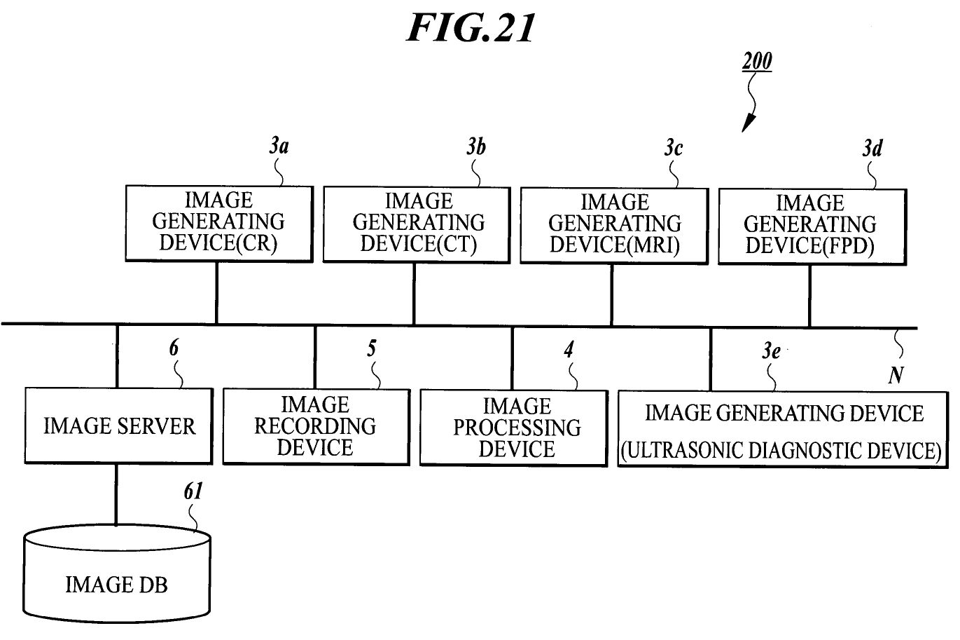

FIG. 21 is a conceptual diagram showing a whole structure of a medical image processing system 200 in the fourth embodiment of the present invention. As shown in FIG. 21, in the medical image processing system 200, the image generating devices 3a to 3e, the image processing device 4, the image recording device 5, an image server 6 and the like are connected to one another in the state capable of transmitting and receiving data through the network N.

The image server 6 comprises an image database (DB) 41 for storing the image data generated by the image generating devices 3a to 3e as related to its accompanying information. When the image processing device 4 outputs the information such as patient ID, image generating device information (modality type) and a radiographic part through the network N, and when the image server 6 receives a transmission request of the past image data generated by the same modality and/or the image data (other modality image data) generated by another type of image generating device (modality), the image server 6 retrieves the corresponding image data from an image DB 61, and outputs the retrieved image data along with its accompanying information to the image processing device 4. The accompanying information includes, for example, patient information in regard to a patient such as patient name, a patient ID, age and sex of a radiographed patient; and radiographing information such as a radiographing date, examination ID, a radiographic part, a radiographing condition (a body position, a radiographing direction and the like) and image generating device information (modality type).

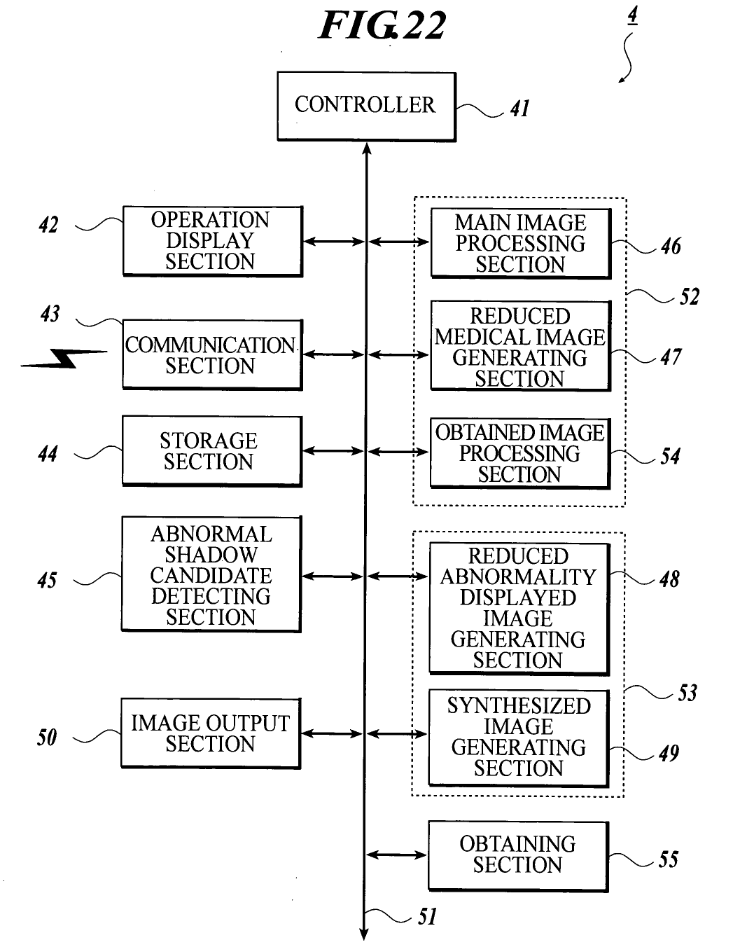

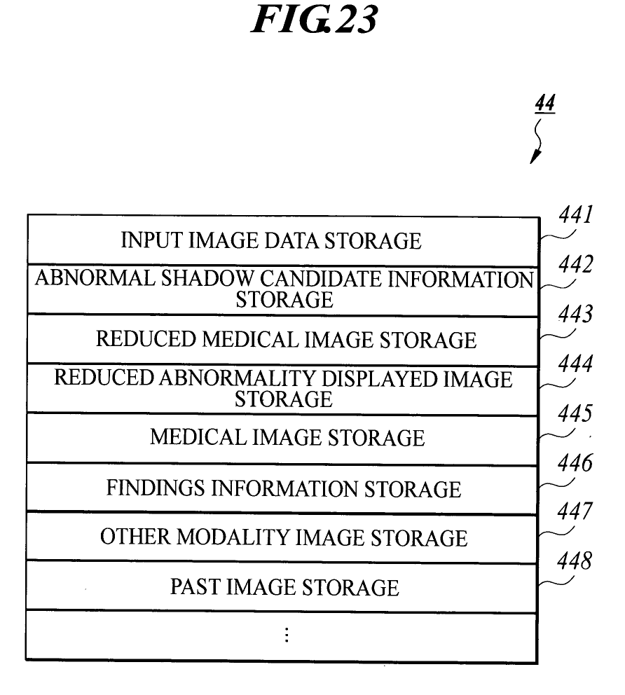

The image processing device 4 comprises, as shown in FIG. 22, an obtained image processing section 54 and an obtaining section 55 in addition to the structure shown in FIG. 14 in the third embodiment. Moreover, the storage section 44, as shown in FIG. 23, comprises an other modality image storage 447 and a past image storage 448 in addition to the structure in the third embodiment.

The other modality image storage 447 stores other modality image data obtained from the image server 6 through the communication section 43, reduced other modality processed image data, which is data generated by performing image processing on the other modality image data, and its accompanying information as related to image data D by means of a patient ID. The past image storage 448 stores the data of past medical images by the same modality (the past image by the same modality) obtained from the image server 6 through the communication section 43, and its accompanying information as related to image data D by means of a patient ID.

The main image processing section 46, the reduced medical image generating section 47 and the obtained image processing section 54 constitute an image processing section 52. In the image processing section 52, the main image processing section 46 performs image processing on image data D to generate medical image data for diagnosis as a main image. Moreover, the reduced medical image generating section 47 performs image processing including the reduction processing thereof and the like on the image data D to generate reduced medical image data as a sub image. The obtaining section 55 obtains other modality image data of the same part of the same patient, which is generated by another type of an image generating device (other modality) than the image generating device which has generated the image data D, or past medical image data generated by the same modality, from the image server 6. The obtained image processing section 54 performs image processing including reduction processing and the like on these image data, and reduces the processed image data at a predetermined magnifying rate to generate reduced other modality processed image data or reduced past image data as a sub image.

The obtained image processing section 54 loads other modality image data from the other modality image storage 447 or past image data by the same modality from the past image storage 448 on the basis of an instruction from the controller 41, and reduces the loaded image data as the predetermined magnifying rate. The obtained image processing section 54 recognizes the subject area of the reduced image data by the above-mentioned subject recognition method, and performs the density correction on area other than the subject area so as to make the area have more than a predetermined density value, for example, a value having a higher density value than the minimum density value in the subject area. Moreover, the obtained image processing section 54 includes an other modality image processing means to perform image processing such as gradation processing, frequency processing and processing adding the information of modality type to the other modality image data on the reduced other modality image data. Then, the obtained image processing section 54 stores the processed other modality image data (reduced other modality processed image data) in the other modality image storage 447 as related to the other modality image data before the processing. Moreover, the obtained image processing section 54 stores the reduced past image data by the same modality in the past image storage 448 as related to the past image data by the same modality before the reduction.

The obtaining section 55 obtains other modality image data of the same part of the same patient generated by another type of an image generating device (other modality) than the image generating device which has generated the image data D, or past medical image data generated by the same modality, from the image server 6 through the communication section 43 on the basis of an instruction from the controller 41.

The obtained image processing section 54 and the obtaining section 55 may be realized by software processing in cooperation with the CPU of the controller 41 and programs stored in the ROM, or may be configured by means of dedicated hardware.

Moreover, the synthesized image generating section 49 comprises the following functions.

The synthesized image generating section 49 loads medical image data which has already received image processing from the medical image storage 445 on the basis of an instruction from the controller 41, and loads the reduced medical image data, the reduced abnormality displayed image data, the reduced past image data of the same modality, or the reduced other modality processed image data, each of which is to be synthesized with the medical image data, from the corresponding storage of the storage section 44. Then, the synthesized image generating section 49 synthesizes the medical image with the reduced medical image, the reduced abnormality displayed image, the reduced past image data of the same modality, or the reduced other modality processed image data into one image. In this case, the synthesized image generating section 49 recognizes the subject area in the medical image by means of the above-mentioned subject area recognizing method, and performs the size alteration on the reduced medical image, the reduced abnormality displayed image, the reduced past image data of the same modality, or the reduced other modality processed image data, each of which is to be synthesized, according to the ratio between the subject area and area other than the subject area in the medical image to locate the reduced medical image, the reduced abnormality displayed image, the reduced past image data of the same modality, or the reduced other modality processed image data with the information of the subject area in the medical image maintained. At this time, when a plurality of images which are to be synthesized with the medical image exist, the size alteration is performed so that the reduction rate of each of the plurality of images becomes the same. Otherwise, the size may be adjusted so that the size of each image to be synthesized with the medical image is not dispersed to have the same size severally on the basis of the setting by the operation display section 42. Then, the synthesized image generating section 49 adds the information indicating scale calibration and a reduction ratio to the located reduced medical image or the reduced abnormality displayed image, and adds scale calibration to the reduced past image by the same modality and the reduced other modality processed image to generate a synthesized image.

Incidentally, in the present embodiment, the synthesized image generating section 49 has a function of a size information adding means to perform the addition of the scale calibration or the addition of the reduction ratio and the like. However, the addition of the size information may be performed by the reduced medical image generating section 47, the reduced abnormality displayed image generating section 48 or the like. Moreover, the information indicating the reduction ratio and the scale calibration can be in advance set to be added or not to be added by an input from the operation display section 42 severally.

Hereupon, when the medical image to be synthesized is mammography, on the basis of an instruction from the controller 41, the synthesized image generating section 49 performs the synthesis processing to synthesize two sheets of mammography as main images among four sheets of mammography generated by radiographing both the left and right breasts severally from two directions (right breast oblique direction; MLO-R, left breast oblique direction; MLO-L, right breast vertical direction; CC-R, left breast vertical direction; CC-L) at one examination to the same patient (namely, having the same examination ID) so as to output in two-side output on one sheet of recording medium as one image. After that, the synthesized image generating section 49 performs the synthesis on sub images with the synthesized respective medical images on the basis of an instruction from the control section 41. Each of the sub image is the reduced medical image data, the reduced abnormality displayed image data, the reduced past image data of the same modality, or the reduced other modality processed image data. As the synthesizing forms of mammography, the synthesis is performed, for example, in the following synthesizing forms (1) to (16) on the basis of an instruction from the controller 41.

(1) medical images (MLO-R, L) and reduced medical images (CC-R, L)

(2) medical images (CC-R, L) and reduced medical images (MLO-R, L)

(3) medical images (MLO-R, CC-R) and reduced medical images (MLO-L, CC-L)

(4) medical images (MLO-L, CC-L) and reduced medical images (MLO-R, CC-R)

(5) medical images (MLO-R, L) and reduced abnormality displayed images (CC-R, L)

(6) medical images (CC-R, L) and reduced abnormality displayed images (MLO-R, L)

(7) medical images (MLO-R, CC-R) and reduced abnormality displayed images (MLO-L, CC-L)

(8) medical images (MLO-L, CC-L) and reduced abnormality displayed images (MLO-R, CC-R)

(9) medical images (MLO-R, L) and reduced other modality processed images (CC-R, L)

(10) medical images (CC-R, L) and reduced other modality processed images (MLO-R, L)

(11) medical images (MLO-R, CC-R) and reduced other modality processed images (MLO-L, CC-L)

(12) medical images (MLO-L, CC-L) and reduced other modality processed images (MLO-R, CC-R)

(13) medical images (MLO-R, L) and reduced past images of the same modality (CC-R, L)

(14) medical images (CC-R, L) and reduced past images of the same modality (MLO-R, L)

(15) medical images (MLO-R, CC-R) and reduced past images of the same modality (MLO-L, CC-L)

(16) medical images (MLO-L, CC-L) and reduced past images of the same modality (MLO-R, CC-R)

That is, the synthesized image generating section 49 synthesizes the reduced medical image, the reduced abnormality displayed image data, the reduced other modality processed image data or the reduced past image data by the same modality of another related mammography (for example, the mammography radiographed from another direction, the mammography of the left breast on the mammography of the right breast, the mammography of the right breast on the mammography of the left breast, or the like) as references over each of the two side of mammography. Thereby, at the time of image diagnosis by a doctor, an image related to the mammography for diagnosis can be easily referred to efficiently.

Otherwise, when a medical image is mammography, on the basis of an instruction from the controller 41, the synthesized image generating section 49 locates a reduced medical image of a main image; a reduced abnormality displayed image; a reduced processed image by other modality or a reduced past image by the same modality, both of which are radiographed from the same direction; or a reduced medical image, a reduced abnormality displayed image, a reduced processed image by another modality or a reduced past image by the same modality, the preceding four images being radiographed from another direction, as sub images over mammography for diagnosis as the main image, and synthesizes the images. Thereby, since reduced medical images, reduced abnormality displayed images, reduced processed images of another modality or reduced past images by the same modality, all being radiographed from two directions, are synthesized on one medical image, reference can be easily done, and it is possible to perform the image diagnosis effectively. To put it concretely, the synthesized image generating section 49 performs synthesis, for example, in any one of the following forms (17) to (28) on the basis of an instruction from the controller 41.

(17) medical image (MLO-R) and reduced medical images (MLO-R, CC-R)

(18) medical image (MLO-L) and reduced medical images (MLO-L, CC-L)

(19) medical image (CC-R) and reduced medical images (MLO-R, CC-R)

(20) medical image (CC-L) and reduced medical images (MLO-L, CC-L)

(21) medical image (MLO-R) and reduced abnormality displayed images (MLO-R, CC-R)

(22) medical image (MLO-L) and reduced abnormality displayed images (MLO-L, CC-L)

(23) medical image (CC-R) and reduced abnormality displayed images (MLO-R, CC-R)

(24) medical image (CC-L) and reduced abnormality displayed images (MLO-L, CC-L)

(25) medical image (MLO-R) and reduced processed images of another modality (MLO-R, CC-R)

(26) medical image (MLO-L) and reduced processed images of another modality (MLO-L, CC-L)

(27) medical image (CC-R) and reduced processed images of another modality (MLO-R, CC-R)

(28) medical image (CC-L) and reduced processed images of another modality (MLO-L, CC-L)

(29) medical image (MLO-R) and reduced past images of the same modality (MLO-R, CC-R)

(30) medical image (MLO-L) and reduced past images of the same modality (MLO-L, CC-L)

(31) medical image (CC-R) and reduced past images of the same modality (MLO-R, CC-R)

(32) medical image (CC-L) and reduced past images of the same modality (MLO-L, CC-L)

The synthesizing forms (17)-(32) may be performed by synthesizing in two-side output on one sheet of recording medium.

In addition, for example, outputs may be performed in the following output forms.

(33) medical images (MLO-R, CC-R), reduced medical images (CC-R, MLO-R)

(34) medical images (MLO-L, CC-L), reduced medical images (CC-L, MLO-L)

(35) medical images (MLO-R, CC-R), reduced abnormality displayed images (CC-R, MLO-R)

(36) medical images (MLO-L, CC-L), reduced abnormality displayed images (CC-L, MLO-L)

(37) medical images (MLO-R, L), reduced abnormality displayed images (MLO-R, L1

(38) medical images (CC-R, L), reduced abnormality displayed images (CC-R, L)

(39) medical images (MLO-R, CC-R), reduced abnormality displayed images (MLO-R, CC-R)

(40) medical images (MLO-L, CC-L), reduced abnormality displayed images (MLO-L, CC-L)

(33) medical images (MLO-R, L), reduced processed images of another modality (MLO-R, L)

(41) medical images (CC-R, L), reduced processed images of another modality (CC-R, L)

(42) medical images (MLO-R, CC-R), reduced processed images of another modality (MLO-R, CC-R)

(43) medical images (MLO-L, CC-L), reduced processed images of another modality (MLO-L, CC-L)

(44) medical images (MLO-R, L), reduced past images of the same modality (MLO-R, L)

(45) medical images (CC-R, L), reduced past images of the same modality (CC-R, L)

(46) medical images (MLO-R, CC-R), reduced past images of the same modality (MLO-R, CC-R)

(47) medical images (MLO-L, CC-L), reduced past images of the same modality (MLO-L, CC-L)

Hereupon, when mammography images of both of the left and the right breasts radiographed from the same radiographing direction are outputted in two-side output on the left side and the right side on one sheet of recording medium as main images (for example, CC-R and CC-L), synthesis is performed so that the relative location relation between the mammography for diagnosis as the main images and a reduced medical image, a reduced abnormality displayed image, a reduced processed image by another modality or a reduced past image by the same modality on each mammography as a sub image is symmetrical on the left side and the right side (see FIG. 18A). Moreover, when the mammography images of a left breast or a right breast radiographed from different radiographing directions severally are outputted in two-side output on one sheet of recording medium (for example, CC-R and MLO-R), synthesis is performed so that the relative location relation between the mammography for diagnosis and a reduced medical image, a reduced abnormality displayed image, a reduced processed image of another modality or a reduced past image of the same modality on each mammography has the same relation on the left side and the right side (see FIG. 18B).

Next, operation in the fourth embodiment will be described.

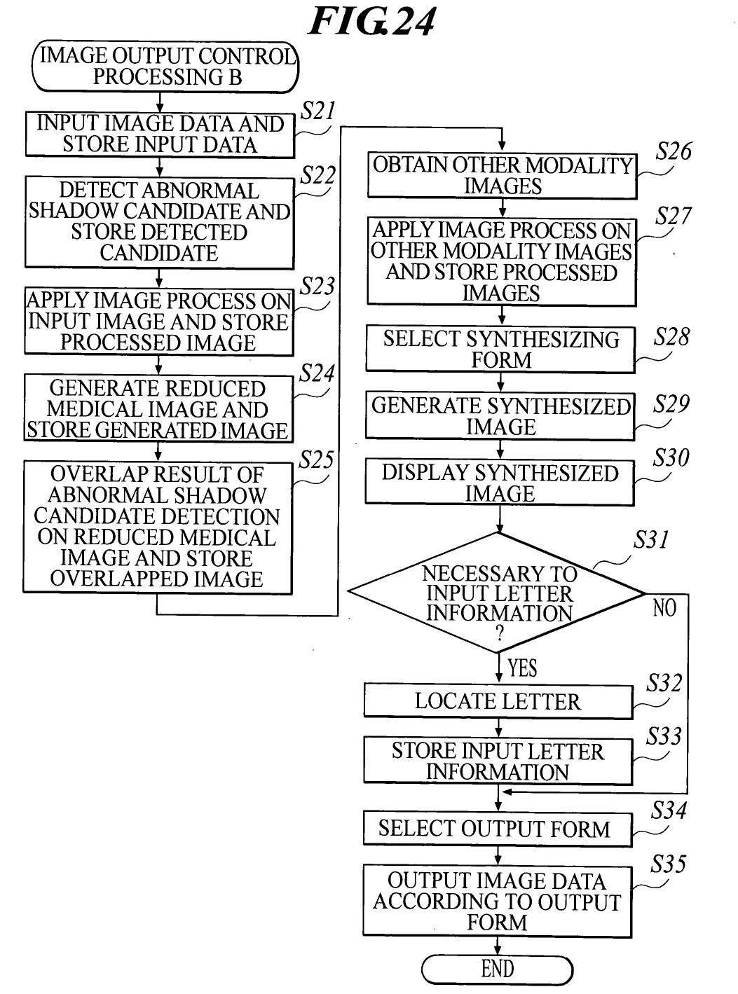

FIG. 24 shows image output control processing B to be executed by the controller 41. In the following, with reference to FIG. 24, the image output control processing B will be described.

When image data D and its accompanying information are inputted from any one of the image generating devices 3a to 3e through the communication section 43, the input image data D and its accompanying information are stored in the input image data storage 441 (Step S21). Successively, the abnormal shadow candidate detecting section 45 loads the image data D and its accompanying information, and the detection of an abnormal shadow candidate is performed on the image data D. Then, a detection result is stored in the abnormal shadow candidate information storage 442 (Step S22). Moreover, the main image processing section 46 loads the image data D and its accompanying information, and image processing such as gradation processing, frequency processing, dynamic range compression processing, and the density correction processing on area other than the subject area or the like is performed on the image data D. Then the processed image data D and its accompanying information are stored in the medical image storage 445 (Step S23).

Next, the reduced medical image generating section 47 loads the image data D from the input image data storage 441. Then, reduction processing at a predetermined magnifying rate, density correction processing for correcting density of the area other than the subject area to have more than a predetermined density, and the like are performed on the loaded image data D, and thereby reduced medical image data is generated to be stored in the reduced medical image storage 443 (Step S24). In addition, the reduced abnormality displayed image generating section 48 loads the location information and the annotation information in an abnormal shadow candidate area among the abnormal shadow candidate information to the image data D stored in the abnormal shadow candidate information storage 442. Then, the annotation information is overlapped on the location of the abnormal shadow candidate area of the reduced medical image data, and thereby the reduced abnormality displayed image data is generated to be stored in the reduced abnormality displayed image storage 444 (Step S25).

Incidentally, when the image data D is mammography and four sheets of the image data D of the both sides of breast radiographed from two radiographing directions severally exist per the same examination ID, the processing in Steps S21 to S25 is executed on each of the image data D.

Next, the obtaining section 55 obtains an image of the same radiographic part of the same patient ID by other modality and its accompanying information from the image DB 61 of the image server 6 through the communication section 43 to be stored in the other modality image storage 447 (Step S26). The obtained image processing section 54 performs the image processing such as reduction processing for reducing the other modality image data at a predetermined magnifying rate, gradation processing, frequency processing and processing for adding the information of a modality type to the other modality image data and the like, on the other modality image data. The processed other modality image data (reduced other modality processed image data) is stored in the other modality image storage 447 as related to the other modality image data before the processing (Step S27).

Incidentally, Steps S26 and S27 can be performed in parallel to the processing in Steps S22 to S25.

Next, when the operation display section 42 displays an instruction of the selection input of a synthesizing form and a synthesizing form is selected according to an input (Step S28), the synthesized image generating section 49 loads the medical image data corresponding to the selected synthesizing form and the reduced medical image data, the reduced abnormality displayed image data or the reduced processed image data by the other modality, and the synthesized image generating section 49 synthesizes the loaded data in the synthesizing form selected in Step S28 (Step S29). Hereupon, the synthesized image generating section 49 recognizes the subject area in the medical image, and performs the size alteration on the reduced medical image, the reduced abnormality displayed image or the reduced processed image by the other modality to be synthesized according to a ratio between the subject area and area other than the subject area in the medical image. Thereby, the reduced medical image, the reduced abnormality displayed image or the reduced processed image by the other modality is located with the information of the subject area maintained. Scale calibration and a reduction ratio are added on the located reduced medical image or the reduced abnormality displayed image, and scale calibration are added to the reduced processed image by other modality. Then, a synthesized image is generated. As the synthesizing form, it is possible to select any one of the forms (1) to (12), (17) to (28) and (33) to (43), for example, in the case of mammography, with the operation display section 42.

When the synthesized image is generated, the synthesized image is displayed on the display screen of the operation display section 42 (Step S30). When an input instruction of findings information such as a doctor's diagnosis result of “normal/abnormal” on an abnormal shadow candidate and/or comments is performed on this screen and letter information is inputted (Step S31; YES), markers indicating inputted distinctions of “normal/abnormal” are added to each abnormal shadow candidate of the synthesized image, and inputted comments are added to vacant areas on the outside of the subject area of the medical image. Thereby, the inputted letters are located (Step S32). The inputted information is stored in the findings information storage 446 of the storage section 44 as related to the image data D by means of an examination ID (Step S33). Successively, when an output form (whether the data of the synthesized image is outputted to the image recording device 5, or the medical image data, and the reduced medical image data, the reduced abnormality displayed image data or reduced processed image data of the other modality are severally outputted to the image recording device 5) is selected on the display screen, and when an output is instructed (Step S34), the image output section 50 outputs the image data corresponding to the selected output form to the image recording device 5 through the communication section 43 (Step S35).

Here, when an output of the data of the synthesized image is instructed in Step S34, the image recording device 5 can easily output an image in which various kinds of information are located for diagnosis. However, since the synthesized image data has large information amount, there is a problem of amount of communication data being large. Accordingly, when the synthesized image data is not required to be outputted in the case where each image is observed separately or the like, the medical image data, and the reduced medical image data, the reduced abnormality displayed image data or the reduced processed image data by other modality are separately transmitted. Thereby, the quantity of communication data on the network N can be suppressed.

Incidentally, the synthesized image data may be stored in the storage section 44 to be outputted in response to an input from the operation display section 42 without performing the synthesizing processing on images.

Moreover, in the above-mentioned image output control processing B, the case where other modality image data is obtained from the DB 41 of the image server 6 is described as an example. However, past image data by the same modality may be obtained along with other modality image data to be reduced, and may be synthesized with a medical image. Otherwise, the past image data by the same modality may be outputted to the image recording device 5. Moreover, only the past image data by the same modality may be obtained from the image DB 61 of the image server 6 to be synthesized with the medical image, or may be outputted to the image recording device 5.

As described above, in the image processing device 4, the abnormal shadow candidate detecting section 45 detects abnormal shadow candidate area in the image data D inputted from the image generating devices 3a to 3e through the communication section 43, and the main image processing section 46 performs the image processing on the image data D. Furthermore, the reduced medical image generating section 47 reduces the image-processed medical image data at a predetermined magnifying rate to generate a reduced medical image. Moreover, the reduced abnormality displayed image generating section 48 overlaps the annotation of the detection result of the abnormal shadow candidate on the reduced medical image to generate a reduced abnormality displayed image. Moreover, other modality image data generated by radiographing the same part of the same patient is obtained through the communication section 43. The image processing including the reduction processing and the like on the obtained other modality image data is performed by the obtained image processing section 54. Then, the reduced processed image by the other modality is generated. Then, the synthesized image generating section 49 locates the reduced medical image, the reduced abnormality displayed image or the reduced processed image by the other modality on the medical image on the basis of a synthesizing form inputted from the operation display section 42 with the information of the subject area of the medical image data maintained in order to generate a synthesized image. The synthesized image generating section 49 outputs the output image data selected by the operation display section 42 to the image recording device 5 through the communication section 43.

Consequently, the medical image processing system 200 outputs a hardcopy where image is displayed to be a reference for a diagnosis on a medical image such as a reduced abnormality displayed image on which a detection result of an abnormal shadow candidate is overlapped with the information of the medical image maintained, and a reduced medical image of a medical image which is related to the medical image and is generated by radiographing the same part from another direction, a reduced abnormality displayed image, a reduced processed image by other modality generated by photographing the same part of the same patient in other modality, or the like. Consequently, the medical image processing system 100 is capable of performing the diagnosis on a medical image more efficiently, and thereby it is possible to improve the diagnosis performance and the working efficiency of a doctor.

Incidentally, in the fourth embodiment described above, the image server 6 comprises the image DB 61 for storing the image data generated by an image generating device (modality) on the network N, and the image processing device 4 obtains the image data of the same radiographic part of the same patient which has been radiographed by a modality other than the modality which has generated the image data, namely other modality image data, from the image DB 61. However, each image generating device may store the image data generated by respective image generating devices, and the image processing device 4 may obtain other modality image data from each image generating device.

Moreover, the images to be synthesized with a medical image may either any one of, or any combination of a plurality kinds of a reduced medical image, a reduced abnormality displayed image, a reduced processed image of another modality, and a reduced past image of the same modality.

[Fifth Embodiment]

Next, a fifth embodiment will be described.

A whole structure of the fifth embodiment is the same as that of the medical image processing system 100 shown in FIG. 13 in the third embodiment. Accordingly, the descriptions of the structure are omitted. Moreover, the structure of the image processing device 4 is approximately the same as the structure shown in FIG. 14 in the third embodiment. Accordingly, only the different respects will be described in the following.

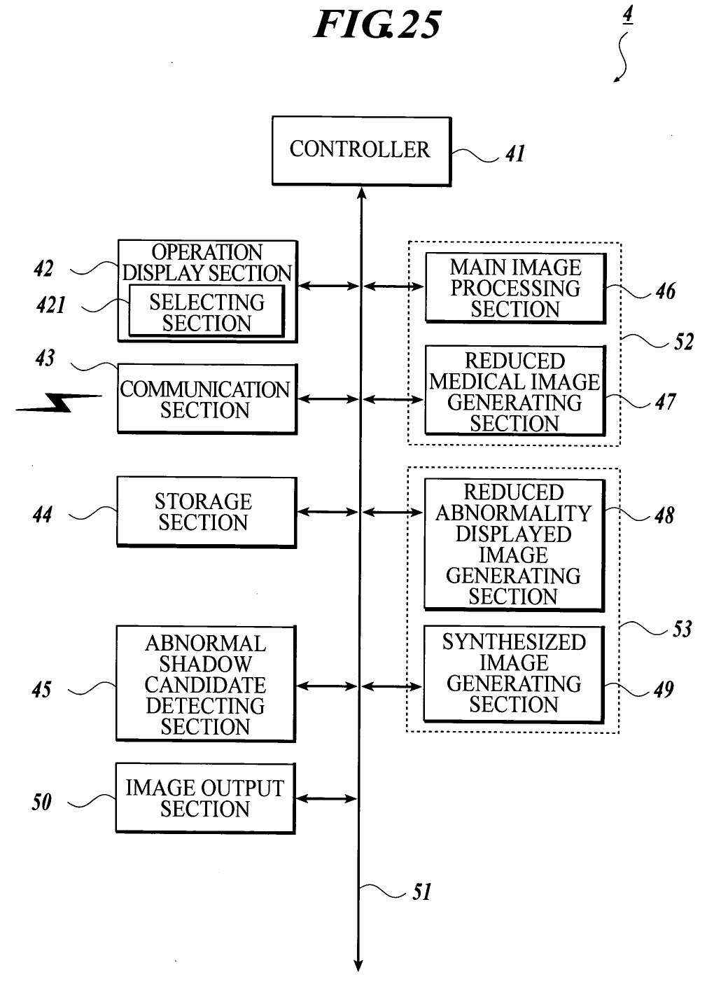

As shown in FIG. 25, the operation display section 42 of the image processing device 4 comprises a selecting section 421.

The selecting section 421 is an user interface, when the medical image (image data D) inputted from the image generating devices 3a to 3e is mammography and when a series of four pieces of image data D (designated by reference letters D1-D4) of the left and the right breasts radiographed from two radiographing directions severally (MLO-R, L, CC-R, L) exist per the same examination ID, to select a piece of the image data D regarded as a main image and a piece of the image data D regarded as a sub image among the four pieces of the image data D1 to D4, and assign a format of the sub image (whether the sub image is formed as a reduced medical image, or the sub image is formed as a reduced abnormality displayed image to be generated by overlapping an annotation as an abnormal shadow candidate detection result on a reduced medical image).

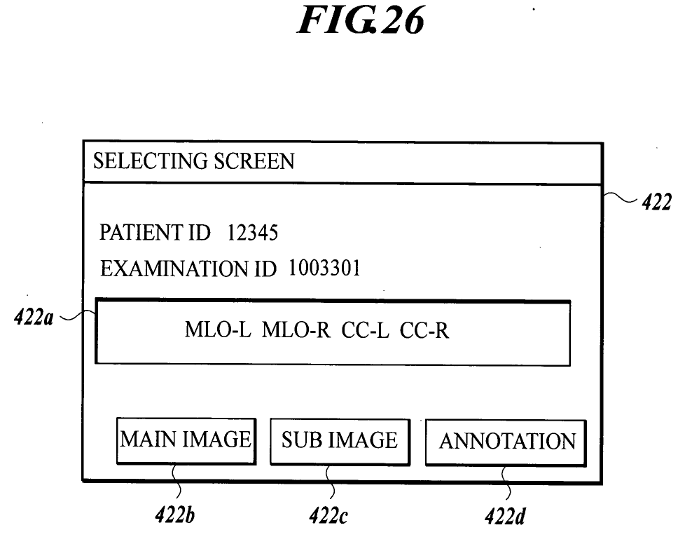

For example, the selecting section 421 displays a selecting screen 422 (see FIG. 26) for selecting a main image, a sub image and its format on the display screen of the operation display section 42. When a radiographing condition of the image data D to be set as the main image is selected among “MLO-R, MLO-L, CC-R, CC-L” in a radiographing condition selecting area 422a by means of a touch panel, a mouse or the like and a “MAIN IMAGE” button 422b is pushed, the result of the selection is outputted to the controller 41, and the image data D of the selected radiographing condition is set as a main image. Similarly, when a radiographing condition of a piece of the image data D to be set as a sub image is selected among “MLO-R, MLO-L, CC-R, CC-L” in the radiographing condition selecting area 422a and a “SUB IMAGE” button 422b is pushed, the result of the selection is outputted to the controller 41, and the image data D of the selected radiographing condition is set as a sub image. When two main images are outputted in two-side as one image, the radiographing conditions of the two main images can be selected, and one or more sub images per each main image can be selected. Moreover, when an “ANNOTATION” button 422d is pushed in the state where the radiographing condition of a sub image is selected in the radiographing condition selecting area 422a, necessity of overlapping the result of abnormal shadow candidate detection on the sub image is assigned.

The other structure of the image processing device 4 is the same as that described in FIG. 14. Accordingly, its description is omitted.

Next, operation of the fifth embodiment will be described.

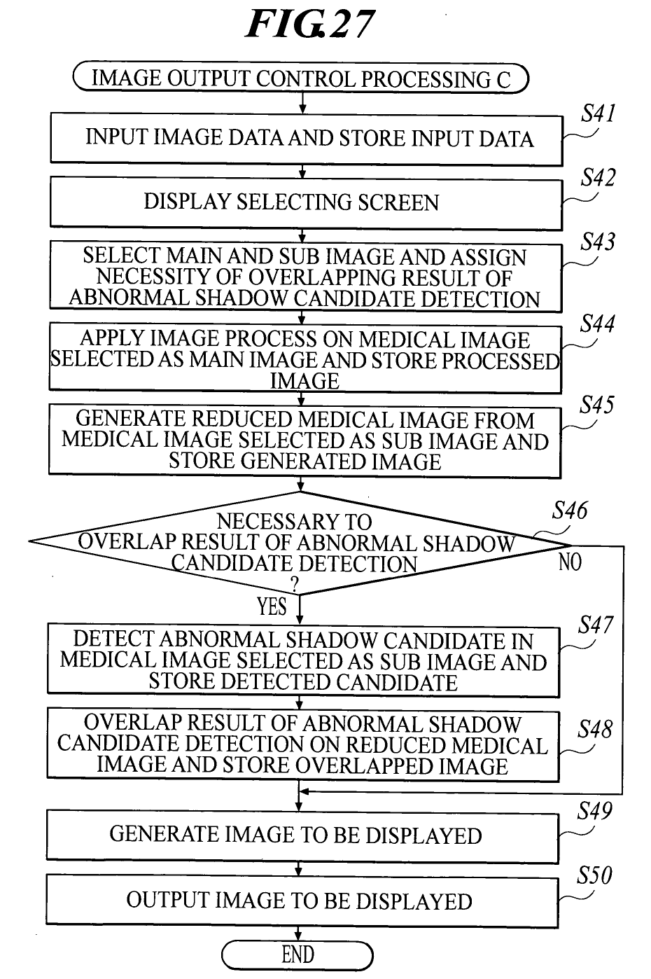

FIG. 27 shows image output control processing C to be executed by the controller 41. In the following, with reference to FIG. 27, the image output control processing C will be described.

When a series of image data D (D1 to D4) having the same examination ID and their accompanying information are inputted from any one of the image generating devices 3a to 3e through the communication section 43, the input image data D1 to D4 and their accompanying information are stored in the input image data storage 441 (Step S41). Moreover, the selecting screen 422 for selecting a main image and a sub image and for assigning necessity of overlapping result of abnormal shadow candidate detection is displayed on the display screen (Step S42), and the image data D to be set as a main image and a sub image is selected. Furthermore, necessity of overlapping result of the abnormal shadow candidate detection is assigned (Step S43).

Successively, the main image processing section 46 loads the image data D selected as the main image and its accompanying information from the input image data storage 441, and image processing such as gradation processing, frequency processing, dynamic range compression processing, and the density correction processing on area other than the subject area is performed on the image data D. Then the processed main image data is stored in the medical image storage 445 (Step S44). Moreover, the reduced medical image generating section 47 loads the image data D selected as the sub image from the input image data storage 441. Reduction processing at a predetermined magnifying rate, density correction processing for correcting the density of the area other than the subject area so as to have more than a predetermined density and the like are performed on the loaded image data D, and thereby reduced medical image data is generated to be stored in the reduced medical image storage 443 (Step S45).

Next, it is judged whether necessity of overlapping the result of the abnormal shadow candidate detection is assigned or not (Step S46). If the necessity of overlapping the result of the abnormal shadow candidate detection is assigned (Step S46; YES), the abnormal shadow candidate detecting section 45 loads the image data D selected as the sub image and its accompanying information, and the abnormal shadow candidate is detected in the image data D. The detection result is stored in the abnormal shadow candidate information storage 442 (Step S47). The reduced abnormality displayed image generating section 48 loads the location information and the annotation information in an abnormal shadow candidate area among the abnormal shadow candidate information in the image data D stored in the abnormal shadow candidate information storage 442. Then, the annotation information is overlapped on the location of the abnormal shadow candidate area of the reduced medical image data, and thereby the reduced abnormality displayed image data is generated to be stored in the reduced abnormality displayed image storage 444 (Step S48). Then, the processing proceeds to Step S49.

On the other hand, if the necessity of overlapping the result of the abnormal shadow candidate detection is not assigned (Step S46; NO), the processing proceeds to Step S49.

In Step S49, the synthesized image generating section 49 loads the main image data generated in Step S44, and the reduced medical image data generated in Step S45 on the basis of the selection result and the assignment result in Step S43 or the reduced abnormality displayed image data generated in Step S48, and the synthesized image generating section 49 synthesizes the loaded data in order to generate the displaying image data (Step S49). Hereupon, the synthesized image generating section 49 recognizes the subject area in the main image data, and performs the size alteration on the reduced medical image or the reduced abnormality displayed image to be synthesized according to a ratio of the subject area to the area other than the subject area in the main image data. Thereby, the reduced medical image or the reduced abnormality displayed image is located with the information of the subject area maintained. Scale calibration and/or the reduction ratio are added on the located reduced medical image or the reduced abnormality displayed image, and then the image to be displayed is generated.

Data of the image to be displayed is outputted to image recording device 5 through the communication section 43 by the image output section 50 (Step S50).

As described above, according to the medical image processing system 100, when a series of medical image having the same examination ID and their accompanying information are inputted from any one of the image generating devices 3a to 3e through the communication section 43, the selecting section 421 displays the selecting screen 422 for selecting a main image and a sub image and for assigning the necessity of overlapping the result of the abnormal shadow candidate detection on the display screen. When the selection of the image data D to be a main image and a sub image and the assignment of the necessity of overlapping the result of the abnormal shadow candidate detection is performed, the image data of the main image and the sub image is generated and synthesized in accordance with the selection result. Thereby, one sheet of the data of the image to be displayed, and a hardcopy is outputted from the image recording device 5.

Consequently, when a plurality of image data generated by radiographing the same radiographic part in the same examination exist, the image data of the main image to be used for diagnosis, and the image data and the format of the sub image to be located over the main image for a reference of diagnosis can be selected. Therefore, it is possible to generate an image to be displayed according to a purpose of diagnosis, or the like, and to improve the doctor's diagnosis performance and working efficiency furthermore.

Incidentally, in the above-mentioned embodiment, the case where the series of the images having the same examination ID is four images is described as an example. However, as long as the number of the images is plural, the present invention can be applied thereto. Consequently, the number is not limited in particular.

Moreover, data of the image to be displayed is stored in the storage section 44, and it may be outputted without performing the synthesis processing thereon in response to an input from the operation display section 42.

[Sixth Embodiment]

Next, a sixth embodiment will be described.

A whole structure in the sixth embodiment is approximately the same as the structure of the medical image processing system 200 shown in FIG. 21 in the fourth embodiment, and consequently only different respects will be described and the other respects are not described.

The image server 6 comprises the image DB 61 for storing the image data generated by image generating devices 3a to 3e as related to its accompanying information. When the image processing device 4 outputs extraction conditions such as patient ID, radiographic part and the like through the network N, the image server 6 searches in the image DB 61 on the basis of the accompanying information to extract the image data corresponding to the extraction conditions to output the list of the image data to the image processing device 4. Moreover, when the image processing device 4 outputs examination ID and the like and the image server 6 receives a transmission request of image data, the image server 6 extracts the corresponding image data from the image DB 61, and outputs the extracted image data along with its accompanying information to the image processing device 4. The accompanying information includes, for example, patient information in regard to a patient such as patient name of radiographed patient, patient ID, age, sex; and radiographing information such as a radiographing date, examination ID, a radiographic part, radiographing conditions (a body position, a radiographing direction and the like), image generating device information (modality type) and the like.

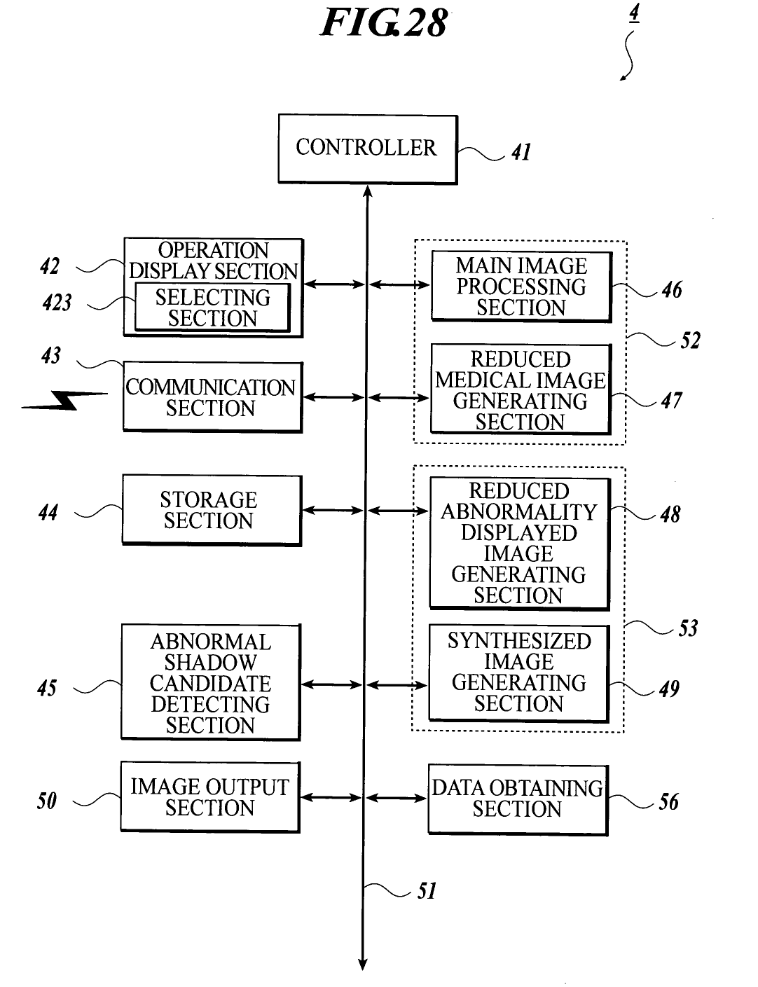

Moreover, the structure of the image processing device 4 is, as shown in FIG. 28, a structure comprising a data obtaining section 56 newly, wherein the operation display section 42 comprises a selecting section 423 in addition to the structure shown in FIG. 14 of the third embodiment.

The selecting section 423 is a user interface for selecting the image data to be set as a main image and the image data set as a sub image among the image data of medical images stored in the image DB 61 and/or the input image data storage 441.

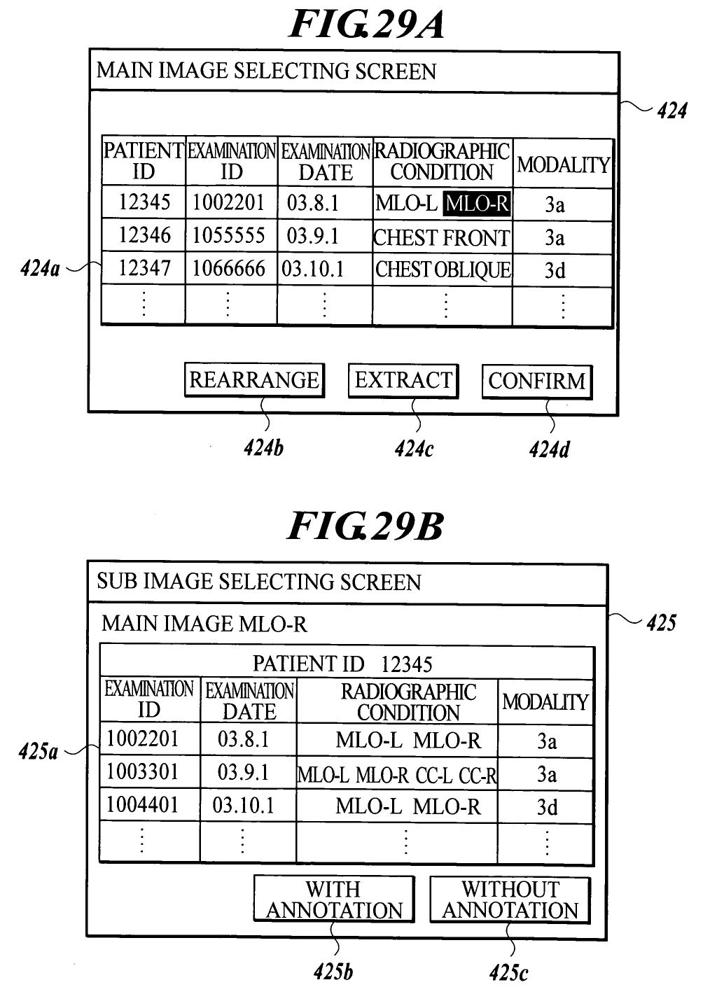

For example, the selecting section 423 displays a list of the medical images stored in the image DB 61 and/or the input image data storage 441 on the display screen of the operation display section 42 as a main image selecting screen 424. When a medical image is selected for a main image in the image list of the main image selecting screen 424 with a touch panel, a mouse or the like, the selecting section 423 outputs the selection result to the controller 41. FIG. 29A shows an example of the main image selecting screen 424. The main image selecting screen 424, as shown in FIG. 29A, for example, includes a medical image selecting area 424a for selecting the medical images displayed in a list, a “REARRANGE” button 424b, an “EXTRACT” button 424c, a “CONFIRM” button 424d and the like. When the “REARRANGE” button 424b or the “EXTRACT” button 424c are pushed, the rearrangement or the refinement of the list can be performed by the use of each item such as a patient ID, a radiographic part and the like.

When a medical image is selected for a main image in the medical image selecting area 424a and the “CONFIRM” button 424d is pushed, the selecting section 423 extracts a medical image related to the selected medical image for a main image, such as an image radiographed with the same examination ID as the medical image for the main image, a past medical image generated by radiographing the same radiographic part of the same patient by the same modality under a different radiographing condition, and an other modality image generated by radiographing the same radiographic part of the same patient by other modality, or the like. Then, the selecting section 423 displays the extracted medical images as a list on a sub image selecting screen 425 as sub image candidates. FIG. 29B shows an example of the sub image selecting screen 425. The sub image selecting screen 425 is displayed per each selected main image. When an image is selected in a sub image candidate area 425a with a touch panel, a mouse or the like, and when the necessity of overlapping the result of abnormal shadow candidate detection is assigned by means of a “WITH ANNOTATION” button 425b or a “WITHOUT ANNOTATION” button 425c, the selecting section 423 outputs the result to the controller 41.

In the main image selecting screen 424, it is possible to select a plurality of images radiographed in one examination as main image. For example, when the medical image is mammography, the images of the left and the right breast (for example, MLO-R, L) radiographed in one examination can be outputted as main images in two-side output by operating the images in the main image selecting screen 424 with a touch panel, a mouse or the like. Moreover, in the sub image selecting screen 425, per one main image, a plurality of sub images can be selected by operating with touch panel, a mouse or the like.

According to an instruction from the controller 41, the data obtaining section 56 requires delivery of the image data and the list of the medical images stored in the image DB 61 of the image server 6 through the communication section 43, and the data obtaining section 56 obtains image data and list.

Since the other structure of the image processing device 4 is approximately the same as that described in FIG. 14, only the different respects will be described in the following.

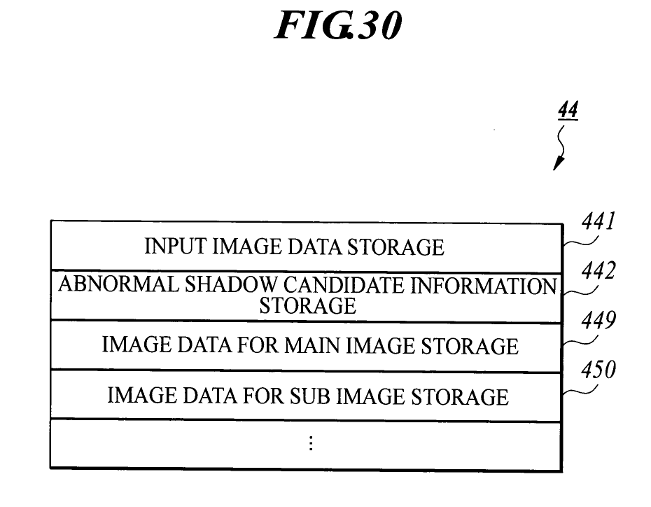

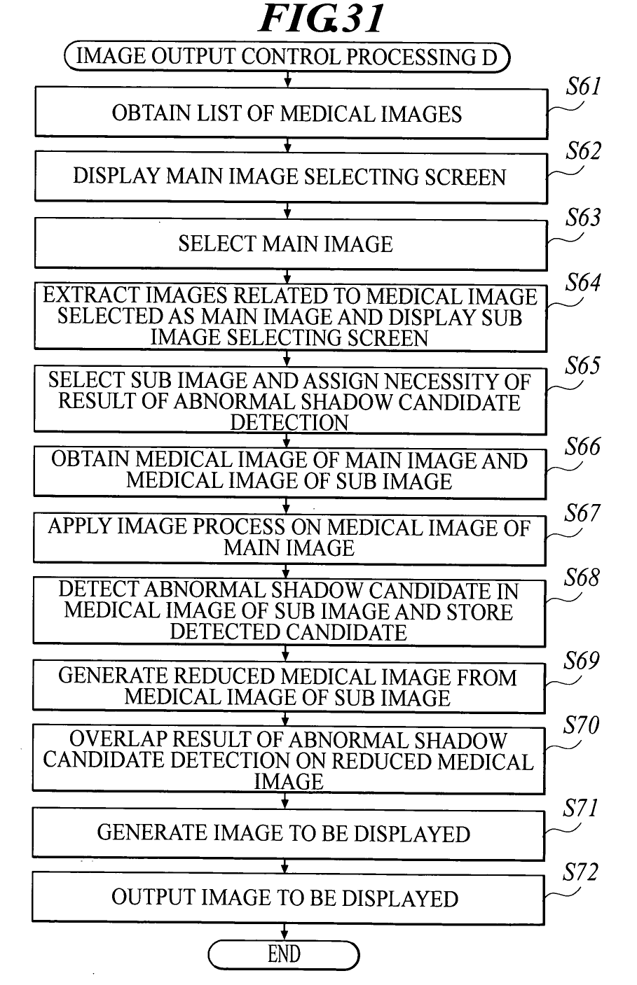

The storage section 44, as shown in FIG. 30, comprises the input image data storage 441, the abnormal shadow candidate information storage 442, an image data for main image storage 449 and an image data for sub image storage 450. The input image data storage 441 stores the image data of the medical image inputted from the image generating devices 3a to 3e as related to the accompanying information including the examination ID and the like. The abnormal shadow candidate information storage 442 stores the abnormal shadow candidate information inputted from the abnormal shadow candidate detecting section 45 as related to the information for identifying an image such as the examination ID or the like. The image data for main image storage 449 temporarily stores medical image data for a main image (hereinafter referred to as “image data for a main image”) selected by the selecting section 423 and its accompanying information. The image data for sub image storage 450 temporarily stores medical image data for a sub image (hereinafter referred to as “image data for a sub image”) selected by the selecting section 423 and its accompanying information. Incidentally, the medical image data to be stored in the image data for main image storage 449 and the image data for sub image storage 450 is medical image data obtained by the data obtaining section 56 or the image data loaded from the input image data storage 441.

The abnormal shadow candidate detecting section 45 has a similar structure to that described in the third embodiment, and performs the similar processing to that of the third embodiment by means of the similar structure. The abnormal shadow candidate detecting section 45 detects candidate area which appears to be abnormal shadow by performing the image analysis on the image data of the medical image for a sub image selected by the selecting section 423, and outputs the detection result to the abnormal shadow candidate information storage 442.

The main image processing section 46 has a similar structure to that described in the third embodiment, and performs the similar processing to that of the third embodiment by means of the similar structure. The main image processing section 46 loads the image data for a main image from the image data for main image storage 449 on the basis of an instruction from the controller 41, and performs various kinds of image processing on the loaded image data. The main image processing section 46 outputs the processed image data to the synthesized image generating section 49 as main image data.

The reduced medical image generating section 47 has a similar structure to that described in the third embodiment, and performs the similar processing to that of the third embodiment by means of the similar structure. The reduced medical image generating section 47 loads image data for a sub image from the image data for sub image storage 450 to generate a reduced medical image on the basis of an instruction from the controller 41. The reduced medical image generating section 47 outputs the generated reduced medical image to the reduced abnormality displayed image generating section 48 or the synthesized image generating section 49.

The reduced abnormality displayed image generating section 48 has a similar structure to that described in the third embodiment, and performs the similar processing to that of the third embodiment by means of the similar structure. The reduced abnormality displayed image generating section 48 loads abnormal shadow candidate information according to the same image data for a sub image as the reduced medical image data inputted from the reduced medical image generating section 47 from the abnormal shadow candidate information storage 442 on the basis of an instruction from the controller 41, and overlaps annotation information on the reduced medical image data to generate reduced abnormality displayed image data. The reduced abnormality displayed image generating section 48 outputs the generated reduced abnormality displayed image data to the synthesized image generating section 49.

The synthesized image generating section 49 has a similar structure to that described in the third embodiment, and performs the similar processing to that of the third embodiment by means of the similar structure. The synthesized image generating section 49 synthesizes input main image data, reduced medical image data and/or reduced abnormality displayed image data into one image on the basis of an instruction from the controller 41 to generate the data of an image to be displayed.

Next, operation of the sixth embodiment will be described.

FIG. 31 shows image output control processing D to be executed by the controller 41. In the following, with reference to FIG. 31, the image output control processing D will be described. The processing is started when an instruction indicating the generation of a hardcopy is inputted by the operation display section 42.

First, the data obtaining section 56 obtains a list of the medical images stored in the image DB 61, and a list of the medical images stored in the input image data storage 441 (Step S61). Next, the selecting section 423 displays the main image selecting screen 424, in which the list of the medical images is displayed (Step S62). When a medical image to be set as a main image is selected according to operation (Step S63), the images related to the selected medical image (for example, an image radiographed at the same examination ID as the medical image for the main image under a different radiographing condition, a past medical image generated by radiographing the same radiographic part of the same patient by the same modality, and other modality image generated by radiographing the same radiographic part of the same patient by other modality) are extracted from the list of the medical images as sub image candidates to be displayed in the sub image selecting screen 425 (Step S64).

When the selecting section 423 selects sub images corresponding to the main image in the sub image selecting screen 425 and assigns the necessity of overlapping the result of the abnormal shadow candidate detection (annotation) on each sub image (Step S65), the image data of the medical images of the selected main image and sub images, i.e. the image data for the main image and its accompanying information, and the image data for the sub images and its accompanying information, is obtained from the image server 6 by the data obtaining section 56, or is loaded from the input image data storage 441 to be stored in the image data for main image storage 449 and the image data for sub image storage 450, respectively (Step S66). Incidentally, the image data for each sub image is stored as related to the information indicating the necessity of overlapping the result of abnormal shadow candidate detection.

Next, the main image processing section 46 loads the image data for the main image, and the image processing such as the gradation processing, the frequency processing, the dynamic range compression processing, the density correction processing of the area on the outside of the subject area and the like is performed on the image data for the main image. The processed main image data is outputted to the synthesized image generating section 49 (Step S67). Moreover, the abnormal shadow candidate detecting section 45 loads the image data for sub images on which abnormal shadow candidate detection results are overlapped and its accompanying information, and the detection of abnormal shadow candidates is performed on the image data for the sub images. The detection result is stored in the abnormal shadow candidate information storage 442 (Step S68). Incidentally, if the information in regard to the image data for the sub images is stored in the abnormal shadow candidate information storage 442, the Step 68 may be omitted. Moreover, the reduced medical image generating section 47 loads the image data for the sub images, and performs the processing such as the reduction processing at a predetermined magnifying rate, and the density correction processing for correcting the density in the area other than the subject area so as to have more than a predetermined density on the loaded image data. Thereby, reduced medical image data is generated, and the generated medical image data is outputted to the reduced abnormality displayed image generating section 48 or the synthesized image generating section 49 according to the necessity of overlapping the result of abnormal shadow candidate detection (Step S69).

When the reduced medical image data is inputted to the reduced abnormality displayed image generating section 48, the reduced abnormality displayed image generating section 48 loads the location information and the annotation information of the abnormal shadow candidate area among the abnormal shadow candidate information which is stored in the abnormal shadow candidate information storage 442 and detection of which is performed on the same image data for the sub images as the reduced medical image data. The annotation information is overlapped on the location of the abnormal shadow candidate area of the reduced medical image data. Thereby, reduced abnormality displayed image data is generated to be outputted to the synthesized image generating section 49 (Step S70).

When the processed main image data, the reduced medical image data and/or the reduced abnormality displayed image data is all inputted to the synthesized image generating section 49, the subject area in the main image is recognized. The size alteration is performed on the reduced medical image and/or the reduced abnormality displayed image, which are to be synthesized according to the ratio of the subject area and the area other than the subject area in the main image. The reduced medical image or the reduced abnormality displayed image is located with the information of the subject area maintained. Scale calibration and/or a reduction ratio are added on the located reduced medical image and/or the reduced abnormality displayed image. Thus, a synthesized image, i.e. the data of an image to be displayed, is generated (Step S71). The generated synthesized image is outputted to the image recording device 5 by the image output section 50 (Step S72).

Incidentally, the data of the image to be displayed may be stored in the storage section 44, and may be outputted in response to an input from the operation display section 42 without performing the synthesis processing on an image.

As described above, according to the medical image processing system 200, the main image selecting screen 424, which displays medical images to be set as a main image in a list among the main images inputted from the image generating devices 3a to 3e through the communication section 43 to be stored in the input image data storage 441 and the medical images stored in the image server 6, is displayed, and a main image is selected in the main image selecting screen 424 by the selecting section 423. Then, the sub image selecting screen 425, which displays the medical images related to the selected medical image as sub image candidates in a list, is displayed. When a sub image and the necessity of overlapping the result of the abnormal shadow candidate detection are selected in the sub image selecting screen 425, one image to be displayed is generated on the basis of the image data for the main image and the image data for the sub image in accordance with the selection result. The one image to be displayed is outputted from the image recording device 5 as a hardcopy.

Consequently, since the image data for a main image to be used for a diagnosis, the image data for a sub image to be located on the main image for a reference of diagnosis, and its format can be selected, it is possible to improve a doctor's diagnosis performance and working efficiency furthermore.

In the above, the first to the sixth embodiments of the present invention have been described. However, the description contents of each embodiment described above are suitable examples of the medical image processing systems 100 and 200 according to the present invention, and the present invention is not limited to the contents.

Moreover, the image to be synthesized with a medical image may be any one or a combination of a plurality of kinds of a reduced medical image, a reduced abnormality displayed image, a reduced processed image by another modality, and a reduced past image by the same modality.

Moreover, when an image to be displayed is synthesized to be outputted, it is possible either to synthesize image data for a main image and image data for a sub image into the image to be displayed and then send the synthesized image to an output device, or to send image data for a main image and image data for a sub image, and synthesis information such as number of images and the like, and format information such as location, rotation, mirroring and the like respectively to an output device, and then synthesize each data in the output device according to each information.

In addition, the detailed structure and the detailed operation of each device constituting the medical image processing systems 100 and 200 can be suitably changed without departing form the essence of the present invention.

The entire disclosure of Japanese Patent Application Nos. Tokugan 2003-24028 filed on Jan. 31, 2003 and Tokugan 2003-360469 filed on Dec. 21, 2003 including specifications, claims, drawings and summaries are incorporated herein by reference in their entirety.

What is claimed is:

1. A medical image processing system comprising an image processing section for performing image processing including at least gradation processing on a medical image, a display formatting section for transforming the medical image processed in order to generate an image to be displayed, and an image output section for outputting the image to be displayed to an image recording device,
wherein the image processing section generates, based on at least one medical image obtained by radiographing a subject, a plurality of processed images composed of at least one main image and at least one sub image generated by reducing the whole of the at least one medical image, and
the display formatting section generates one image to be displayed by synthesizing the main image and the sub image.

2. The system of claim 1, further comprising a diagnosis aid information generating section for generating diagnosis aid information by analyzing the medical image,
wherein the display formatting section adds annotation corresponding to the diagnosis aid information generated by the diagnosis aid information generating section to the at least one sub image.

3. The system of claim 1, wherein the image processing section determines an image processing condition for the main image and an image processing condition for the sub image respectively by analyzing the medical image, and generates the plurality of processed images composed of the at least one main image and the at least one sub image by using the image processing conditions determined.

4. The system of claim 3, wherein the image processing condition includes a gradation processing condition, and
the image processing section determines the gradation processing condition so as to make an average gradient of the sub image smaller than an average gradient of the main image.

5. The system of claim 3, wherein the image processing condition includes a gradation processing condition, and
the image processing section determines the gradation processing condition so as to make an average gradient of the sub image have an opposite sign value to a value of an average gradient of the main image.

6. The system of claim 3, wherein the image processing condition includes a frequency processing condition, and
the image processing section determines the frequency processing condition so as to make low frequency components of the sub image have smaller amount than low frequency components of the main image.

7. The system of claim 1, further comprising an image recording device information storage section for storing image recording device information corresponding to the image recording device,
wherein the image processing section determines an image processing condition based on an analysis result of the medical image and the image recording device information.

8. The system of claim 1, wherein the image processing section comprises a schema image generating section for automatically generating a schema by analyzing the medical image, and for generating the at least one sub image including the schema.

9. The system of claim 1, further comprising a sub image display assigning information input section for externally inputting information in order to assign whether the sub image is to be displayed or not,
wherein the display formatting section generates the image to be displayed with the sub image displayed or an image to be displayed without the sub image displayed on the basis of the sub image display assigning information inputted externally.

10. The system of claim 2, wherein the diagnosis aid information generating section detects an abnormal shadow candidate in the medical image, and generates the diagnosis aid information including location information in regard to the abnormal shadow candidate detected in the medical image.

11. The system of claim 2, wherein the diagnosis aid information generating section performs image measurement on the medical image, and generates the diagnosis aid information including location information in regard to a result of the image measurement in the medical image.

12. The system of claim 1, wherein the image output section comprises:
a plurality of output channels corresponding to a plurality of image recording devices;
an output channel selecting section for selecting any one among the plurality of output channels to which an image is outputted; and
an image recording device information storage section for storing image recording device information of the image recording device set per each of the output channels,
the display formatting section generates the image to be displayed on the basis of the image recording device information which corresponds to the output channel selected by the output channel selecting section; and which is stored in the image recording device information storage section.

13. The system of claim 1, further comprising:
an image display section for displaying on a monitor, the image to be displayed generated by the display formatting section;
an image to be displayed modifying information input section for externally inputting modifying information for modifying the image to be displayed; and
a display image modifying section for modifying the image to be displayed on the basis of the image to be displayed modifying information inputted externally.

14. The system of claim 2, further comprising a diagnosis aid information storage section for storing the diagnosis aid information as related to image data of the medical image,
wherein the display formatting section loads the diagnosis aid information stored in the diagnosis aid information storage section, and generates the image to be displayed on the basis of the diagnosis aid information.

15. The system of claim 1, further comprising an image processing condition storage section for storing an image processing condition of image processing as related to image data of the medical image, the image processing performed on the medical image by the image processing section,
wherein the image processing section loads the image processing condition stored in the image processing condition storage section, and generates the plurality of processed images on the basis of the image processing condition.

16. The system of claim 1, further comprising a display format storage section for storing an image to be displayed generating condition applied on the medical image by the display formatting section, or image data of the image to be displayed generated by the display formatting section, as related to image data of the medical image,
wherein the display formatting section loads at least one of the image to be displayed generating condition stored in the display format storage section and data of the image to be displayed in order to generate the image to be displayed.

17. The system of claim 8, further comprising a schema image storage section for storing image data of the schema as related to image data of the medical image,
wherein the display formatting section loads the image data of the schema stored in the schema image storage section in order to generate the image to be displayed on the basis of the image data of the schema.

18. The system of claim 1, wherein the display formatting section comprises:
an image size adjusting section for performing size adjustment on each of the main image and the sub image; and
an image synthesizing section for synthesizing the main image size-adjusted and the sub image size-adjusted.

19. The system of claim 18, wherein the image size adjusting section performs the size adjustment so as to make an image size of the sub image smaller than an image size of the main image.

20. The system of claim 19, wherein the image synthesizing section synthesizes the sub image size-adjusted with the main image size-adjusted so as to fit the sub image into predetermined area in the main image.

21. The system of claim 20, wherein the image synthesizing section determines a location for fitting the sub image size-adjusted on the basis of image attribute information of the medical image.

22. The system of claim 20, wherein the display formatting section comprises a subject area recognizing section for recognizing subject area by analyzing the medical image, and
the image synthesizing section determines a location into which the sub image size-adjusted is to be fitted on the basis of information of the subject area recognized.

23. The system of claim 22, wherein the image size adjusting section adjusts the image size of the sub image on the basis of the information of the subject area recognized.

24. The system of claim 1, wherein the diagnosis aid information generating section generates a plurality of pieces of diagnosis aid information different from one another based on the same medical image, and
the image processing section generates the at least one sub image per each of the plurality of pieces of diagnosis aid information.

25. The system of claim 1, further comprising:
a modality for generating the medical image by radiographing the subject; and
an abnormal shadow candidate detecting section for analyzing the medical image generated in order to detect an abnormal shadow candidate,
wherein the image processing section comprises a reduced medical image generating section for reducing at a predetermined magnifying rate, the whole of the medical image, in order to generate a reduced medical image as the sub image, and
the display formatting section comprises:
a reduced abnormality displayed image generating section for overlapping a result of the detection of the abnormal shadow candidate on the reduced medical image generated in order to generate a reduced abnormality displayed image as the sub image; and
a synthesized image generating section for recognizing subject area of the main image generated, and for locating at least one of the reduced medical image and the reduced abnormality displayed image with information of the subject area recognized in the main image maintained in order to synthesize the main image with at least one of the reduced medical image and the reduced abnormality displayed image as the sub image into a synthesized image.

26. The system of claim 25, further comprising:
an obtaining section for obtaining at least one of an other modality image of the same radiographic part of the same subject, generated by a modality other than the modality that has generated the medical image, and a past medical image generated by the same modality; and
an obtained image storage section for storing at least one of the other modality image obtained and the past medical image obtained,
wherein the image processing section comprises an obtained image processing section for loading at least one of the other modality image and the past medical image from the obtained image storage section, and for reducing at the predetermined magnifying rate, the image loaded in order to generate the reduced medical image as the sub image, and
at least one of the reduced medical image and the reduced abnormality displayed image to be synthesized with the main image by the synthesized image generating section is any one of the images indicated by the following items (1) to (5),
(1) a reduced medical image of the same medical image as the main image;
(2) a reduced abnormality displayed image of the same medical image as the main image;
(3) a reduced medical image of another medical image related to the medical image of the main image;
(4) a reduced abnormality displayed image of another medical image related to the medical image of the main image; and
(5) a reduced medical image obtained from the obtained image processing section.

27. The system of claim 26, wherein the obtained image processing section performs at least one among gradation processing, frequency processing and processing for adding information indicating a modality type in an image, on the reduced other modality image.

28. The system of claim 25, wherein the reduced abnormality displayed image generating section overlaps at least annotation information as the result of the detection of the abnormal shadow candidate in order to generate the reduced abnormality displayed image on the reduced medical image generated by the reduced medical image generating section, the annotation information indicating a location of the abnormal shadow candidate.

29. The system of claim 25, wherein the reduced medical image generating section further recognizes the subject area by analyzing the reduced medical image, and performs density correction so as to make area other than the subject area recognized have more than predetermined density.

30. The system of claim 26, wherein the obtained image processing section further analyzes at least one of the other modality image reduced and the past medical image reduced in order to recognize each subject area, and performs density correction so as to make area other than the each subject area recognized have more than predetermined density.

31. The system of claim 25, further comprising a size information adding section for adding at least one of scale calibration and information indicating a reduction ratio on at least one of the reduced medical image and the reduced abnormality displayed image generated by the reduced medical image generating section.

32. The system of claim 26, further comprising a size information adding section for adding at least one of scale calibration and information indicating a reduction ratio on at least one of the reduced medical image and the reduced abnormality displayed image generated by the obtained image processing section.

33. The system of claim 25, further comprising:
a findings information input section for inputting findings information corresponding to the image to be displayed; and
a findings information adding section for adding the findings information inputted to the image to be displayed to be outputted by the image output section.

34. The system of claim 33, further comprising a findings information storage section for storing information inputted from the findings information input section as related to the medical image to be set as the main image.

35. The system of claim 25, wherein, when the main image is mammography, the synthesized image generating section locates at least one of the reduced medical image as the sub image and the reduced abnormality displayed image as the sub image in the main image in order to synthesize the images in any one of the following forms indicated by items (1) to (8):
(1) main images (MLO(oblique direction)-R(right breast), L(left breast)) and reduced medical images (CC(vertical direction)-R, L);
(2) main images (CC-R, L) and reduced medical images (MLO-R, L);
(3) main images (MLO-R, CC-R) and reduced medical images (MLO-L, CC-L);
(4) main images (MLO-L, CC-L) and reduced medical images (MLO-R, CC-R);
(5) main images (MLO-R, L) and reduced abnormality displayed images (CC-R, L);
(6) main images (CC-R, L) and reduced abnormality displayed images (MLO-R, L);
(7) main images (MLO-R, CC-R) and reduced abnormality displayed images (MLO-L, CC-L); and
(8) main images (MLO-L, CC-L) and reduced abnormality displayed images (MLO-R, CC-R).

36. The system of claim 25, wherein, when the main image is mammography, the synthesized image generating section locates at least one of the reduced medical image and the reduced abnormality displayed image in the main image in order to synthesize the images in any one of following forms (1) to (8):
(1) a main image (MLO-R) and reduced medical images (MLO-R, CC-R);
(2) a main image (MLO-L) and reduced medical images (MLO-L, CC-L);
(3) a main image (CC-R) and reduced medical images (MLO-R, CC-R);
(4) a main image (CC-L) and reduced medical images (MLO-L, CC-L);
(5) a main image (MLO-R) and reduced abnormality displayed images (MLO-R, CC-R);
(6) a main image (MLO-L) and reduced abnormality displayed images (MLO-L, CC-L);
(7) a main image (CC-R) and reduced abnormality displayed images (MLO-R, CC-R); and
(8) a main image (CC-L) and reduced abnormality displayed images (MLO-L, CC-L).

37. The system of claim 25, wherein the synthesized image generating section recognizes the subject area of the main image, and performs size adjustment on at least one of the reduced medical image and the reduced abnormality displayed image to be synthesized with the main image, according to a ratio between the subject area and area other than the subject area in the main image.

38. The system of claim 25, wherein, when at least one of a plurality of the reduced medical images and a plurality of the reduced abnormality displayed images are synthesized with the main image, the synthesized image generating section performs size adjustment on each of the images to be synthesized with the main image so as to make the image to be synthesized have the same size.

39. The system of claim 25, wherein, when the main image is composed of two images at a left side and a right side, the synthesized image generating section recognizes subject area of each of the two images, and performs synthesis so as to make relative location relation between each subject area recognized and at least one of the reduced medical image and the reduced abnormality displayed image in the main image have the same appearance or symmetric appearance at the left side and the right side.

40. The system of claim 25, further comprising a selecting section for selecting a medical image to be set as the main image and a medical image to be set as the sub image among a plurality of medical images generated in the same examination by the modality under different radiographing conditions.

41. The system of claim 25, further comprising an assigning section for assigning whether the reduced medical image is set as the sub image or the reduced abnormality displayed image is set as the sub image.

42. The system of claim 25, further comprising:
at least one modality, and
a managing device for storing and managing medical images generated by the at least one modality as related to accompanying information thereof,
wherein the image processing device comprises a selecting section for selecting a medical image to be set as the main image and a medical image to be set as the sub image among at least one of the medical images generated by the at least one modality and the medical images stored in the managing device.

43. The system of claim 42, wherein, after the selecting section selects the medical image to be set as the main image, the selecting section extracts medical images related to the main image from at least one of the medical images generated by the at least one modality and the medical images stored in the managing device on the basis of the accompanying information, displays a list of the medical images extracted on a display screen as sub image candidates, and selects a medical image to be set as the sub image among the sub image candidates displayed.

44. The system of claim 42, wherein the selecting section is capable of selecting a plurality of sub images corresponding to the main image.

45. A method for processing a medical image, comprising:
generating a plurality of processed images composed of at least one main image and at least one sub image generated by reducing the whole of a medical image on the basis of at least one medical image generated by radiographing a subject;
generating one image to be displayed by synthesizing the main image and the sub image; and
outputting the image to be displayed to an image recording device.
